(19) United States
(12) Patent Application Publication
(10) Pub. No.: US 2026/0223103 A1
(43) Pub. Date: Jul. 30, 2026

(54) TERMINAL APPARATUS AND BASE STATION APPARATUS

(71) Applicant: SHARP KABUSHIKI KAISHA, Sakai City, Osaka (JP)

(72) Inventors: Takahisa FUKUI, Sakai City, Osaka (JP); KAZUNARI YOKOMAKURA, Sakai City, Osaka (JP); Ryota MORIMOTO, Sakai City, Osaka (JP)

(21) Appl. No.: 19/139,942

(22) PCT Filed: Sep. 7, 2023
(86) PCT No.: PCT/JP2023/032756

§ 371 Date: Jun. 17, 2025

(30) Foreign Application Priority Data
Dec. 20, 2022 (JP) 2022-203559

(51) Int. Cl. H04W 72/1263; H04L 5/00

(52) U.S. Cl. CPC H04W 72/1263; H04L 5/0044

(57) ABSTRACT

A first PDCCH to which first DCI is mapped and a first PDSCH scheduled by the first DCI are received, and a PUCCH to which uplink control information for the first PDSCH is mapped is transmitted, wherein one or multiple pieces of first beam information are indicated by the first DCI, one or two pieces of second beam information are selected by the first DCI from the first beam information, one piece of third beam information is a part of the second beam information, a first time that is a time between the first PDCCH and the first PDSCH is equal to or longer than a second time that is configured as the number of OFDM symbols by a first higher layer parameter, the second beam information is applied to the first PDSCH, and in a case that the first time is shorter than the second time, the third beam information is applied to the first PDSCH.

### TECHNICAL FIELD

The present invention relates to a terminal apparatus and a base station apparatus.

This application claims priority to JP 2022-203559 filed on Dec. 20, 2022, the contents of which are incorporated herein by reference.

### BACKGROUND ART

In the 3^{rd} Generation Partnership Project (3GPP: registered trademark), a radio access method and a radio network for cellular mobile communications (hereinafter also referred to as “Long Term Evolution (LTE)” or “Evolved Universal Terrestrial Radio Access (EUTRA)”) have been studied. In LTE, a base station apparatus is also referred to as an evolved NodeB (eNodeB) and a terminal apparatus is also referred to as a User Equipment (UE). LTE is a cellular communication system in which multiple areas covered by base station apparatuses are arranged in a form of cells. A single base station apparatus may manage multiple serving cells.

The 3GPP has been studying a next generation standard (New Radio or NR) (NPL 1) to make a proposal for International Mobile Telecommunication (IMT)-2020, a standard for a next generation mobile communication system developed by the International Telecommunication Union (ITU). NR is to satisfy requirements for three scenarios including enhanced Mobile BroadBand (eMBB), massive Machine Type Communication (mMTC), and Ultra Reliable and Low Latency Communication (URLLC) in a single technology framework.

In the 3GPP, extension of services supported by NR has been studied (NPL 2 and NPL 3).

### CITATION LIST

### Non Patent Literature

NPL 1: “New SID proposal: Study on New Radio Access Technology”, RP-160671, NTT docomo, 3GPP TSG RAN Meeting #71, Goteborg, Sweden, 7 to 10 Mar., 2016.
NPL 2: “Release 17 package for RAN”, RP-193216, RAN chairman, RANI chairman, RAN2 chairman, RAN3 chairman, 3GPP TSG RAN Meeting #86, Sitges, Spain, 9 to 12 Dec., 2019
NPL 3: “Release 18 package summary”, RP-213469, RAN chairman, RANI chairman, RAN2 chairman, RAN3 chairman, 3GPP TSG RAN Meeting #94-e, 6 to 17 Dec., 2021

### SUMMARY OF INVENTION

### Technical Problem

The present invention provides a terminal apparatus that efficiently performs communication, a communication method used for the terminal apparatus, a base station apparatus that efficiently performs communication, and a communication method used for the base station apparatus.

### Solution to Problem

(1) A first aspect of the present invention is a terminal apparatus including a receiver configured to receive a first PDCCH to which first DCI is mapped and a first PDSCH scheduled by the first DCI, and a transmitter configured to transmit a PUCCH to which uplink control information for the first PDSCH is mapped, wherein one or multiple pieces of first beam information are indicated by the first DCI, one or two pieces of second beam information are selected by the first DCI from the one or multiple pieces of first beam information, one piece of third beam information is a part of the one or two pieces of second beam information, a first time is a time between the first PDCCH and the first PDSCH, a second time is configured as the number of OFDM symbols by a first higher layer parameter, in a case that the first time is equal to or longer than the second time, the one or two pieces of second beam information are applied to the first PDSCH, and in a case that the first time is shorter than the second time, the one piece of third beam information is applied to the first PDSCH.
(2) A second aspect of the present invention is a base station apparatus including a transmitter configured to transmit a first PDCCH to which first DCI is mapped and a first PDSCH scheduled by the first DCI, and a receiver configured to receive a PUCCH to which uplink control information for the first PDSCH is mapped, wherein one or multiple pieces of first beam information are indicated by the first DCI, one or two pieces of second beam information are selected by the first DCI from the one or multiple pieces of first beam information, one piece of third beam information is a part of the one or two pieces of second beam information, a first time is a time between the first PDCCH and the first PDSCH, a second time is configured as the number of OFDM symbols by a first higher layer parameter, in a case that the first time is equal to or longer than the second time, the one or two pieces of second beam information are applied to the first PDSCH, and in a case that the first time is shorter than the second time, the one piece of third beam information is applied to the first PDSCH.

### Advantageous Effects of Invention

According to the present invention, the terminal apparatus can efficiently perform communication. In addition, the base station apparatus can efficiently perform communication.

### BRIEF DESCRIPTION OF DRAWINGS

FIG. 1 is a conceptual diagram of a radio communication system according to an aspect of the present embodiment.

FIG. 2 is an example illustrating a relationship between a subcarrier spacing configuration μ, the number of OFDM symbols per slot N^{slot}_{symb}, and a cyclic Prefix (CP) configuration according to an aspect of the present embodiment.

FIG. 3 is a diagram illustrating an example of a configuration method of a resource grid according to an aspect of the present embodiment.

FIG. 4 is a diagram illustrating a configuration example of a resource grid 3001 according to an aspect of the present embodiment.

FIG. 5 is a schematic block diagram illustrating a configuration example of a base station apparatus 3 according to an aspect of the present embodiment.

FIG. 6 is a schematic block diagram illustrating a configuration example of a terminal apparatus 1 according to an aspect of the present embodiment.

FIG. 7 is a diagram illustrating a configuration example of an SS/PBCH block according to an aspect of the present embodiment.

FIG. 8 is a diagram illustrating an example of monitoring occasions for search space sets according to an aspect of the present embodiment.

FIG. 9 is a diagram illustrating an example of an activation command A according to an aspect of the present embodiment.

FIG. 10 is a diagram illustrating an example of an activation command B according to an aspect of the present embodiment.

FIG. 11 is a diagram illustrating an example of an activation command C according to an aspect of the present embodiment.

FIG. 12 is a diagram illustrating an example of an activation command D according to an aspect of the present embodiment.

FIG. 13 is a diagram illustrating an example of an activation command E according to an aspect of the present embodiment.

FIG. 14 is a diagram illustrating an example of management of a TCI state according to an aspect of the present embodiment.

FIG. 15 is a diagram illustrating an example of a timeline management for a TCI state according to an aspect of the present embodiment.

FIG. 16 is a diagram illustrating a second example of the timeline management for the TCI state according to an aspect of the present embodiment.

### DESCRIPTION OF EMBODIMENTS

An embodiment of the present invention will be described below.

floor(C) may be a floor function for a real number C. For example, floor(C) may be a function that outputs a maximum integer in a range of not exceeding the real number C. ceil(D) may be a ceiling function for a real number D. For example, ceil(D) may be a function that outputs a minimum integer in a range of not falling below the real number D. mod(E, F) may be a function that outputs a remainder obtained by dividing E by F. mod(E, F) may be a function that outputs a value corresponding to the remainder obtained by dividing E by F. exp(G)=\hat{ }G. Here, e is a Napier's constant. H\hat{ }I represents H to the power of I. max(J, K) is a function that outputs a maximum value out of J and K. Here, in a case that J and K are equal, max(J, K) is a function that outputs J or K. min(L, M) is a function that outputs a maximum value out of L and M. Here, in a case that L and M are equal, min(L, M) is a function that outputs L or M. round(N) is a function that outputs an integer value of a value closest to N. “·” represents multiplication.

In the radio communication system according to an aspect of the present embodiment, at least Orthogonal Frequency Division Multiplex (OFDM) is used. The OFDM symbol is a time domain unit of the OFDM. The OFDM symbol includes at least one or multiple subcarriers. The OFDM symbol is converted into a time-continuous signal in baseband signal generation. In downlink, at least Cyclic Prefix-Orthogonal Frequency Division Multiplexing (CP-OFDM) is used. In uplink, either CP-OFDM or Discrete Fourier Transform-spread-Orthogonal Frequency Division Multiplex (DFT-s-OFDM) is used. DFT-s-OFDM may be given by applying Transform precoding to the CP-OFDM.

The OFDM symbol may be a term including a CP added to the OFDM symbol. That is, a certain OFDM symbol may include the certain OFDM symbol and the CP added to the certain OFDM symbol.

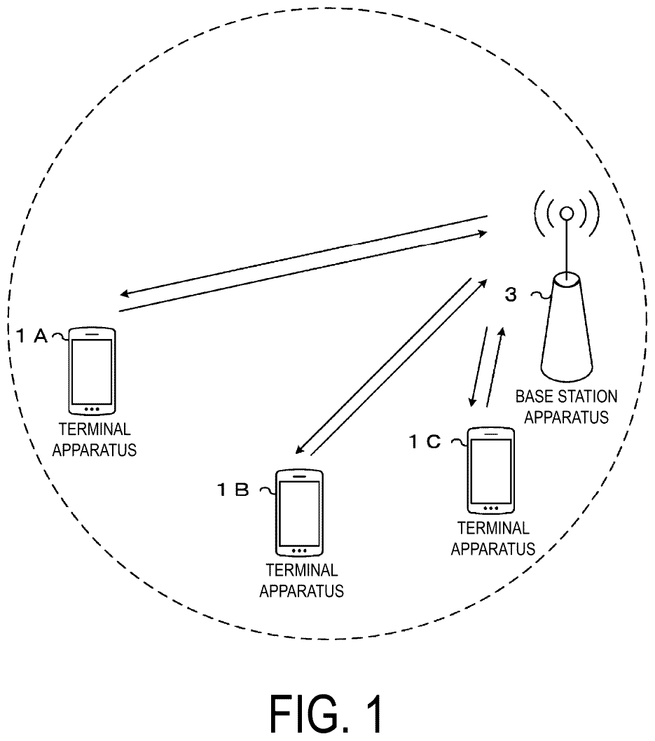

FIG. 1 is a conceptual diagram of a radio communication system according to an aspect of the present embodiment. In FIG. 1, the radio communication system includes at least terminal apparatuses 1A to 1C and a base station apparatus 3 (Base station #3 (BS #3)). Hereinafter, the terminal apparatuses 1A to 1C are also referred to as a terminal apparatus 1 (User Equipment #1 (UE #1)).

The base station apparatus 3 may include one or multiple transmission apparatuses (or transmission points, transmission and/or reception apparatuses, transmission and/or reception points). In a case that the base station apparatus 3 includes multiple transmission apparatuses, the multiple transmission apparatuses may be arranged at different positions.

The base station apparatus 3 may provide one or multiple serving cells. Each serving cell may be defined as a set of resources used for radio communication. In addition, the serving cell is also referred to as a cell.

The serving cell may include one or both of one downlink component carrier (downlink carrier) and one uplink component carrier (uplink carrier). The serving cell may include either or both of two or more downlink component carriers, and/or two or more uplink component carriers. The downlink component carrier and the uplink component carrier are also collectively referred to as a component carrier (carrier).

For example, for each component carrier, one resource grid may be given. In addition, for each set of one component carrier and a certain subcarrier spacing configuration μ, one resource grid may be given. Here, the subcarrier spacing configuration μ is also referred to as numerology. For example, for a set of a certain antenna port p, a certain subcarrier spacing configuration μ, and a certain transmission direction x, one resource grid may be given.

The resource grid includes N^{size, μ}_{grid, x}N^{RB}_{sc} subcarriers. Here, the resource grid starts from a common resource block N^{start, μ}_{grid x}. In addition, the common resource block N^{start, μ}_{grid, x} is also referred to as a reference point of the resource grid.

The resource grid includes N^{subframe, μ}_{symb} OFDM symbols.

The subscript x added to the parameter associated with the resource grid indicates the transmission direction. For example, the subscript x may be used to indicate either of downlink or uplink.

N^{size, μ}_{grid, x} is an offset configuration indicated by a parameter provided by the RRC layer (e.g., parameter CarrierBandwidth). N^{start, μ}_{grid, x} is a band configuration indicated by a parameter provided by the RRC layer (e.g., parameter, OffsetToCarrier). The offset configuration and the band configuration are configurations used for configuring an SCS-specific carrier.

The SubCarrier Spacing (SCS) Δf for a certain subcarrier spacing configuration μ may be Δf satisfying Δf=2^{μ}·15 kHz. Here, the subcarrier spacing configuration μ may indicate one of 0, 1, 2, 3, or 4.

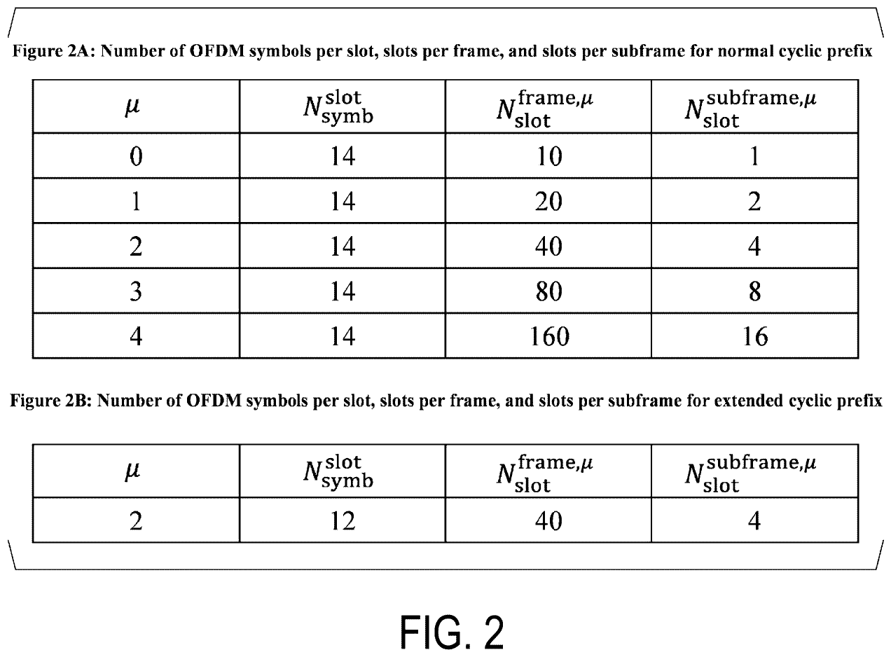

FIG. 2 is an example illustrating a relationship between the subcarrier spacing configuration μ, the number of OFDM symbols per slot N^{slot}_{symb}, and a cyclic Prefix (CP) configuration according to an aspect of the present embodiment. In FIG. 2A, for example, in a case that the subcarrier spacing configuration μ is 2 and the CP configuration is a normal cyclic prefix (normal CP), N^{slot}_{symb}=14, N^{frame, μ}ₛₗₒₜ=40, and N^{subframe, μ}ₛₗₒₜ=4. In addition, in FIG. 2B, for example, in a case that the subcarrier spacing configuration μ is 2 and the CP configuration is an extended cyclic prefix (extended CP), N^{slot}_{symb}=12, N^{frame, μ}ₛₗₒₜ=40, and N^{subframe, μ}ₛₗₒₜ=4.

The time unit T_{c} may be used to represent the length of the time domain. The time unit T_{c} is T_{c}=1/(Δfₘₐₓ·N_{f}). Δfₘₐₓ=480 KHz. N_{f}=4096. A constant κ is κ=Δfₘₐₓ·N_{f}/(Δf_{ref}N_{f, ref})=64. Δf_{ref} is 15 KHz. N_{f, ref} is 2048.

Transmission of a signal in the downlink and/or transmission of a signal in the uplink may be organized into a radio frame (system frame, frame) having the length T_{f}. T_{f}=(ΔfₘₐₓN_{f}/100)·Tₛ=10 ms. The radio frame includes 10 subframes. The length Tₛf of the subframe is (ΔfₘₐₓN_{f}/1000)·Tₛ=1 ms. The number of OFDM symbols per subframe is N^{subframe, μ}_{symb}=N^{slot}_{symb}N^{subframe, μ}ₛₗₒₜ.

The OFDM symbol is a time domain unit of one communication scheme. For example, the OFDM symbol may be a time domain unit of CP-OFDM. In addition, the OFDM symbol may be a time domain unit of DFT-s-OFDM.

The slot may include multiple OFDM symbols. For example, N^{slot}_{symb} continuous OFDM symbols may constitute one slot. For example, in a normal CP configuration, N^{slot}_{symb} may be 14. In addition, in an extended CP configuration, N^{slot}_{symb} may be 12.

For a certain subcarrier spacing configuration μ, the number and index of a slot included in the subframe may be given. For example, slot indices n^{μ}ₛ may be given in ascending order in the subframe with integer values within a range of 0 to N^{subframe, μ}ₛₗₒₜ −1. For the subcarrier spacing configuration μ, the number and index of a slot included in the radio frame may be given. In addition, slot indices n^{μ}_{s, f} may be given in ascending order in the radio frame with integer values within a range of 0 to N^{frame, μ}ₛₗₒₜ−1.

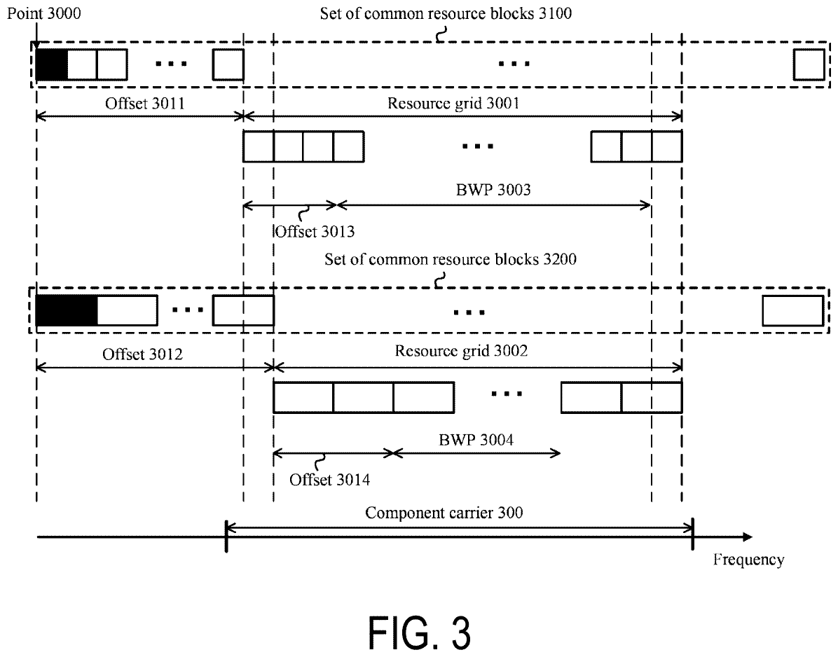

FIG. 3 is a diagram illustrating an example of a configuration method of a resource grid according to an aspect of the present embodiment. The horizontal axis of FIG. 3 represents a frequency domain. FIG. 3 illustrates a configuration example of a resource grid of a subcarrier spacing μ₁ in a component carrier 300, and a configuration example of a resource grid of a subcarrier spacing μ₂ in the certain component carrier. As described above, for a certain component carrier, one or multiple subcarrier spacings may be configured. In FIG. 3, it is assumed that μ₁=μ₂−1, but various aspects of the present embodiment are not limited to the condition of μ₁=μ₂−1.

The component carrier 300 is a band having a predetermined width in the frequency domain.

A point 3000 is an identifier for identifying a certain subcarrier. The point 3000 is also referred to as a point A. A common resource block (CRB) set 3100 is a set of common resource blocks for the configuration of the subcarrier spacing μ₁.

In the common resource block set 3100, a common resource block (solid black block in the common resource block set 3100 in FIG. 3) including the point 3000 is also referred to as a reference point of the common resource block set 3100. The reference point of the common resource block set 3100 may be a common resource block having an index 0 in the common resource block set 3100.

An offset 3011 is an offset from the reference point of the common resource block set 3100 to a reference point of a resource grid 3001. The offset 3011 is represented by the number of common resource blocks for the configuration of the subcarrier spacing μ₁. The resource grid 3001 includes N^{size, μ}_{grid1, x} common resource blocks starting from the reference point of the resource grid 3001.

An offset 3013 is an offset from the reference point of the resource grid 3001 to a reference point (N^{start, μ}_{BWP, i1}) of a bandwidth part (BWP) 3003 having an index i1.

A common resource block set 3200 is a set of common resource blocks for the configuration of the subcarrier spacing μ₂.

In the common resource block set 3200, a common resource block (solid black block in the common resource block set 3200 in FIG. 3) including the point 3000 is also referred to as a reference point of the common resource block set 3200. The reference point of the common resource block set 3200 may be a common resource block having an index 0 in the common resource block set 3200.

An offset 3012 is an offset from the reference point of the common resource block set 3200 to a reference point of a resource grid 3002. The offset 3012 is represented by the number of common resource blocks for the subcarrier spacing μ₂. The resource grid 3002 includes N^{size, μ}_{grid2, x} common resource blocks starting from the reference point of the resource grid 3002.

An offset 3014 is an offset from the reference point of the resource grid 3002 to a reference point (N^{start, μ}_{BWP, i2}) of a BWP 3004 having an index i2.

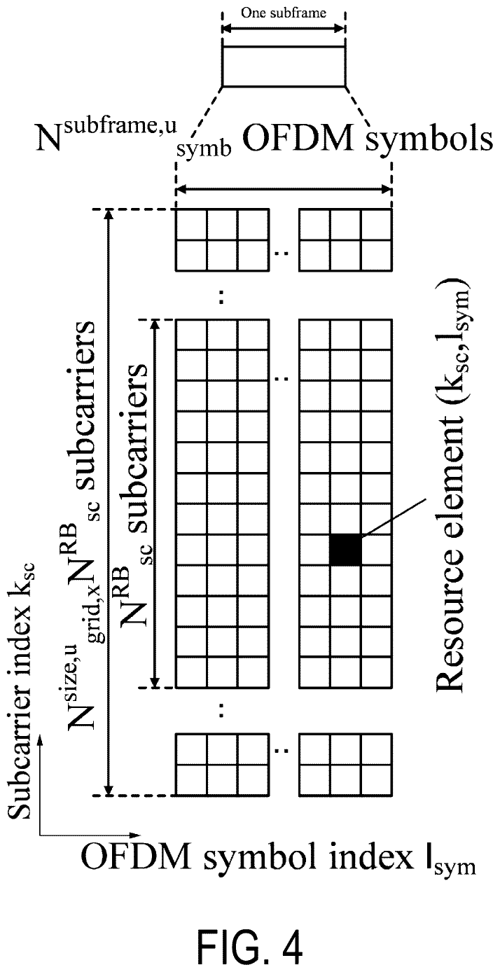

FIG. 4 is a diagram illustrating a configuration example of the resource grid 3001 according to an aspect of the present embodiment. In the resource grid of FIG. 4, the horizontal axis corresponds to an OFDM symbol index l_{sym}, and the vertical axis corresponds to a subcarrier index k_{sc}. The resource grid 3001 includes N^{size, μ}_{grid1, x}N^{RB}_{sc} subcarriers, and N^{subframe, μ}_{symb} OFDM symbols. In the resource grid, a resource identified by the subcarrier index k_{sc} and the OFDM symbol index l_{sym} is also referred to as a resource element (RE).

The resource block (RB) includes N^{RB}_{sc} continuous subcarriers. The resource block is a general term for a common resource block, a physical resource block (PRB), and a virtual resource block (VRB). Here, N^{RB}_{sc} is 12.

A resource block unit is a set of resources corresponding to one OFDM symbol in one resource block. That is, one resource block unit includes 12 resource elements corresponding to one OFDM symbol in one resource block.

The common resource blocks for the configuration of a certain subcarrier spacing u are assigned indices (indexing) in ascending order from 0 in the frequency domain in a certain common resource block set. The common resource block having the index 0 for the configuration of a certain subcarrier spacing μ includes (collides with or matches) the point 3000. An index n^{μ}_{CRB} of the common resource block for the configuration of the certain subcarrier spacing μ satisfies the relationship of n^{μ}_{CRB}=ceil(k_{sc}/N^{RB}_{sc}). Here, a subcarrier with k_{sc}=0 is a subcarrier having the same center frequency as the center frequency of a subcarrier corresponding to the point 3000.

Physical resource blocks for the configuration of the certain subcarrier spacing u are assigned indices in ascending order from 0 in the frequency domain in a certain BWP. An index n^{μ}_{PRB} of the physical resource block for the configuration of the certain subcarrier spacing cμ satisfies the relationship of n^{μ}_{CRB}=n^{μ}_{PRB}+N^{start, μ}_{BWP, i}. Here, N^{start, μ}_{BWP, i} indicates a reference point of the BWP having an index i.

The BWP is defined as a subset of common resource blocks included in the resource grid. The BWP includes N^{size, μ}_{BWP, i} common resource blocks starting from the reference point N^{start, μ}_{BWP, i} of the BWP. A BWP configured for a downlink carrier is also referred to as a downlink BWP. A BWP configured for an uplink component carrier is also referred to as an uplink BWP.

An antenna port may be defined such that the channel over which a symbol on the antenna port is conveyed can be inferred from the channel over which another symbol on the same antenna port is conveyed. For example, the channel may correspond to a physical channel. In addition, the symbol may correspond to an OFDM symbol. In addition, the symbol may correspond to a resource block unit. In addition, the symbol may correspond to a resource element.

The fact that a large scale property of a channel over which a symbol on one antenna port is conveyed can be inferred from a channel over which a symbol on another antenna port is conveyed is referred to as the two antenna ports being quasi co-located (QCL). Here, the large scale property may include at least long term property of a channel. The large scale property may include at least a part or all of delay spread, Doppler spread, Doppler shift, an average gain, an average delay, and a beam parameter (spatial Rx parameters). The fact that the first antenna port and the second antenna port are QCLed with respect to a beam parameter may mean that a reception beam assumed by a reception side for the first antenna port and a reception beam assumed by the reception unit side for the second antenna port are the same (or the reception beams correspond to each other). The fact that the first antenna port and the second antenna port are QCLed with respect to a beam parameter may mean that a transmission beam assumed by a reception side for the first antenna port and a transmission beam assumed by the reception side for the second antenna port are the same (or the transmission beams correspond to each other). In a case that the large scale property of a channel over which a symbol on one antenna port is conveyed can be inferred from a channel over which a symbol on another antenna port is conveyed, the terminal apparatus 1 may assume that the two antenna ports are QCL. The fact that two antenna ports are QCL may mean that the two antenna ports are assumed to be QCL. The large scale property may be referred to as a QCL parameter.

The QCL type may be any one of type A, type B, type C, and type D.

The fact that two antenna ports are QCLed with type A may mean that a first large scale property of a channel over which a symbol on one antenna port is conveyed can be inferred from a channel over which a symbol on another antenna port is conveyed. The fact that two antenna ports are QCLed with type B may mean that a second large scale property of a channel over which a symbol on one antenna port is conveyed can be inferred from a channel over which a symbol on another antenna port is conveyed. The fact that two antenna ports are QCLed with type C may mean that a third large scale property of a channel over which a symbol on one antenna port is conveyed can be inferred from a channel over which a symbol on another antenna port is conveyed. The fact that two antenna ports are QCLed with type D may mean that a fourth large scale property of a channel over which a symbol on one antenna port is conveyed can be inferred from a channel over which a symbol on another antenna port is conveyed. The first large scale property may include all of a Doppler shift, a Doppler spread, an average delay, and a delay spread. The second large scale property may include all of a Doppler shift and a Doppler spread. The third large scale property may include all of a Doppler shift and an average delay. The fourth large scale property may include spatial reception parameters (information of a spatial direction, information of a beam). An antenna port of a DMRS may be a DMRS port. For example, an antenna port of a PTRS may be a PTRS antenna port. An antenna port associated with a PTRS may be a PTRS port. An antenna port for an SRS may be an SRS port. An antenna port for a DMRS may be a DMRS port. An antenna port associated with a DMRS may be a DMRS port.

Carrier aggregation may mean that communication is performed by using multiple serving cells being aggregated. In addition, carrier aggregation may mean that communication is performed by using multiple component carriers being aggregated. In addition, carrier aggregation may mean that communication is performed by using multiple downlink component carriers being aggregated. In addition, carrier aggregation may mean that communication is performed by using multiple uplink component carriers being aggregated.

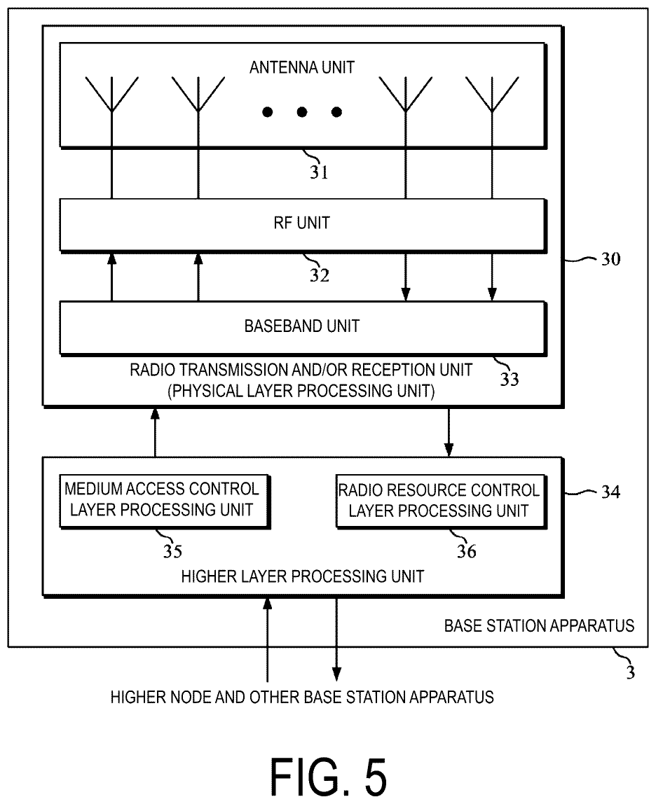

FIG. 5 is a schematic block diagram illustrating a configuration example of the base station apparatus 3 according to an aspect of the present embodiment. As illustrated in FIG. S, the base station apparatus 3 includes at least a part or all of a radio transmission and/or reception unit (physical layer processing unit) 30 and/or a higher layer processing unit 34. The radio transmission and/or reception unit 30 includes at least a part or all of an antenna unit 31, a radio frequency (RF) unit 32, and a baseband unit 33. The higher layer processing unit 34 includes at least a part or all of a medium access control layer processing unit 35 and a radio resource control (RRC) layer processing unit 36.

The radio transmission and/or reception unit 30 includes at least a part or all of a radio transmission unit 30a and a radio reception unit 30b. Here, apparatus configurations of the baseband unit included in the radio transmission unit 30a and the baseband unit included in the radio reception unit 30b may be the same or different from each other. In addition, apparatus configurations of the RF unit included in the radio transmission unit 30a and the RF unit included in the radio reception unit 30b may be the same or different from each other. In addition, apparatus configurations of the antenna unit included in the radio transmission unit 30a and the antenna unit included in the radio reception unit 30b may be the same or different from each other.

For example, the radio transmission unit 30a may generate and transmit a baseband signal of a PDSCH. For example, the radio transmission unit 30a may generate and transmit a baseband signal of a PDCCH. For example, the radio transmission unit 30a may generate and transmit a baseband signal of a PBCH. For example, the radio transmission unit 30a may generate and transmit a baseband signal of a synchronization signal. For example, the radio transmission unit 30a may generate and transmit a baseband signal of a PDSCH DMRS. For example, the radio transmission unit 30a may generate and transmit a baseband signal of a PDCCH DMRS. For example, the radio transmission unit 30a may generate and transmit a baseband signal of a CSI-RS. For example, the radio transmission unit 30a may generate and transmit a baseband signal of a DL PTRS.

For example, the radio reception unit 30b may receive a PRACH. For example, the radio reception unit 30b may receive and demodulate a PUCCH. The radio reception unit 30b may receive and demodulate a PUSCH. For example, the radio reception unit 30b may receive a PUCCH DMRS. For example, the radio reception unit 30b may receive a PUSCH DMRS. For example, the radio reception unit 30b may receive a UL PTRS. For example, the radio reception unit 30b may receive an SRS.

The higher layer processing unit 34 outputs downlink data (a transport block) to the radio transmission and/or reception unit 30 (or the radio transmission unit 30a). The higher layer processing unit 34 performs processing operations of a Medium Access Control (MAC) layer, a Packet Data Convergence Protocol (PDCP) layer, a Radio Link Control (RLC) layer, and an RRC layer.

The medium access control layer processing unit 35 included in the higher layer processing unit 34 performs processing of the MAC layer.

The radio resource control layer processing unit 36 included in the higher layer processing unit 34 performs processing of the RRC layer. The radio resource control layer processing unit 36 manages various pieces of configuration information/parameters (RRC parameters) of the terminal apparatus 1. The radio resource control layer processing unit 36 sets the parameter based on an RRC message received from the terminal apparatus 1.

The radio transmission and/or reception unit 30 (or the radio transmission unit 30a) performs processing such as modulation and encoding. The radio transmission and/or reception unit 30 (or the radio transmission unit 30a) generates a physical signal through modulation, encoding, and baseband signal generation (conversion into the time-continuous signal) on downlink data, and transmits the physical signal to the terminal apparatus 1. The radio transmission and/or reception unit 30 (or the radio transmission unit 30a) may map the physical signal to a certain component carrier and transmit the physical signal to the terminal apparatus 1.

The radio transmission and/or reception unit 30 (or the radio reception unit 30b) performs processing such as demodulation and decoding. The radio transmission and/or reception unit 30 (or the radio reception unit 30b) separates, demodulates, and decodes the received physical signal, and outputs the decoded information to the higher layer processing unit 34. The radio transmission and/or reception unit 30 (or the radio reception unit 30b) may perform a channel access procedure prior to transmission of the physical signal.

The RF unit 32 converts (down-converts) a signal received via the antenna unit 31 into a baseband signal by means of orthogonal demodulation and removes unnecessary frequency components. The RF unit 32 outputs a processed analog signal to the baseband unit.

The baseband unit 33 converts an analog signal input from the RF unit 32 into a digital signal. The baseband unit 33 removes a portion corresponding to a cyclic prefix (CP) from the converted digital signal, performs a Fast Fourier Transform (FFT) on the signal from which the CP has been removed, and extracts a signal in the frequency domain.

The baseband unit 33 performs Inverse Fast Fourier Transform (IFFT) on the data to generate an OFDM symbol, adds a CP to the generated OFDM symbol, generates a baseband digital signal, and converts the baseband digital signal into an analog signal. The baseband unit 33 outputs the converted analog signal to the RF unit 32.

The RF unit 32 removes an unnecessary frequency component from the analog signal input from the baseband unit 33 by using a low-pass filter, up-converts the analog signal into a signal having a carrier frequency, and transmits the signal via the antenna unit 31. In addition, the RF unit 32 may have a function of controlling transmission power. The RF unit 32 is also referred to as a transmission power control unit.

For the terminal apparatus 1, one or multiple serving cells (or component carriers, downlink component carriers, uplink component carriers) may be configured.

Each of the serving cells configured for the terminal apparatus 1 may be one of a Primary cell (PCell), a Primary SCG cell (PSCell), or a Secondary Cell (SCell).

The PCell is a serving cell included in a Master Cell Group (MCG). The PCell is a cell in which an initial connection establishment procedure or a connection re-establishment procedure is performed (has been performed) by the terminal apparatus 1.

The PSCell is a serving cell included in a Secondary Cell Group (SCG). The PSCell is a serving cell in which random access is performed by the terminal apparatus 1.

The SCell may be included in either of the MCG or the SCG.

A serving cell group (cell group) is a term at least including an MCG and an SCG. The serving cell group may include one or multiple serving cells (or component carriers). One or multiple serving cells (or component carriers) included in the serving cell group may be operated by means of carrier aggregation.

One or multiple downlink BWPs may be configured for each of the serving cells (or downlink component carriers). One or multiple uplink BWPs may be configured for each of the serving cells (or uplink component carriers).

Among one or multiple downlink BWPs configured for the serving cell (or the downlink component carrier), one downlink BWP may be configured as an active downlink BWP (or one downlink BWP may be activated). Among one or multiple uplink BWPs configured for the serving cell (or the uplink component carrier), one uplink BWP may be configured as an active uplink BWP (or one uplink BWP may be activated).

The PDSCH, the PDCCH, and the CSI-RS may be received in the active downlink BWP. The terminal apparatus 1 may attempt to receive the PDSCH, the PDCCH, and the CSI-RS in the active downlink BWP. The PUCCH and the PUSCH may be transmitted in the active uplink BWP. The terminal apparatus 1 may transmit the PUCCH and the PUSCH in the active uplink BWP. The active downlink BWP and the active uplink BWP are also collectively referred to as active BWPs.

The PDSCH, the PDCCH, and the CSI-RS need not be received in downlink BWPs (inactive downlink BWPs) other than the active downlink BWP. The terminal apparatus 1 need not attempt to receive the PDSCH, the PDCCH, and the CSI-RS in downlink BWPs that are not active downlink BWPs. The PUCCH and the PUSCH need not be transmitted in uplink BWPs (inactive uplink BWPs) that are not active uplink BWPs. The terminal apparatus I need not transmit the PUCCH and the PUSCH in uplink BWPs that are not active uplink BWPs. The inactive downlink BWPs and the inactive uplink BWPs are also collectively referred to as inactive BWPs.

Downlink BWP switch is a procedure for deactivating one active downlink BWP of a certain serving cell and activating any one of the inactive downlink BWPs of the certain serving cell. The downlink BWP switch may be controlled by a BWP field included in downlink control information. The downlink BWP switch may be controlled based on a higher layer parameter.

Uplink BWP switch is used for deactivating one active uplink BWP and activating any one of the inactive uplink BWPs that are not the one active uplink BWP. The uplink BWP switch may be controlled by a BWP field included in downlink control information. The uplink BWP switch may be controlled based on a higher layer parameter.

Among one or multiple downlink BWPs configured for the serving cell, two or more downlink BWPs need not be configured for an active downlink BWP. For the serving cell, at certain times, one downlink BWP may be active.

Among one or multiple uplink BWPs configured for the serving cell, two or more uplink BWPs need not be configured for an active uplink BWP. For the serving cell, at certain times, one uplink BWP may be active.

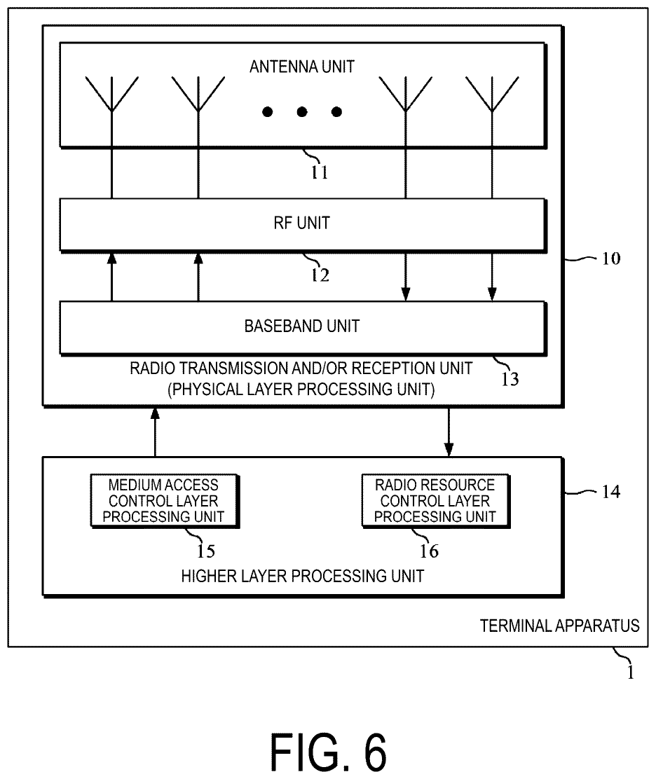

FIG. 6 is a schematic block diagram illustrating a configuration example of the terminal apparatus 1 according to an aspect of the present embodiment. As illustrated in FIG. 6, the terminal apparatus 1 includes at least one or all of a radio transmission and/or reception unit (physical layer processing unit) 10 and a higher layer processing unit 14. The radio transmission and/or reception unit 10 includes at least a part or all of an antenna unit 11, an RF unit 12, and a baseband unit 13. The higher layer processing unit 14 includes at least a part or all of a medium access control layer processing unit 15 and a radio resource control layer processing unit 16.

The radio transmission and/or reception unit 10 includes at least a part or all of a radio transmission unit 10a and a radio reception unit 10b. Here, apparatus configurations of the baseband unit 13 included in the radio transmission unit 10a and the baseband unit 13 included in the radio reception unit 10b may be the same or different from each other. In addition, apparatus configurations of the RF unit 12 included in the radio transmission unit 10a and the RF unit 12 included in the radio reception unit 10b may be the same or different from each other. In addition, apparatus configurations of the antenna unit 11 included in the radio transmission unit 10a and the antenna unit 11 included in the radio reception unit 10b may be the same or different from each other.

For example, the radio transmission unit 10a may generate and transmit a baseband signal of a PRACH. For example, the radio transmission unit 10a may generate and transmit a baseband signal of a PUCCH. The radio transmission unit 10a may generate and transmit a baseband signal of a PUSCH. For example, the radio transmission unit 10a may generate and transmit a baseband signal of a PUCCH DMRS. For example, the radio transmission unit 10a may generate and transmit a baseband signal of a PUSCH DMRS. For example, the radio transmission unit 10a may generate and transmit a baseband signal of a UL PTRS. For example, the radio transmission unit 10a may generate and transmit a baseband signal of an SRS.

For example, the radio reception unit 10b may receive and demodulate a PDSCH. For example, the radio reception unit 10b may receive and demodulate a PDCCH. For example, the radio reception unit 10b may receive and demodulate a PBCH. For example, the radio reception unit 10b may receive a synchronization signal. For example, the radio reception unit 10b may receive a PDSCH DMRS. For example, the radio reception unit 10b may receive a PDCCH DMRS. For example, the radio reception unit 10b may receive a CSI-RS. For example, the radio reception unit 10b may receive a DL PTRS.

The higher layer processing unit 14 outputs uplink data (a transport block) to the radio transmission and/or reception unit 10 (or the radio transmission unit 10a). The higher layer processing unit 14 performs processing operations of the MAC layer, a packet data convergence protocol layer, a radio link control layer, and the RRC layer.

The medium access control layer processing unit 15 included in the higher layer processing unit 14 performs processing of the MAC layer.

The radio resource control layer processing unit 16 included in the higher layer processing unit 14 performs processing of the RRC layer. The radio resource control layer processing unit 16 manages various pieces of configuration information/parameters (RRC parameters) of the terminal apparatus 1. The radio resource control layer processing unit 16 sets the RRC parameters based on an RRC message received from the base station apparatus 3.

The radio transmission and/or reception unit 10 (or the radio transmission unit 10a) performs processing such as modulation and encoding. The radio transmission and/or reception unit 10 (or the radio transmission unit 10a) generates a physical signal through modulation, encoding, and baseband signal generation (conversion into a time-continuous signal) on uplink data and transmits the physical signal to the base station apparatus 3. The radio transmission and/or reception unit 10 (or the radio transmission unit 10a) may map the physical signal to a certain BWP (an active uplink BWP) and transmit the physical signal to the base station apparatus 3.

The radio transmission and/or reception unit 10 (or the radio reception unit 10b) performs processing such as demodulation and decoding. The radio transmission and/or reception unit 10 (or the radio reception unit 30b) may receive a physical signal in a certain BWP (active downlink BWP) of a certain serving cell. The radio transmission and/or reception unit 10 (or the radio reception unit 10b) separates, demodulates, and decodes the received physical signal and outputs the decoded information to the higher layer processing unit 14. The radio transmission and/or reception unit 10 (radio reception unit 10b) may perform the channel access procedure prior to the transmission of the physical signal.

The RF unit 12 converts (down-converts) a signal received via the antenna unit 11 into a baseband signal by means of orthogonal demodulation and removes unnecessary frequency components. The RF unit 12 outputs a processed analog signal to the baseband unit 13.

The baseband unit 13 converts the analog signal input from the RF unit 12 into a digital signal. The baseband unit 13 removes a portion corresponding to a cyclic prefix (CP) from the converted digital signal, performs a Fast Fourier Transform (FFT) on the signal from which the CP has been removed, and extracts a signal of the frequency domain.

The baseband unit 13 performs an Inverse Fast Fourier Transform (IFFT) on the uplink data to generate an OFDM symbol, adds a CP to the generated OFDM symbol, generates a baseband digital signal, and converts the baseband digital signal into an analog signal. The baseband unit 13 outputs the converted analog signal to the RF unit 12.

The RF unit 12 removes unnecessary frequency components from the analog signal input from the baseband unit 13 through a low-pass filter, up-converts the analog signal into a signal having a carrier frequency, and transmits the signal via the antenna unit 11. In addition, the RF unit 12 may have a function of controlling transmission power. The RF unit 12 is also referred to as a transmission power control unit.

A physical signal (signal) will be described below.

A physical signal is a general term for a downlink physical channel, a downlink physical signal, an uplink physical channel, and an uplink physical channel. A physical channel is a general term for a downlink physical channel and an uplink physical channel. A physical signal is a general term for a downlink physical signal and an uplink physical signal. The physical signal may be referred to as a reference signal.

An uplink physical channel may correspond to a set of resource elements for conveying information that is generated in a higher layer. An uplink physical channel may be a physical channel used in an uplink component carrier. An uplink physical channel may be transmitted by the terminal apparatus 1. The uplink physical channel may be received by the base station apparatus 3. In the radio communication system according to an aspect of the present embodiment, at least a part or all of the following uplink physical channels may be used:
Physical Uplink Control CHannel (PUCCH);
Physical Uplink Shared CHannel (PUSCH); and
Physical Random Access CHannel (PRACH).

The PUCCH may be used to transmit Uplink Control Information (UCI). The PUCCH may be transmitted for conveying (delivering or transmitting) uplink control information. The uplink control information may be mapped to the PUCCH. The terminal apparatus 1 may transmit the PUCCH to which the uplink control information is mapped. The base station apparatus 3 may receive the PUCCH to which the uplink control information is mapped.

The uplink control information (uplink control information bit, uplink control information sequence, or uplink control information type) includes at least a part or all of Channel State Information (CSI), a Scheduling Request (SR), and Hybrid Automatic Repeat request ACKnowledgement (HARQ-ACK) information.

The channel state information is also referred to as a channel state information bit or a channel state information sequence. The scheduling request is also referred to as a scheduling request bit or a scheduling request sequence. The HARQ-ACK information is also referred to as a HARQ-ACK information bit or a HARQ-ACK information sequence.

The HARQ-ACK information may include at least a HARQ-ACK corresponding to a transport block (TB). The HARQ-ACK may indicate an acknowledgement (ACK) or a negative-acknowledgement (NACK) corresponding to the transport block. The ACK may indicate that decoding of the transport block has been decoded successfully, The NACK may indicate that decoding of the transport block has not been decoded successfully. The HARQ-ACK information may include a HARQ-ACK codebook including one or multiple HARQ-ACK bits.

The transport block is a sequence of information bits delivered from a higher layer. Here, the sequence of information bits is also referred to as a bit sequence. Here, the transport block may be delivered through an UpLink-Shared CHannel (UL-SCH) of a Transport layer.

A HARQ-ACK for the transport block may be referred to as a HARQ-ACK for a PDSCH. In this case, the “HARQ-ACK for the PDSCH” indicates a HARQ-ACK for a transport block included in a PDSCH.

The HARQ-ACK may indicate an ACK or a NACK corresponding to one code block group (CBG) included in the transport block.

A scheduling request may be at least used for requesting a resource of the UL-SCH for new transmission. A scheduling request bit may be used for indicating either of a positive SR or a negative SR. The scheduling request bit indicating the positive SR is also referred to as a “positive SR being conveyed”. The positive SR may indicate that the terminal apparatus 1 requests resources of the UL-SCH for new transmission. The positive SR may indicate that a scheduling request is triggered by a higher layer. The positive SR may be conveyed in a case that the higher layer indicates the scheduling request. The scheduling request bit indicating the negative SR is also referred to as a “negative SR being transmitted”. The negative SR may indicate that the terminal apparatus 1 requests no resources of the UL-SCH for new transmission. The negative SR may indicate that the scheduling request is not triggered by a higher layer. The negative SR may be conveyed in a case that the higher layer indicates no scheduling request.

Channel state information may include at least a part or all of a Channel Quality Indicator (COD), a Precoder Matrix Indicator (PMI), and a Rank Indicator (RI). The CQI is an indicator related to quality (for example, propagation strength) of a propagation path or quality of a physical channel, and the PMI is an indicator related to a precoder. The RI is an indicator related to a transmission rank (or the number of transmission layers).

The channel state information is an indicator related to a reception state of a physical signal (for example, CSI-RS) at least used for channel measurement. A value of the channel state information may be determined by the terminal apparatus 1 based on the reception state assumed by a physical signal at least used for channel measurement. Channel measurement may include interference measurement.

The PUCCH may correspond to a PUCCH format. The PUCCH may be a set of resource elements used for conveying the PUCCH format. The PUCCH may include the PUCCH format. The PUCCH may be transmitted in a certain PUCCH format. Note that the PUCCH format may be interpreted as a form of information. In addition, the PUCCH format may be interpreted as a set of information set in a certain form of information.

The PUSCH may be used for conveying one or both of a transport block and uplink control information. The transport block may be mapped to the PUSCH. The transport block delivered on the UL-SCH may be mapped to the PUSCH. The uplink control information may be mapped to the PUSCH. The terminal apparatus 1 may transmit the PUSCH to which one or both of the transport block and the uplink control information are mapped. The base station apparatus 3 may receive the PUSCH to which one or both of the transport block and the uplink control information are mapped.

The PRACH may be transmitted for conveying a random access preamble. The terminal apparatus 1 may transmit the PRACH. The base station apparatus 3 may receive the PRACH. A PRACH sequence x_{u, v}(n) is defined by x_{u, v}(n)=xᵤ(mod(n+Cᵥ, L_{RA}). Here, xᵤis a Zadoff Chu (ZC) sequence. In addition, xᵤ may be defined by xᵤ=exp(−jπui(i+1)/L_{RA}) j is an imaginary unit. In addition, π is the ratio of the circumference of a circle to its diameter. In addition, Cᵥ corresponds to a cyclic shift of the PRACH sequence. In addition, L_{RA} corresponds to the length of the PRACH sequence. In addition, L_{RA} is 839, or 139. In addition, i is an integer in the range from 0 to L_{RA}−1. In addition, u is a sequence index for the PRACH sequence.

For each PRACH occasion, 64 random access preambles are defined. The random access preambles are identified based on the cyclic shift Cᵥ of the PRACH sequence and the sequence index u for the PRACH sequence. Each of the 64 identified random access preambles may be assigned an index.

Uplink physical signals may correspond to a set of resource elements. The uplink physical signals need not be used to convey information generated in a higher layer. Note that the uplink physical signals may be used to convey information generated in the physical layer. The uplink physical signals may be physical signals used in an uplink component carrier. The terminal apparatus 1 may transmit the uplink physical signals. The base station apparatus 3 may receive the uplink physical signals. In the radio communication system according to an aspect of the present embodiment, at least a part or all of the following uplink physical signals may be used:
UpLink Demodulation Reference Signal (UL DMRS);
Sounding Reference Signal (SRS); and
UpLink Phase Tracking Reference Signal (UL PTRS).

A UL DMRS is a general term for a DMRS for a PUSCH and a DMRS for a PUCCH.

A set of antenna ports of the DMRS for the PUSCH (the DMRS related to the PUSCH, the DMRS included in the PUSCH, or the DMRS corresponding to the PUSCH) may be given based on a set of antenna ports for the PUSCH. For example, the set of antenna ports of the DMRS for the PUSCH may be the same as a set of antenna ports of the PUSCH.

Transmission of the PUSCH and transmission of the DMRS for the PUSCH may be indicated (or may be scheduled) in one DCI format. The PUSCH and the DMRS for the PUSCH may be collectively referred to as a PUSCH. Transmission of the PUSCH may mean transmission of the PUSCH and the DMRS for the PUSCH.

A propagation path of the PUSCH may be inferred from the DMRS for the PUSCH.

A set of antenna ports of the DMRS for the PUCCH (a DMRS related to the PUCCH, a DMRS included in the PUCCH, or a DMRS corresponding to the PUCCH) may be the same as a set of antenna ports of the PUCCH.

Transmission of the PUCCH and transmission of the DMRS for the PUCCH may be indicated (or may be triggered) in one DCI format. One or both of resource element mapping of the PUCCH and resource element mapping of the DMRS for the PUCCH may be given in one PUCCH format. The PUCCH and the DMRS for the PUCCH may be collectively referred to as a PUCCH. Transmission of the PUCCH may mean transmission of the PUCCH and the DMRS for the PUCCH.

A propagation path of the PUCCH may be inferred from the DMRS for the PUCCH.

A downlink physical channel may correspond to a set of resource elements for conveying information generated in a higher layer. A downlink physical channel may be a physical channel used in a downlink component carrier. The base station apparatus 3 may transmit a downlink physical channel. The terminal apparatus 1 may receive a downlink physical channel. In the radio communication system according to an aspect of the present embodiment, at least a part or all of the following downlink physical channels may be used:
Physical Broadcast Channel (PBCH);
Physical Downlink Control Channel (PDCCH); and
Physical Downlink Shared Channel (PDSCH).

The PBCH may be transmitted for conveying one or both of a Master Information Block (MIB) and physical layer control information. Here, the physical layer control information is information generated in the physical layer. The MIB is a set of parameters mapped to a Broadcast Control CHannel (BCCH) that is a logical channel of the MAC layer. The BCCH is mapped to a BCH that is a channel of a transport layer. The BCH may be mapped to the PBCH. The terminal apparatus 1 may receive the PBCH to which one or both of the MIB and the physical layer control information are mapped. The base station apparatus 3 may transmit the PBCH to which one or both of the MIB and/or the physical layer control information are mapped.

For example, the physical layer control information may include 8 bits. The physical layer control information may include at least a part or all of the following 0A to 0D.
0A) Radio frame bits
0B) Half radio frame (half system frame or half frame) bits
0C) SS/PBCH block index bits
0D) Subcarrier offset bits

The radio frame bit is used for indicating a radio frame in which the PBCH is transmitted (radio frame including a slot in which the PBCH is transmitted). The radio frame bit includes 4 bits. The radio frame bit may include 4 bits out of a 10-bit radio frame indicator. For example, the radio frame indicator may be at least used for identifying radio frames from index 0 to index 1023.

The half radio frame bit is used for indicating, out of the radio frame in which the PBCH is transmitted, which of the first five subframes or the last five subframes is used for transmission of the PBCH. Here, the half radio frame may include five subframes. In addition, the half radio frame may include the first five subframes out of the 10 subframes included in the radio frame. In addition, the half radio frame may include the last five subframes out of the 10 subframes included in the radio frame.

An SS/PBCH block index bit is used for indicating an SS/PBCH block index. The SS/PBCH block index bit includes 3 bits. The SS/PBCH block index bit may include 3 bits out of a 6-bit SS/PBCH block index indicator. The SS/PBCH block index indicator may be at least used for identifying SS/PBCH blocks of the index 0 to index 63.

A subcarrier offset bit is used for indicating a subcarrier offset. The subcarrier offset may be used for indicating a difference between the leading subcarrier to which the PBCH is mapped and the leading subcarrier to which the control resource set having the index 0 is mapped.

The PDCCH may be transmitted for conveying Downlink Control Information (DCI). The downlink control information may be mapped to the PDCCH. The terminal apparatus 1 may receive the PDCCH to which the downlink control information is mapped. The base station apparatus 3 may transmit the PDCCH to which the downlink control information is mapped.

The downlink control information may be transmitted in a DCI format. Note that the DCI format may also be interpreted as the format of downlink control information. In addition, the DCI format may be interpreted as a set of downlink control information set to the format of certain downlink control information.

A DCI format 0_0, a DCI format 0_1, a DCI format 1_0, and a DCI format 1_1 are DCI formats. An uplink DCI format is a general term for the DCI format 0_0 and the DCI format 0_1. A downlink DCI format is a general term for the DCI format 1_0 and the DCI format 1_1.

The DCI format 0_0 is at least used for scheduling of the PUSCH mapped to a certain cell. The DCI format 0_0 includes at least a part or all of fields listed from 1A to 1E.
1A) Identifier field for DCI formats
1B) Frequency domain resource assignment field
1C) Time domain resource assignment field
1D) Frequency hopping flag field
1E) Modulation and Coding Scheme (MCS) field

An identifier field for DCI formats may indicate whether the DCI format including the identifier field for DCI formats is an uplink DCI format or a downlink DCI format. In other words, an identifier field for DCI formats may be included in each of the uplink DCI format and the downlink DCI format. Here, the identifier field for DCI formats included in the DCI format 0_0 may indicate 0.

A frequency domain resource assignment field included in the DCI format 0_0 may be used for indicating assignment of frequency resources for the PUSCH,

A time domain resource assignment field included in the DCI format 0_0 may be used for indicating assignment of time resources for the PUSCH.

A frequency hopping flag field may be used for indicating whether frequency hopping is applied to the PUSCH.

An MCS field included in the DCI format 0_0 may be at least used for indicating one or both of a modulation scheme for the PUSCH and a target encoding rate. The target encoding rate may be a target encoding rate for the transport block mapped to the PUSCH. A transport block size (TBS) mapped to the PUSCH may be determined based on one or both of the target encoding rate and the modulation scheme for the PUSCH.

The DCI format 0_0 need not include a field used for a CSI request.

The DCI format 0_0 need not include a carrier indicator field. In other words, the serving cell to which the uplink component carrier to which the PUSCH scheduled in the DCI format 0_0 is mapped belongs may be the same as the serving cell of the uplink component carrier to which the PDCCH including the DCI format 0_0 is mapped. Based on detection of the DCI format 0_0 in a certain downlink component carrier of a certain serving cell, the terminal apparatus 1 may recognize that the PUSCH scheduled in the DCI format 0_0 is mapped to the uplink component carrier of the certain serving cell.

The DCI format 0_0 need not include a BWP field (BWP indicator field). Here, the DCI format 0_0 may be a DCI format for scheduling the PUSCH without changing an active uplink BWP. The terminal apparatus 1 may recognize that the PUSCH is transmitted without switching the active uplink BWP based on detection of the DCI format 0_0 used for the scheduling of the PUSCH.

The DCI format 0_1 is at least used for scheduling of the PUSCH mapped to a certain cell. The DCI format 0_1 includes at least a part or all of fields listed from 2A to 2H.
2A) Identifier field for DCI formats
2B) Frequency domain resource assignment field
2C) Uplink time domain resource assignment field
2D) Frequency hopping flag field
2E) MCS field
2F) CSI request field
2G) BWP field
2H) Carrier indicator field

The identifier field for DCI formats included in the DCI format 0_1 may indicate 0.

The frequency domain resource assignment field included in the DCI format 0_1 may be used for indicating assignment of frequency resources for the PUSCH.

The time domain resource assignment field included in the DCI format 0_1 may be used for indicating assignment of time resources for the PUSCH.

The MCS field included in the DCI format 0_1 may be at least used for indicating a part or all of a modulation scheme for the PUSCH and/or a target encoding rate.

The BWP field of the DCI format 0_1 may be used for indicating an uplink BWP to which the PUSCH scheduled in the DCI format 0_1 is mapped. In other words, the DCI format 0_1 may be accompanied by a change in the active uplink BWP. The terminal apparatus 1 may recognize the uplink BWP to which the PUSCH is mapped based on detection of the DCI format 0_1 used for scheduling of the PUSCH.

The DCI format 0_1 not including the BWP field may be a DCI format for scheduling the PUSCH without changing the active uplink BWP. The terminal apparatus 1 may recognize that the PUSCH is transmitted without switching the active uplink BWP based on detection of the DCI format D0_1 which is the DCI format 0_1 used for the scheduling of the PUSCH and does not include the BWP field.

In a case that the BWP field is included in the DCI format 0_1 but the terminal apparatus 1 does not support the function of switching the BWP according to the DCI format 0_1, the terminal apparatus 1 may disregard the BWP field. In other words, the terminal apparatus 1 which does not support the function of switching the BWP may recognize that the PUSCH is transmitted without switching the active uplink BWP based on detection of the DCI format 0_1 which is the DCI format 0_1 used for the scheduling of the PUSCH and includes the BWP field. Here, in a case that the terminal apparatus 1 supports the function of switching the BWP, the terminal apparatus 1 may report, in a function information reporting procedure of the RRC layer, that “the terminal apparatus I supports the function of switching the BWP”.

The CSI request field is used for indicating a report of CSI

In a case that a carrier indicator field is included in the DCI format 0_1, the carrier indicator field may be used for indicating the uplink component carrier to which the PUSCH is mapped. In a case that a carrier indicator field is not included in the DCI format 0_1, the uplink component carrier to which the PUSCH is mapped may be the same as the uplink component carrier to which the PDCCH including the DCI format 0_1 used for scheduling of the PUSCH is mapped. In a case that the number of uplink component carriers configured for the terminal apparatus 1 in a certain serving cell group is two or more (a case that uplink carrier aggregation is operated in a certain serving cell group), the number of bits of the carrier indicator field included in the DCI format 0_1 used for scheduling of the PUSCH mapped to the certain serving cell group may be 1 bit or more (for example, 3 bits). In a case that the number of uplink component carriers configured for the terminal apparatus 1 in a certain serving cell group is one (a case that uplink carrier aggregation is not operated in a certain serving cell group), the number of bits of the carrier indicator field included in the DCI format 0_1 used for scheduling of the PUSCH mapped to the certain serving cell group may be 0 bits (or the carrier indicator field may not be included in the DCI format 0_1 used for scheduling of the PUSCH mapped to the certain serving cell group).

The DCI format 1_0 is at least used for scheduling of the PDSCH mapped to a certain cell. The DCI format 1_0 includes at least a part or all of 3A to 3F:
3A) Identifier field for DCI formats;
3B) Frequency domain resource assignment field;
3C) Time domain resource assignment field;
3D) MCS field;
3E) PDSCH HARQ feedback timing indicator field (PDSCH to HARQ feedback timing indicator field); and
3F) PUCCH resource indicator field.

The identifier field for DCI formats included in the DCI format 1_0 may indicate 1.

The frequency domain resource assignment field included in the DCI format 1_0 may be at least used for indicating assignment of frequency resources for the PDSCH.

The time domain resource assignment field included in the DCI format 1_0 may be at least used for indicating assignment of time resources for the PDSCH.

The MCS field included in the DCI format 1_0 may be at least used for indicating one or both of the modulation scheme for the PDSCH and the target encoding rate. The target encoding rate may be a target encoding rate for a transport block mapped to the PDSCH. The size of a transport block (Transport Block Size or TBS) mapped to the PDSCH may be determined based on one or both of the target encoding rate and the modulation scheme for the PDSCH.

The PDSCH HARQ feedback timing indicator field may be used for indicating an offset from the slot including the last OFDM symbol of the PDSCH to the slot including the first OFDM symbol of the PUCCH.

The PUCCH resource indicator field may be a field indicating an index of any of one or multiple PUCCH resources included in a PUCCH resource set. The PUCCH resource set may include one or multiple PUCCH resources.

The DCI format 1_0 may not include the carrier indicator field. In other words, the downlink component carrier to which the PDSCH scheduled by using the DCI format 1_0 is mapped may be the same as the downlink component carrier to which the PDCCH including the DCI format 1_0 is mapped. Based on detection of the DCI format 1_0 on a certain downlink component carrier, the terminal apparatus 1 may recognize that the PDSCH scheduled in the DCI format 1_0 is mapped to the downlink component carrier.

The DCI format 1_0 may not include a BWP field. Here, DCI format 1_0 may be a DCI format for scheduling the PDSCH without changing the active downlink BWP. The terminal apparatus 1 may recognize that the PDSCH is received without switching the active downlink BWP based on detection of the DCI format 1_0 used in scheduling of the PDSCH.

The DCI format 1_1 is at least used for scheduling of the PDSCH mapped to a certain cell. The DCI format 1_1 includes at least some or all of 4A to 4I:
4A) Identifier field for DCI formats;
4B) Frequency domain resource assignment field;
4C) Time domain resource assignment field;
4E) MCS field;
4F) PDSCH_HARQ feedback timing indicator field;
4G) PUCCH resource indicator field;
4H) BWP field; and
4I) Carrier indicator field.

The identifier field for DCI formats included in the DCI format 1_1 may indicate 1.

The frequency domain resource assignment field included in the DCI format 1_1 may be at least used for indicating assignment of frequency resources for the PDSCH.

The time domain resource assignment field included in the DCI format 1_1 may be at least used for indicating assignment of time resources for the PDSCH.

The MCS field included in the DCI format 1_1 may be at least used for indicating one or both of the modulation scheme for the PDSCH and the target encoding rate.

In a case that the PDSCH HARQ feedback timing indicator field is included in the DCI format 1_1, the PDSCH_HARQ feedback timing indicator field may be at least used for indicating an offset from the slot including the last OFDM symbol of the PDSCH to the slot including the first OFDM symbol of the PUCCH. In a case that the PDSCH HARQ feedback timing indicator field is not included in the DCI format 1_1, an offset from the slot including the last OFDM symbol of the PDSCH to the slot including the first OFDM symbol of the PUCCH may be identified by a higher layer parameter.

The PUCCH resource indicator field may be a field indicating an index of any of one or multiple PUCCH resources included in a PUCCH resource set.

The BWP field of the DCI format 1_1 may be used to indicate the downlink BWP to which the PDSCH scheduled in the DCI format 1_1 is mapped. In other words, the DCI format 1_1 may be accompanied by a change in the active downlink BWP. The terminal apparatus 1 may recognize the downlink BWP to which the PUSCH is mapped based on detection of the DCI format 1_1 used for the scheduling of the PDSCH.

The DCI format 1_1 not including the BWP field may be a DCI format for scheduling the PDSCH without changing the active downlink BWP. The terminal apparatus 1 may recognize that the PDSCH is received without switching the active downlink BWP based on detection of the DCI format 1_1 which is used for the scheduling of the PDSCH and the DCI format 1_1 not including the BWP field.

In a case that the DCI format 1_1 includes the BWP field but the terminal apparatus 1 does not support the function of switching the BWP according to the DCI format 1_1, the terminal apparatus 1 may disregard the BWP field. In other words, the terminal apparatus 1 which does not support the function of switching the BWP may recognize that the PDSCH is received without switching the active downlink BWP based on detection of the DCI format 1_1 which is used for the scheduling of the PDSCH and the DCI format 1_1 including the BWP field. Here, in a case that the terminal apparatus 1 supports the function of switching the BWP, the terminal apparatus 1 may report, in a function information reporting procedure of the RRC layer, that “the terminal apparatus 1 supports the function of switching the BWP”.

In a case that the carrier indicator field is included in the DCI format 1_1, the carrier indicator field may be used for indicating the downlink component carrier to which the PDSCH is mapped. In a case that the carrier indicator field is not included in the DCI format 1_1, the downlink component carrier to which the PDSCH is mapped may be the same as the downlink component carrier to which the PDCCH including the DCI format 1_1 used for scheduling of the PDSCH is mapped. In a case that the number of downlink component carriers configured for the terminal apparatus 1 in a certain serving cell group is two or more (a case that downlink carrier aggregation is operated in a certain serving cell group), the number of bits of the carrier indicator field included in the DCI format 1_1 used for scheduling of the PDSCH mapped to the certain serving cell group may be 1 bit or more (for example, 3 bits). In a case that the number of downlink component carriers configured for the terminal apparatus 1 in a certain serving cell group is one (a case that downlink carrier aggregation is not operated in a certain serving cell group), the number of bits of the carrier indicator field included in the DCI format 1_1 used for scheduling of the PDSCH mapped to the certain serving cell group may be 0 bits (or the carrier indicator field may not be included in the DCI format 1_1 used for scheduling of the PDSCH mapped to the certain serving cell group).

The PDSCH may be transmitted for conveying a transport block. The PDSCH may be used for transmitting a transport block delivered on the DL-SCH. The PDSCH may be used for conveying a transport block. A transport block may be mapped to the PDSCH. The transport block corresponding to the DL-SCH may be mapped to the PDSCH. The base station apparatus 3 may transmit the PDSCH. The terminal apparatus 1 may receive the PDSCH.

A downlink physical signal may correspond to a set of resource elements. The downlink physical signal may not carry information generated in a higher layer. The downlink physical signal may be a physical signal used in a downlink component carrier. The downlink physical signal may be transmitted by the base station apparatus 3. The downlink physical signal may be transmitted by the terminal apparatus 1. In the radio communication system according to an aspect of the present embodiment, at least some or all of the following downlink physical signals may be used:
Synchronization signal (SS);
DownLink DeModulation Reference Signal (DL DMRS);
Channel State Information-Reference Signal (CSI-RS), and
DownLink Phase Tracking Reference Signal (DL PTRS).

The synchronization signal may be used for the terminal apparatus 1 to take synchronization in one or both of the frequency domain and the time domain in downlink. The synchronization signal is a general term for a primary synchronization signal (PSS) and a secondary synchronization signal (SSS).

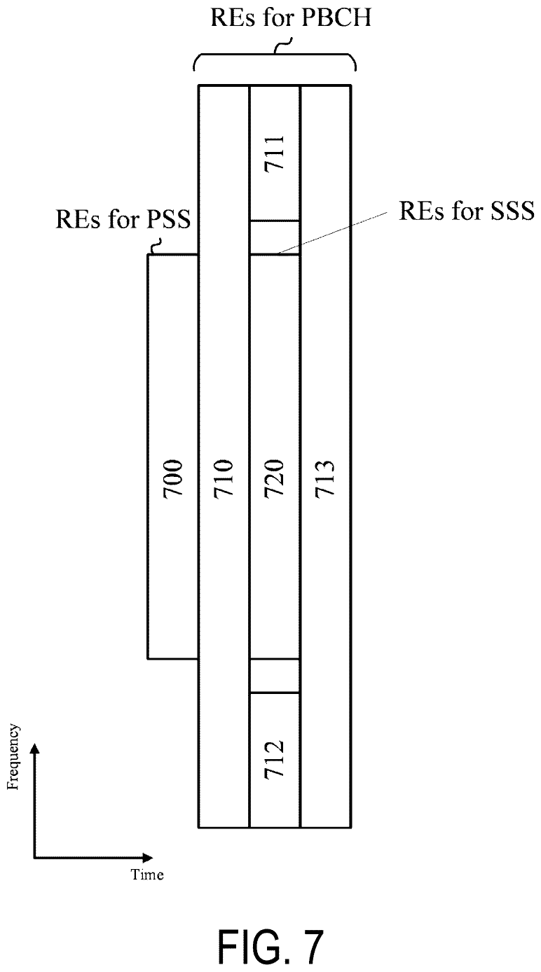

FIG. 7 is a diagram illustrating a configuration example of the SS/PBCH block according to an aspect of the present embodiment. In FIG. 7, the horizontal axis corresponds to a time axis (OFDM symbol index l_{sym}), and the vertical axis represents the frequency domain. In addition, a block 700 represents a set of resource elements for a PSS. In addition, a block 720 represents a set of resource elements for an SSS. In addition, four blocks (blocks 710, 711, 712, and 713) represent a set of resource elements for a PBCH and a DMRS for the PBCH (DMRS related to the PBCH, DMRS included in the PBCH, or DMRS corresponding to the PBCH).

As illustrated in FIG. 7, the SS/PBCH block includes a PSS, an SSS, and a PBCH. In addition, the SS/PBCH block includes four continuous OFDM symbols. The SS/PBCH block includes 240 subcarriers. The PSS is mapped to the 57th to 183rd subcarriers in the first OFDM symbol. The SSS is mapped to the 57th to 183rd subcarriers in the third OFDM symbol. Zero may be set to the 1st to 56th subcarriers of the first OFDM symbol. Zero may be set to the 184th to 240th subcarriers of the first OFDM symbol. Zero may be set to the 49th to 56th subcarriers of the third OFDM symbol. Zero may be set to the 184th to 192nd subcarriers of the third OFDM symbol. The PBCH is mapped to subcarriers which are the 1st to 240th subcarriers of the second OFDM symbol and to which a DMRS for the PBCH is not mapped. The PBCH is mapped to subcarriers which are the 1st to 48th subcarriers of the third OFDM symbol and to which a DMRS for the PBCH is not mapped. The PBCH is mapped to subcarriers which are the 193rd to 240th subcarriers of the third OFDM symbol and to which a DMRS for the PBCH is not mapped. The PBCH is mapped to subcarriers which are the 1st to 240th subcarriers of the fourth OFDM symbol and to which a DMRS for the PBCH is not mapped.

The antenna ports of the PSS, the SSS, the PBCH, and the DMRS for the PBCH may be the same.

The PBCH over which the symbol of the PBCH on a certain antenna port is conveyed may be inferred from the DMRS for the PBCH mapped to the slot to which the PBCH is mapped and the DMRS for the PBCH included in the SS/PBCH block including the PBCH.

The DL DMRS is a general term for a DMRS for the PBCH, a DMRS for the PDSCH, and a DMRS for the PDCCH.

A set of antenna ports of the DMRS for the PDSCH (a DMRS related to the PDSCH, a DMRS included in the PDSCH, or a DMRS corresponding to the PDSCH) may be given based on a set of antenna ports for the PDSCH. In other words, the set of antenna ports of the DMRS for the PDSCH may be the same as the set of antenna ports for the PDSCH.

Transmission of the PDSCH and transmission of the DMRS for the PDSCH may be indicated (or may be scheduled) in one DCI format. The PDSCH and the DMRS for the PDSCH may be collectively referred to as a PDSCH. Transmission of the PDSCH may be transmission of the PDSCH and the DMRS for the PDSCH.

A propagation path of the PDSCH may be inferred from the DMRS for the PDSCH. In a case that a set of resource elements in which the symbol of a certain PDSCH is conveyed and a set of resource elements in which the symbol of the DMRS for the certain PDSCH is conveyed are included in the same Precoding Resource Group (PRG), the PDSCH over which the symbol of the PDSCH on a certain antenna port is conveyed may be inferred from the DMRS for the PDSCH.

The antenna port of the DMRS for the PDCCH (the DMRS related to the PDCCH, the DMRS included in the PDCCH, or the DMRS corresponding to the PDCCH) may be the same as the antenna port for the PDCCH.

The PDCCH may be inferred from the DMRS for the PDCCH. In other words, a propagation path of the PDCCH may be inferred from the DMRS for the PDCCH. In a case that the same precoder is applied (in a case that the same precoder is assumed to be applied, or in a case of assuming that the same precoder is applied) to a set of resource elements in which the symbol of a certain PDCCH is conveyed and a set of resource elements in which the symbol of the DMRS for the certain PDCCH is conveyed, the PDCCH over which the symbol of the PDCCH on a certain antenna port is conveyed may be inferred from the DMRS for the PDCCH.

A Broadcast CHannel (BCH), an Uplink-Shared CHannel (UL-SCH), and a Downlink-Shared CHannel (DL-SCH) are transport channels. A transport channel defines the relationship between a physical layer channel and a MAC layer channel (also referred to as a logical channel).

A BCH of the transport layer is mapped to the PBCH of the physical layer. In other words, a transport block passing through the BCH of the transport layer is delivered to the PBCH of the physical layer. In addition, the UL-SCH of the transport layer is mapped to the PUSCH of the physical layer. In other words, the transport block passing through the UL-SCH of the transport layer is delivered to the PUSCH of the physical layer. In addition, the DL-SCH of the transport layer is mapped to the PDSCH of the physical layer. In other words, a transport block passing through the DL-SCH of the transport layer is delivered to the PDSCH of the physical layer.

One UL-SCH and one DL-SCH may be given to each serving cell. The BCH may be given to a PCell. The BCH may not be given to a PSCell and an SCell.

In the MAC layer, control over a Hybrid Automatic Repeat reQuest (HARQ) is performed for each transport block.

A Broadcast Control CHannel (BCCH), a Common Control CHannel (CCCH), and a Dedicated Control CHannel (DCCH) are logical channels. For example, the BCCH is a channel of the RRC layer used for transmitting a MIB or system information. In addition, a Common Control Channel (CCCH) may be used for transmitting a common RRC message in multiple terminal apparatuses 1. Here, the CCCH may be, for example, used for a terminal apparatus 1 that is not in a state of RRC connection. In addition, a Dedicated Control CHannel (DCCH) may be at least used for transmitting an RRC message dedicated to a terminal apparatus 1. Here, the DCCH may be, for example, used for the terminal apparatus 1 that is in a state of RRC connection.

A higher layer parameter common to multiple terminal apparatuses 1 is also referred to as a common higher layer parameter. Here, the common higher layer parameter may be defined as a parameter specific to a serving cell. Here, a parameter specific to a serving cell may be a parameter common to terminal apparatuses configured with the serving cell (for example, terminal apparatuses 1-A, 1-B, and 1-C).

For example, an RRC message delivered to the BCCH may include the common higher layer parameter. For example, an RRC message delivered on the DCCH may include the common higher layer parameter.

Among certain higher layer parameters, a higher layer parameter different from the common higher layer parameter is also referred to as a dedicated higher layer parameter. Here, the dedicated higher layer parameter can provide a dedicated RRC parameter to the terminal apparatus 1-A configured with the serving cell. In other words, the dedicated RRC parameter is a higher layer parameter capable of providing a unique configuration to each of the terminal apparatuses 1-A, 1-B, and 1-C.

The BCCH of the logical channel may be mapped to the BCH or the DL-SCH of the transport layer. For example, a transport block including information of an MIB is delivered to the BCH of the transport layer. In addition, a transport block including system information other than the MIB is delivered to the DL-SCH of the transport layer. In addition, the CCCH is mapped to the DL-SCH or the UL-SCH. In other words, a transport block mapped to the CCCH is delivered to the DL-SCH or the UL-SCH. In addition, the DCCH is mapped to the DL-SCH or the UL-SCH. In other words, a transport block mapped to the DCCH is delivered to the DL-SCH or the UL-SCH.

An RRC message includes one or multiple parameters managed in the RRC layer. Here, the parameters managed in the RRC layer are also referred to as RRC parameters. For example, the RRC message may include the MIB. In addition, the RRC message may include system information. In addition, the RRC message may include a message corresponding to the CCCH. In addition, the RRC message may include a message corresponding to the DCCH. An RRC message including a message corresponding to the DCCH is also referred to as an individual RRC message.

A higher layer parameter (parameter in higher layer) is an RRC parameter or a parameter included in a Medium Access Control Control Element (MAC CE). In other words, the higher layer parameter is a general term for the MIB, the system information, a message corresponding to the CCCH, a message corresponding to the DCCH, and a parameter included in a MAC CE. The parameter included in the MAC CE is transmitted by using a MAC Control Element (CE) command.

Procedures performed by the terminal apparatus 1 include at least some or all of the following 5A to 5C:
5A) Cell search;
5B) Random access; and
5C) Data communication

The cell search is a procedure used for the terminal apparatus 1 synchronizing with a certain cell related to the time domain and the frequency domain and detecting a physical cell identity (physical cell ID). In other words, by means of the cell search, the terminal apparatus 1 may perform synchronization with a certain cell in the time domain and the frequency domain and detect a physical cell ID.

A sequence of the PSS is given based at least on the physical cell ID. A sequence of the SSS is given based at least on the physical cell ID.

An SS/PBCH block candidate indicates a resource allowed to (possible to, scheduled to, configured to, defined to, having a possibility to) transmit the SS/PBCH block.

A set of SS/PBCH block candidates in a certain half radio frame is also referred to as an SS burst set. An SS burst set is also referred to as a transmission window, an SS transmission window, or a Discovery Reference Signal transmission window (DRS transmission window). The SS burst set is a general term including at least a first SS burst set and a second SS burst set.

The base station apparatus 3 transmits SS/PBCH blocks with one or multiple indices with a prescribed period. The terminal apparatus 1 may detect at least one SS/PBCH block out of the SS/PBCH blocks with one or multiple indices and attempt decoding of the PBCH included in the SS/PBCH block.

The random access is a procedure including at least some or all of a message 1, a message 2, a message 3, and a message 4.

The message 1 is a procedure in which the PRACH is transmitted by the terminal apparatus 1. The terminal apparatus 1 transmits the PRACH in one PRACH occasion selected out of one or multiple PRACH occasions based at least on the index of the SS/PBCH block candidate detected based on the cell search. Each of the PRACH occasions is defined based at least on resources in the time domain and the frequency domain.

The terminal apparatus I transmits one random access preamble selected out of the PRACH occasions corresponding to the indices of the SS/PBCH block candidates in which the SS/PBCH block is detected.

The message 2 is a procedure of attempting to detect a DCI format 1_0 with a Cyclic Redundancy Check (CRC) scrambled by a Random Access-Radio Network Temporary Identifier (RA-RNTI) by the terminal apparatus 1. The terminal apparatus 1 attempts detection of the PDCCH including the DCI format in a control resource set given based on the MIB, which is included in the PBCH included in the SS/PBCH block detected based on a cell search, and in resources indicated based on a configuration of a search space set. The message 2 is also referred to as a random access response.

The message 3 is a procedure of transmitting the PUSCH scheduled by using a random access response grant included in the DCI format 1_0 detected through the procedure of the message 2. Here, the random access response grant is indicated by a MAC CE included in the PDSCH scheduled by using the DCI format 1_0.

The PUSCH scheduled based on the random access response grant is either a message 3 PUSCH or a PUSCH. The message 3 PUSCH includes a contention resolution identifier (contention resolution ID) MAC CE. The contention resolution ID MAC CE includes a contention resolution ID.

Retransmission of the message 3 PUSCH is scheduled by using a DCI format 0_0 with a CRC scrambled based on a Temporary Cell-Radio Network Temporary Identifier (TC-RNTI).

The message 4 is a procedure of attempting to detect the DCI format 1_0 with a CRC scrambled based on either of a Cell-Radio Network Temporary Identifier (C-RNTI) or a TC-RNTI. The terminal apparatus 1 receives a PDSCH scheduled based on the DCI format 1_0. The PDSCH may include a contention resolution ID.

Data communication is a general term for downlink communication and uplink communication.

In the data communication, the terminal apparatus 1 attempts detection of the PDCCH (monitors the PDCCH or supervises the PDCCH) in a control resource set and resources identified based on a search space set.

The control resource set (CORESET) is a set of resources including a prescribed number of resource blocks and a prescribed number of OFDM symbols. In the frequency domain, the control resource set may include continuous resources (non-interleaved mapping) or may include distributed resources (interleaver mapping).

A set of resource blocks constituting the control resource set may be indicated by a higher layer parameter. The number of OFDM symbols constituting the control resource set may be indicated by a higher layer parameter.

The terminal apparatus 1 attempts detection of the PDCCH in a search space set. Here, an attempt to detect the PDCCH in the search space set may be an attempt to detect a candidate of the PDCCH in the search space set, may be an attempt to detect a DCI format in the search space set, may be an attempt to detect the PDCCH in the control resource set, may be an attempt to detect a candidate of the PDCCH in the control resource set, or may be an attempt to detect a DCI format in the control resource set.

The search space set is defined as a set of candidates of the PDCCH. The search space set may be a Common Search Space (CSS) set or may be a UE-specific Search Space (USS) set. The terminal apparatus 1 attempts detection of candidates of the PDCCH in some or all of a Type 0 PDCCH common search space set, a Type 0a PDCCH common search space set, a Type 1 PDCCH common search space set, a Type 2 PDCCH common search space set, a Type 3 PDCCH common search space set, and/or a UE-specific PDCCH search space set (UE-specific search space set).

The Type 0 PDCCH common search space set may be used as a common search space set having the index 0. The Type 0 PDCCH common search space set may be a common search space set having the index 0.

A CSS set is a general term for the Type 0 PDCCH common search space set, the Type 0a PDCCH common search space set, the Type 1 PDCCH common search space set, the Type 2 PDCCH common search space set, and the Type 3 PDCCH common search space set. A USS set is also referred to as a UE-specific PDCCH search space set.

A certain search space set is related to (included in or corresponds to) a certain control resource set. The index of the control resource set related to the search space set may be indicated by a higher layer parameter.

For a certain search space set, some or all of 6A to 6C may be indicated by at least a higher layer parameter:
6A) PDCCH monitoring periodicity
6B) PDCCH monitoring pattern within a slot
6C) PDCCH monitoring offset

The monitoring occasion of a certain search space set may correspond to the OFDM symbol to which the first OFDM symbol of a control resource set related to the certain search space set is mapped. The monitoring occasion of a certain search space set may correspond to a resource of a control resource set starting from the first OFDM symbol of the control resource set related to the certain search space set. The monitoring occasion of the search space set is given based at least on some or all of the monitoring periodicity of the PDCCH, the monitoring pattern of the PDCCH in a slot, and a monitoring offset of the PDCCH.

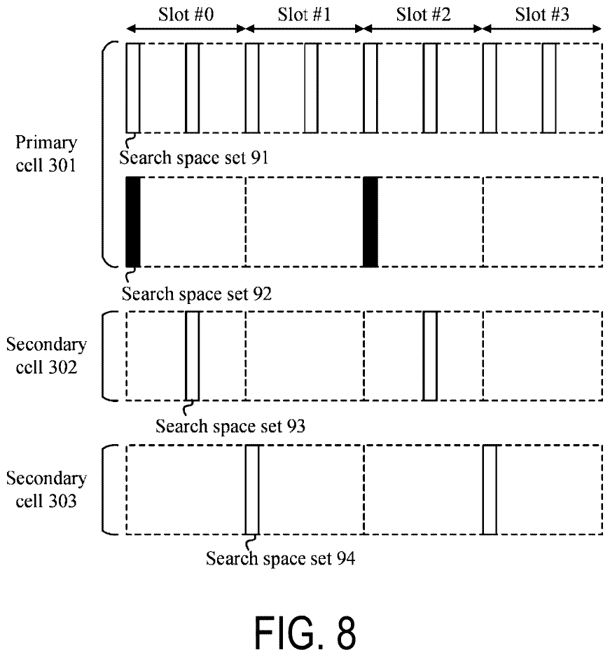

FIG. 8 is a diagram illustrating an example of the monitoring occasions for the search space sets according to an aspect of the present embodiment. In FIG. 8, search space set 91 and search space set 92 are configured in a primary cell 301, search space set 93 is configured in a secondary cell 302, and search space set 94 is configured in a secondary cell 303.

In FIG. 8, solid white blocks in the primary cell 301 represent the search space set 91, solid black blocks in the primary cell 301 represent the search space set 92, blocks in the secondary cell 302 represent the search space set 93, and blocks in the secondary cell 303 represent the search space set 94.

The monitoring periodicity of the search space set 91 is set to one slot, the monitoring offset of the search space set 91 is set to zero slots, and the monitoring pattern of the search space set 91 is set to [1, 0, 0, 0, 0, 0, 0, 1, 0, 0, 0, 0, 0, 0]. In other words, the monitoring occasion of the search space set 91 corresponds to the first OFDM symbol (OFDM symbol #0) and the 8th OFDM symbol (OFDM symbol #7) in each of the slots.

The monitoring periodicity of the search space set 92 is set to two slots, the monitoring offset of the search space set 92 is set to zero slots, and the monitoring pattern of the search space set 92 is set to [1, 0, 0, 0, 0, 0, 0, 0, 0, 0, 0, 0, 0, 0]. In other words, the monitoring occasion of the search space set 92 corresponds to the first OFDM symbol (OFDM symbol #0) in each of the even-numbered slots.

The monitoring periodicity of the search space set 93 is set to two slots, the monitoring offset of the search space set 93 is set to zero slots, and the monitoring pattern of the search space set 93 is set to [0, 0, 0, 0, 0, 0, 0, 1, 0, 0, 0, 0, 0, 0]. In other words, the monitoring occasion of the search space set 93 corresponds to the 8th OFDM symbol (OFDM symbol #7) in each of the even-numbered slots.

The monitoring periodicity of the search space set 94 is set to two slots, the monitoring offset of the search space set 94 is set to one slot, and the monitoring pattern of the search space set 94 is set to [1, 0, 0, 0, 0, 0, 0, 0, 0, 0, 0, 0, 0, 0]. In other words, the monitoring occasion of the search space set 94 corresponds to the first OFDM symbol (OFDM symbol #0) in each of the odd-numbered slots.

The Type 0 PDCCH common search space set may be at least used for the DCI format with a Cyclic Redundancy Check (CRC) sequence scrambled by a System Information-Radio Network Temporary Identifier (SI-RNTI).

The Type Oa PDCCH common search space set may be at least used for the DCI format with a Cyclic Redundancy Check (CRC) sequence scrambled by a System Information-Radio Network Temporary Identifier (SI-RNTI).

The Type 1 PDCCH common search space set may be at least used for the DCI format with a CRC sequence scrambled by a Random Access-Radio Network Temporary Identifier (RA-RNTI) and/or a CRC sequence scrambled by a Temporary Cell-Radio Network Temporary Identifier (TC-RNTI).

The Type 2 PDCCH common search space set may be used for the DCI format with a CRC sequence scrambled by a Paging-Radio Network Temporary Identifier (P-RNTI).

The Type 3 PDCCH common search space set may be used for the DCI format with a CRC sequence scrambled by a Cell-Radio Network Temporary Identifier (C-RNTI).

The UE-specific PDCCH search space set may be at least used for the DCI format with a CRC sequence scrambled by C-RNTI.

In downlink communication, the terminal apparatus 1 detects a downlink DCI format. The detected downlink DCI format is at least used for resource assignment of the PDSCH. The detected downlink DCI format is also referred to as downlink assignment. The terminal apparatus 1 attempts reception of the PDSCH. A HARQ-ACK corresponding to the PDSCH (HARQ-ACK corresponding to the transport block included in the PDSCH) is reported to the base station apparatus 3 based on PUCCH resources indicated based on the detected downlink DCI format.

In uplink communication, the terminal apparatus 1 detects an uplink DCI format. The detected DCI format is at least used for resource assignment of the PUSCH. The detected uplink DCI format is also referred to as an uplink grant. The terminal apparatus 1 performs transmission of the PUSCH.

In configured scheduling (configured grant), the uplink grant for scheduling the PUSCH is configured for each transmission periodicity of the PUSCH. A part or all of pieces of information indicated by an uplink DCI format in a case that the PUSCH is scheduled by the uplink DCI format may be indicated by the uplink grant configured in a case of the configured scheduling.

The PUSCH transmission may correspond to a configured scheduling type 1 or a configured scheduling type 2. In other words, the configured scheduling may be any one of the configured scheduling type 1 or the configured scheduling type 2. A PUSCH transmission of the configured scheduling type 1 is semi-statically configured. For example, a PUSCH transmission of the configured scheduling type 1 may be operated in response to receiving a certain higher layer parameter. A certain higher layer parameter may be configuredGrantConfig. For example, configuredGrantConfig may include rrc-ConfiguredUplinkGrant. The PUSCH transmission may be operated without detecting an uplink grant in the DCI.

The PUSCH transmission of the configured scheduling type 2 may be semi-persistently scheduled. For example, the PUSCH transmission may be scheduled by a certain uplink grant. The certain uplink grant may be included in activation DCI (or valid activation DCI). For example, after receiving a certain higher layer parameter, the PUSCH transmission of the configured scheduling type 2 may be scheduled by a certain uplink grant. A certain higher layer parameter may be configuredGrantConfig. For example, configuredGrantConfig need not include rrc-ConfiguredUplinkGrant.

A system frame number (SFN) ne may be a number assigned to a radio frame and/or an index for a radio frame. The system frame number may include 10 bits. At least a part of the system frame number may be signaled in the MIB. For example, 6 bits (e.g., 6 most significant bits) of the 10-bit system frame number may be signaled in the MIB. At least a part of the system frame number may be determined based on the PBCH for conveying the MIB. For example, 4 bits (e.g., 4 least significant bits) of the 10-bit system frame number may be conveyed in a PBCH transport block as a part of channel coding.

PDCCH-Config may be a dedicated higher layer parameter. PDCCH-Config may configure a parameter for a PDCCH. Multiple (for example, up to three) CORESETs may be configured in PDCCH-Config. A CORESET ID may be configured in one CORESET. One CORESET pool index may be configured in one CORESET.

PDSCH-Config may be a dedicated higher layer parameter. PDSCH-Config may configure a parameter for a PDSCH.

In a case that multiple PDCCH candidates (PDCCH candidate(s)) are associated with a search space set configured by a higher layer parameter, one PDCCH candidate is used. The one PDCCH candidate may be one of two PDCCH candidates that starts earlier. The higher layer parameter may be a searchSpaceLinking.

At least two transmission schemes may be supported for the PUSCH. For example, codebook-based transmission may be one of the transmission schemes for the PUSCH. For example, non-codebook-based transmission may be one of the transmission schemes for the PUSCH. A higher layer parameter may provide one of codebook-based transmission and non-codebook-based transmission. For example, in a case that ‘codebook’ is set for the higher layer parameter, the terminal apparatus 1 may be configured with codebook-based transmission. For example, in a case that ‘nonCodebook’ is set for the higher layer parameter, the terminal apparatus 1 may be configured with non-codebook-based transmission. The higher layer parameter may be txConfig. The higher layer parameter may be usage. For example, in a case that the higher layer parameter is not configured, the terminal apparatus I may not expect scheduling to be performed in either of the DCI format 0_1 and the DCI format 0_2. In a case that the PUSCH is scheduled in the DCI format 0_0, transmission of the PUSCH may be performed based at least on one antenna port.

In codebook-based transmission, the PUSCH may be scheduled in a DCI format. The DCI format may be any one of the DCI format 0_0, the DCI format 0_1, and the DCI format 0_2. In codebook-based transmission, the PUSCH is configured to be transmitted semi-statically. The terminal apparatus 1 may determine one or multiple precoders for PUSCH transmission. For example, the precoder may be determined based at least on some or all of an SRS resource indicator (SRI), a transmitted precoding matrix indicator (TPMI), and a transmission rank (or rank). For example, the SRI may be provided by a DCI field of one or two SRS resource indicators. For example, the TPMI may be provided by a DCI field of one or two pieces of precoding information. For example, the transmission rank may be provided by a DCI field of the number of layers (the number of transmission layers). The SRI may be provided by a first higher layer parameter. The TPMI and the transmission rank may be provided by a second higher layer parameter. The first higher layer parameter may be srs-ResourceIndicator or srs-ResourceIndicator2. The second higher layer parameter may be precodingAndNumberOfLayers or precodingAndNumberOfLayers2.

An SRS resource set applied to the PUSCH may be determined based on the higher layer parameter. The PUSCH may be scheduled by the DCI format 0_1 or the DCI format 0_2. The higher layer parameter may be srs-ResourceSetToAddModList or srs-ResourceSetToAddModeListDCI-0-2. The higher layer parameter may be a higher layer parameter configured in SRS-Config.

In a case that ‘codebook’ is set for the higher layer parameter usage, one or two SRS resource sets may be configured in srs-ResourceSetToAddModList or srs-ResourceSetToAddModListDCI-0-2. The higher layer parameter usage may be configured in the higher layer parameter SRS-ResourceSet.

In a case that one SRS resource set is configured, the SRI and the TPMI may be given by the DCI field. The TPMI may be used to indicate a precoder. The precoder may be applied across v layers. In a case that multiple SRS resources are configured, one SRS resource may be selected by the SRL A transmission precoder (precoder) may be selected from a codebook (uplink codebook). For example, the codebook may have the number of antenna ports. The number of antenna ports may be the same as the higher layer parameter nrofSRS-Ports. In a case that ‘codebook’ is set for the higher layer parameter txConfig, the terminal apparatus 1 may be configured with at least one SRS resource. The indicated SRI may relate to transmission of the SRS resource identified by the SRI.

In a case that two SRS resource sets are configured, one or two SRIs and one or two TPMIs may be given by the DCI field. For example, the DCI field may be one or both of a DCI field for SRS resource indication and a DCI field of precoding information and number of layers. The terminal apparatus 1 may apply the indicated SRI and TPMI to one or multiple PUSCH repetitions. The TPMI may be used to indicate the precoder based on a codepoint for an SRS resource set indication. The precoder may be applied to the 0th layer to (v−1)-th layer, The precoder may correspond to the SRS resource selected by the SRI. Multiple SRS resources may be configured for an applicable SRS resource set. For one or two TPMIs, a transmission precoder (precoder) may be selected from a codebook (uplink codebook). In a case that two SRIs are indicated, the terminal apparatus 1 may expect the numbers of antenna ports for the indicated two SRS resources to be equal. The number of antenna ports may be provided by a higher layer parameter.

In codebook-based transmission, the terminal apparatus 1 may determine a codebook subset. For example, the codebook subset may be determined based at least on a TPMI. The codebook subset may be determined in response to reception of a certain higher layer parameter. The certain higher layer parameter may be codebookSubset or codebookSubsetDCI-0-2. Any of ‘fullyAndPartialAndNonCoherent’, ‘partialAndNonCoherent’, and ‘nonCoherent’ may be set for the certain higher layer parameter. For example, in a case that at least a certain higher layer parameter is set to ‘partialAndNonCoherent’, the codebook subset associated with a 2-port SRS resource (an SRS resource with two ports) may be ‘nonCoherent’. For example, the codebook may include at least one SRS resource with four ports and at least one SRS resource with two ports.

The terminal apparatus 1 may report the UE capability. In a case that the terminal apparatus 1 reports the UE capability of ‘partialAndNonCoherent’ transmission, the terminal apparatus 1 may not expect the codebook subset with ‘fullyAndPartialAndNonCoherent’ to be configured.

In a case that the terminal apparatus 1 reports the UE capability of the ‘nonCoherent’ transmission, the terminal apparatus 1 need not expect that the codebook subset with ‘fullyAndPartialAndNonCoherent’or ‘partialAndNonCoherent’is configured.

In a case that the number of antenna ports indicates that the maximum number of configured SRS antenna ports is 2, the terminal apparatus 1 may not expect the higher layer parameter set to ‘partial AndNonCoherent’ to be configured. The higher layer parameter may be codebookSubset or codebookSubsetForDCI-Format0-2. The number of antenna ports may be determined by the higher layer parameter nrofSRS-Ports.

For codebook-based transmission, one SRS resource may be determined based on the SRI from the SRS resource set. Except the case that a first higher layer parameter is set to ‘fullpowerMode2’, the maximum number of configured SRS resources for codebook-based transmission may be 2. The first higher layer parameter may be ul-FullPowerTransmission. The DCI may indicate transmission of the SRS resource. For example, in a case that an aperiodic SRS is configured, the SRS request field in the DCI may indicate transmission of aperiodic SRS resources. The terminal apparatus 1 may not expect that the first higher layer parameter for which ‘fullpowerModel’ is set and the second higher layer parameter for which ‘fullAndPartialAndNonCoherent’ is set are configured.

The terminal apparatus 1 may transmit the PUSCH by using the same one or multiple antenna ports as one or multiple SRS ports in the SRS resource indicated by the DCI format or the higher layer parameter. For example, the SRS ports may be the same as the antenna ports for PUSCH transmission. A DMRS antenna port may be determined according to ordering of a DMRS port.

In a case that multiple SRS resources are configured by an SRS resource set, the terminal apparatus 1 may expect the higher layer parameter nrofSRS-Ports with the same value for these SRS resources to be configured. The SRS resource set may be the higher layer parameter SRS-ResourceSet with the higher layer parameter usage for which ‘codebook’is set.

In a case that the higher layer parameter is set to ‘fullpowerMode2’, one or multiple SRS resources with the same number or different numbers of SRS ports may be configured in one SRS resource set. In a case that the higher layer parameter is set to ‘fullpowerMode2’, up to two different spatial relations may be configured for all SRS resources in one SRS resource set. In a case that the higher layer parameter is set to ‘fullpowerMode2’, up to two or four SRS resources may be configured in one SRS resource set. In addition, up to eight SRS resources may be configured in one SRS resource set. The SRS resource set may be an SRS resource set with the higher layer parameter usage for which ‘codebook’is set.

For non-codebook-based transmission, the PUSCH may be scheduled by the DCI format 0_0, the DCI format 0_1, or the DCI format 0_2. The terminal apparatus 1 may determine the precoder and the transmission rank of the PUSCH based on the SRI. For example, in a case that multiple SRS resources are configured, the SRI may be given by one or two SRS resource indications in the DCI. For example, the SRI may be given by the higher layer parameter. The SRS resource set applied to the PUSCH may be defined by an entry of the higher layer parameter. The higher layer parameter may be srs-ResourceSetToAddModList or srs-ResourceSetToAddModListDCI-0-2.

The terminal apparatus 1 may use one or multiple SRS resources for SRS transmission. The maximum number of SRS resources in one SRS resource set may be transmitted to the base station apparatus 3 as UE capability (terminal capability). SRS resources may be configured for simultaneous transmission in the same OFDM symbol. Multiple SRS resources transmitted at the same time may occupy the same resource block. One SRS port may be configured in each SRS resource. One or two SRS resource sets may be configured in the higher layer parameter srs-ResourceSetToAddModList where the higher layer parameter usage in the higher layer parameter SRS-ResourceSet is set to ‘nonCodebook’. In a case that two SRS resource sets are configured, one or two SRIs may be given by the DCI field. The DCI field may be a DCI field of two SRS resource indications.

The terminal apparatus 1 may apply the indicated SRI to one or multiple PUSCH repetitions. For example, in accordance with the SRS resource set of the PUSCH repetition, the terminal apparatus 1 may apply the indicated SRI to one or multiple PUSCH repetitions. The maximum number of SRS resources per SRS resource set configured for non-codebook-based transmission may be 4. The maximum number of SRS resources per SRS resource set configured for non-codebook-based transmission may be 8. Each of the indicated one or two SRIs may be associated with the latest transmission of an SRS resource in the SRS resource set identified by the SRI The SRS transmission may be before the PDCCH carrying the SRI. The terminal apparatus 1 may not expect that the different numbers of SRS resources are configured in the two SRS resource sets.

The terminal apparatus 1 may apply an “indicated TCI state” to one or multiple PUSCH repetitions. For example, the terminal apparatus 1 may apply the “indicated TCI state” to one or multiple PUSCH repetitions according to the SRS resource set indicator field or a TRP indicator field. Each of one or two “indicated TCI states” may be associated with the latest indicator of a TCI state indicated by a first DCI format. The first DCI format may be transmitted prior to a second DCI format scheduling the PUSCH repetition.

In a case that multiple PDCCH candidates (PDCCH candidate(s)) are associated with a search space set configured by a higher layer parameter, one PDCCH candidate is used. The one PDCCH candidate may be one of two PDCCH candidates that starts earlier. The higher layer parameter may be a searchSpaceLinking.

For non-codebook-based transmission, the terminal apparatus 1 may calculate a precoder. For example, a precoder used for SRS transmission may be calculated based on measurement of an NZP CSI-RS resource. One NZP CSI-RS resource may be configured for one SRS resource set. For example, one SRS resource set may be an SRS resource set with the higher layer parameter set to ‘nonCodebook’

In a case that an aperiodic SRS resource set is configured, the NZP-CSI RS may be indicated through the SRS request field. The SRS request field may be one of the DCI fields in any one of the DCI format 0_1, the DCI format 0_2, the DCI format 1_1, and the DCI format 1_2. The first higher layer parameter may indicate an association between an aperiodic SRS (aperiodic SRS triggerting state) and an SRS resource set. The first higher layer parameter, a triggered SRS resource, srs-ResourceSetId, and csi-RS may be configured in the higher layer parameter SRS-ResourceSet. The higher layer parameter csi-RS may indicate NZP-CSI-RS-ResourceId. The higher layer parameter SRS-ResourceSet associated with the SRS request may be defined by an entry in a list that is a higher layer parameter. The list that is a higher layer parameter may be the higher layer parameter srs-ResourceSetToAddModList or srs-ResourceSetToAddModListDCI-0-2. The terminal apparatus 1 may not expect to update the precoding information (SRS precoding information). For example, in a case that the gap between the last OFDM symbol in reception of the aperiodic NZP-CSI-RS resource and an initial OFDM symbol in transmission of the aperiodic SRS is equal to or less than the 42 OFDM symbols, the terminal apparatus 1 may not expect to update the precoding information.

In a case that the aperiodic SRS associated with the aperiodic NZP CSI-RS resource is configured, the presence of the CSI-RS may be indicated by the SRS request field. In a case that the value of the SRS request field is not ‘00’ and the scheduling DCI is not used for cross carrier scheduling or cross BWP scheduling (cross bandwidth part scheduling), the presence of the CSI-RS may be indicated by the SRS request field.

The terminal apparatus 1 may perform one-to-one mapping. One to-one mapping may be mapping from an SRI to a PUSCH layer corresponding to a DMRS port. The 0th to a (v−1)-th PUSCH layers may be provided. v may be the number of layers. The number of layers may be configured by the higher layer parameter. The number of layers may be indicated by the DCI The terminal apparatus 1 may transmit the PUSCH by using the same antenna port as the SRS port. For example, the SRS port in the SRS resource indicated by the SRI may be indexed as pi=1000+i. For example, the SRS port in the (i+1)-th SRS resource may be pi. In addition, the SRS port in the (i+1)-th SRS resource may also be indexed as pi. pi may be 1000+i. In other words, pi=1000+i may be satisfied.

In non-codebook-based transmission, the terminal apparatus 1 may not expect both spatial relation information (info) for the SRS resource and the higher layer parameter associatedCSI-RS in the higher layer parameter SRS-ResourceSet for the SRS resource set to be configured. The spatial relation information may be determined by a higher layer parameter. The spatial relation information may be a higher layer parameter spatialRelationInfo. In the non-codebook-based transmission, in a case that at least one SRS resource is configured in the SRS resource set with the higher layer parameter set to ‘nonCodebook’, the terminal apparatus 1 may be scheduled by the DCI format 0_1 or the DCI format 0_2. The spatial relation information may be determined according to the TCI state. The spatial relation information may be determined according to the “indicated TCI state”.

One or multiple Sounding Reference Signal resource sets (SRS resource sets) may be configured by the first higher layer parameter. The first higher layer parameter may be SRS-ResourceSet or SRS-PosResourceSet. In each SRS resource set, K SRS resources may be configured. K may be an integer of 1 or more. The maximum value of K may be indicated by the UE capability. The maximum value of K may be 16. The adaptability of the SRS resource set may be configured in a second higher layer parameter. The second higher layer parameter may be usage. For example, in a case that the second higher layer parameter is set to ‘beamManagement’, one SRS resource may be transmitted in each of the one or multiple SRS resource sets. For example, an SRS resource may be transmitted at a given time instance. Multiple SRS resources in different SRS resource sets may be transmitted simultaneously. For example, in different SRS resource sets of the same BWP, multiple SRS resources with the same time domain behaviour may be transmitted simultaneously.

For the aperiodic SRS, at least one DCI field may be used to select at least one from the configured SRS resource sets.

In a case that two SRS resource sets (a first SRS resource set and a second SRS resource set) are configured and that the number K of repetitions in a PUSCH repetition type A is more than 1, the same OFDM symbol allocation may be applied across continuous K slots and the PUSCH may be limited to one transmission layer. The terminal apparatus 1 may repeat a transport block across K continuous slots. In a case that the codepoint “00” of the SRS resource set indicator field is indicated, the first SRS resource set may be associated with K continuous slots. In a case that the codepoint “01” of the SRS resource set indicator field is indicated, the second SRS resource set may be associated with K continuous slots. In a case that the codepoint “10” of the SRS resource set indicator field is indicated, the first and second SRS resource sets may be associated with K continuous slots. For example, in a case of K=2, the first SRS resource set may be applied to a first slot and the second SRS resource set may be applied to a second slot. In a case of K>2 and that cyclic mapping (cyclicMapping) is enabled, the first and second SRS resource sets may be applied to the first and second slots of K continuous slots, respectively, and the same SRS resource set mapping pattern may continue in the remaining slots of K continuous slots. In a case of K>2 and that sequential mapping (sequentialMapping) is enabled, the first SRS resource set may be applied to the first and second slots of K continuous slots, and the second SRS resource set may be applied to third and fourth slots of K continuous slots, and the same SRS resource set mapping pattern may continue in the remaining slots of K continuous slots. In a case that the codepoint “11” of the SRS resource set indicator field is indicated, the first and second SRS resource sets may be associated with continuous K slots. For example, in a case of K=2, the second SRS resource set may be applied to the first slot and the first SRS resource set may be applied to the second slot. In the case of K>2 and that cyclic mapping (cyclicMapping) is enabled, the second and first SRS resource sets may be applied to the first and second slots of K continuous slots, respectively, and the same SRS resource set mapping pattern may continue in the remaining slots of K continuous slots. In the case of K>2 and that sequential mapping (sequentialMapping) is enabled, the second SRS resource set may be applied to the first and second slots of K continuous slots, and the first SRS resource set may be applied to the third and fourth slots of K continuous slots, and the same SRS resource set mapping pattern may continue in the remaining slots of K continuous slots. The SRS resource set indicator field may be included in one or both of the DCI format 0_1 and the DCI format 0_2. usage in SRS-ResourceSet may be set to ‘codebook’ or ‘noncodebook’ to configure two SRS resource sets.

The SRS resource set indicator field may determine one or two TCI states. For example, in a case that the SRS resource set indicator field indicates “00” or “01”, one TCI state may be used. For example, in a case that the SRS resource set indicator field indicates “10” or “11”, two TCI states may be used. One or two TCI states may be one or both of a UL TCI state (UL-TCIState) and a DL/Joint TCI state (DLorJoint-TCIState). One or two TCI states may be one or both of an “indicated UL TCI state (UL-TCIState)” and an “indicated DL/Joint TCI state (DLorJoint-TCIState)”.

The SRS resource set indicator field may determine that one or both of a first TCI state and a second TCI state are used. For example, in a case that the SRS resource set indicator field indicates “00”, the first TCI state may be used. For example, in a case that the SRS resource set indicator field indicates “01”, the second TCI state may be used. For example, in the case that the SRS resource set indicator field indicates “10” or “11”, the first and second TCI states may be used.

STxMP (Simultaneous Transmission with Multi panel) may be applied to the terminal apparatus 1. STxMP (Simultaneous Transmission with Multi panel) may be applied to one or both of a first uplink physical channel and a second uplink physical channel. In a case that STxMP is applied, the terminal apparatus I may simultaneously transmit the first uplink physical channel and the second uplink physical channel. In the case that STxMP is applied, the terminal apparatus 1 may transmit the first and second uplink physical channels in the same time resource and the same frequency resource. In the case that STxMP is applied, a first code division multiplexing (CDM) group for a first DMRS port indicated for the first uplink physical channel may be different from a second CDM group for a second DMRS port indicated for the second uplink physical channel. The first CDM group need not be expected to be the same as the second CDM group. One or both of the first DMRS port and the second DMRS port may be indicated by an antenna port field in one DCI format. The first and second CDM groups may be indicated by the antenna port field. In the case that STxMP is applied, the first and second uplink physical channels may correspond to one precoding matrix. One precoding matrix may be determined by a TPMI field in the DCI format. In the case that STxMP is applied, the first uplink physical channel may correspond to the first TCI state, and the second uplink physical channel may correspond to the second TCI state. The first and second TCI states may be indicated by a transmission configuration indicator (TCI) field in the DCI format 1_1/1_2. In the case that STxMP is applied, the first uplink physical channel may correspond to a first uplink transmission spatial filter (UL Tx Spatial filter), and the second uplink physical channel may correspond to a second uplink transmission spatial filter. The first uplink transmission spatial filter may be determined by an SRS resource indication (SRI) field in the DCI format. The second uplink transmission spatial filter may be determined by a Second SRI field in the DCI format.

In the case that STxMP is applied, the first number of transmission layers (number of ranks) corresponding to the first uplink physical channel may be the same as or different from the second number of transmission layers (number of ranks) corresponding to the second uplink physical channel. A difference between the first number of transmission layers and the second number of transmission layers need not be expected to be two or more. In the case that STxMP is applied, the first and second uplink physical channels may fully overlap each other. In the case that STxMP is applied, the first and second uplink physical channels need not be expected to partially overlap each other. In the case that STxMP is applied, a first transport block corresponding to the first uplink physical channel need not be expected to be different from a second transport block corresponding to the second uplink physical channel. In the case that STxMP is applied, each of the first and second uplink physical channels need not be expected to convey two transport blocks (codewords). In the case that STxMP is applied, a higher layer parameter sfnSchemePusch or a higher layer parameter sfnSchemePucch need not be expected to be configured for one or both of the first and second uplink physical channels. In a case that the higher layer parameter sfnSchemePusch is configured for a certain PUSCH, a DMRS port for the certain PUSCH may be QCLed with reference signals in multiple (e.g., two) TCI states. In a case that the higher layer parameter sfnSchemePucch is configured for a certain PUCCH, a DMRS port for the certain PUCCH may be QCLed with reference signals in multiple (e.g., two) TCI states.

The application of STxMP may be configured by a higher layer parameter. For example, the application of STxMP for a PUSCH may be configured by a dedicated higher layer parameter for the PUSCH. For example, the application of STxMP for a PUCCH may be configured by a dedicated higher layer parameter for the PUCCH. The application of STxMP may be indicated by the DCI format.

A PUSCH-MTRP scheme may be a general term for the PUSCH repetition in the case that cyclicMapping is enabled, the PUSCH repetition in the case that sequentialMapping is enabled, and STxMP. For example, the fact that the PUSCH-MTRP scheme is applied may be any one of the fact that cylicMapping is enabled, the fact that sequentialMapping is enabled, and the fact that STxMP is applied.

Multiple Transmission Reception Points (Transmit/Receive Points or TRPs) may be used. The base station apparatus 3 may include multiple TRPs (Multi-TRP). The terminal apparatus 1 may be scheduled by two TRPs in one serving cell. In Multi-TRP, the operation mode of one of single-DCI and multi-DCI may be used. In Multi-TRP, uplink control may be completed in the MAC layer and the physical layer. In Multi-TRP, downlink control may be completed in the MAC layer and the physical layer. In the Single-DCI mode, the terminal apparatus 1 may be scheduled by the same DCI for two TRPs. In a Multi-DCI mode, the terminal apparatus 1 may be scheduled by independent DCI from each TRP. In the Multi-DCI mode, each TRP in the Multi-TRP may be identified by TRP information. In other words, one TRP in the Multi-TRP may be identified by one piece of TRP information. The TRP information may be used to select one TRP. In addition, an index of a Control Resource Set (CORESET) resource pool may be associated with one CORESET. The terminal apparatus 1 may transmit the PUSCH based on the index of the CORESET resource pool. The terminal apparatus 1 may transmit the PDCCH and the PDSCH based on the index of the CORESET resource pool. The TRP information may be a CORESET pool index. The TRP information may be given by a TRP indicator field.

The terminal apparatus 1 may form a beam (beamforming). For example, the terminal apparatus 1 may transmit a radio wave (electromagnetic waves) in a specific spatial direction by beamforming. For example, the terminal apparatus 1 may receive a radio wave from a specific spatial direction by beamforming. The terminal apparatus 1 may include and use one or multiple antennas for one or both of transmission and reception of a radio wave. A directional radio wave may be referred to as a beam. Information related to a beam may be referred to as beam information. For example, the beam information may be a specific spatial direction. For example, the beam information may be an arrival direction of a radio wave. The beam information may be a TCI state. The beam information may be an uplink transmission spatial filter. The beam information may be an SRS resource indicator. The beam information may be a QCL assumption or a QCL relationship.

The terminal apparatus 1 may be configured with a higher layer parameter TCI-State. For example, the terminal apparatus 1 may be configured with one list in the higher layer parameter PDSCH-Config. One list may include up to M higher layer parameters TCI-State. One list may be a list of up to M higher layer parameters TCI-State. The terminal apparatus 1 may be configured with one list in order to decode (receive) the PDSCH according to the PDCCH with the DCI. M may depend on the terminal capability (UE capability). For example, M may depend on the terminal capability maxNumberConfiguredTCIStatePerCC. TCI-State may be referred to as a TCI state.

Each TCI-State (i.e., higher layer parameter TCI-State) may include a parameter for configuring a QCL (quasi co-location (QCL relationship)). The QCL relationship may be a relationship between one or two downlink reference signals (downlink physical signals) and a DMRS (DMRS port) of a PDSCH. The QCL relationship may be a relationship between one or two downlink reference signals (downlink physical signals) and a DMRS (DMRS port) of a PDCCH. The QCL relationship may be a relationship between one or two downlink reference signals (downlink physical signals) and a CSI-RS (CSI-RS port) of one CSI-RS resource. For example, the QCL relationship between a channel/signal A and a channel/signal B may indicate that the channel/signal A is QCLed with the channel/signal B.

The QCL relationship may be configured by one or both of a higher layer parameter qcl-Type1 and a higher layer parameter qcl-Type2. For example, the QCL relationship may be configured by one or both of the higher layer parameter qcl-Type1 for a first downlink reference signal (DL RS) and the higher layer parameter qcl-Type2 for a second downlink reference signal. In a case that the first downlink reference signal and the second downlink reference signal are different from each other, a QCL type of qcl-Type1 need not be the same as a QCL type of qcl-Type2. A QCL type corresponding to each downlink reference signal may be given by a higher layer parameter qcl-Type in a higher layer parameter QCL-Info. The QCL type may be any one of type A, type B, type C, and type D.

The terminal apparatus 1 may be configured with a higher layer parameter DLorJointTCIState. For example, the terminal apparatus 1 may be configured with one list in the higher layer parameter PDSCH-Config. One list may include up to 128 higher layer parameters DLorJointTCIState (TCIState). One list may be a list of up to 128 higher layer parameters DLorJointTCIState (TCIState). One list may be configured to provide one reference signal. The higher layer parameter DLorJointTCIState (TCIState) may be configured to provide one reference signal. One reference signal may be a reference signal for the QCL for the DMRS of the PDSCH and the DMRS of the PDCCH. One reference signal may be a reference signal for the CSI-RS. One list may be configured to provide one reference. The higher layer parameter DLorJointTCIState may be configured to provide one reference. One reference may be used to determine an uplink transmission spatial filter (UL TX spatial filter). The uplink transmission spatial filter may be used for a PUSCH, a PUCCH, and an SRS. In other words, one reference may be provided to determine uplink transmission spatial filters for a PUSCH, a PUCCH, and an SRS. The TCI state may be DLorJointTCIState (TCIState). DLorJointTCIState may be referred to as a DL/Joint TCI state or a unified TCI state. One list may be dl-OrJoint-TCIStateList.

The terminal apparatus I may be configured with the higher layer parameter UL-TCIState. For example, the terminal apparatus 1 may be configured with one list in a higher layer parameter BWP-UplinkDedicated. One list may include up to 64 higher layer parameters UL-TCIState. One list may be a list of up to 64 higher layer parameters UL-TCIState. Each UL-TCIState (or UL-TCIState configuration) may include a parameter for configuring one reference signal. For example, each UL-TCIState may include one parameter for configuring one reference signal for determining the uplink transmission spatial filter for some or all of a PUSCH, a PUCCH, and an SRS. One list may be a higher layer parameters ul-TCI-StateList. The TCI state may be UL-TCIState. UL-TCIState may be referred to as a UL TCI state or a unified TCI state.

UL-TCIState may be a higher layer parameter TCI-UL-State. UL-TCIState may be configured by the higher layer parameter TCI-UL-State. The higher layer parameter TCI-UL-State may associate one or two downlink reference signals with a corresponding QCL type.

In a case that DLorJointTCIState or the UL-TCIState is configured, the terminal apparatus 1 may transmit the PUSCH according to a spatial relation. For example, the spatial relationship may be a relationship with reference to one reference signal (RS). For example, one reference signal may be a reference signal for determining the uplink transmission spatial filter. One reference signal may be a reference signal configured with qcl-Type set to typeD in the “indicated TCI state”. The “indicated TCI state” may be indicated DLorJointTCIState or indicated UL-TCIState. A reference RS in indicated DLorJointTCIState may be a CSI-RS resource in a higher layer parameter NZP-CSI-RS-ResourceSet. A reference RS in the indicated UL-TCIState may be a CSI-RS resource in NZP-CSI-RS-ResourceSet. Indicated UL-TCIState (Indicated UL-TCIState) may be a TCI state, a UL TCI state, or a unified TCI state indicated by the DCI format 1_1 or the DCI format 1_2. Indicated DLorJointTCIState (Indicated DLorJointTCIState) may be a TCI state, a DL/Joint TCI state, or a unified TCI state indicated by the DCI format 1_1 or the DCI format 1_2.

DLorJointTCIState (e.g., higher layer parameter DLorJointTCIState) and UL-TCIState (e.g., higher layer parameter UL-TCIState) may be configured in one BWP of one component carrier. In a case that the configuration of DLorJointTCIState or the configuration of UL-TCIState is not performed in one BWP, the terminal apparatus 1 may apply the configuration of DLorJointTCIState or the configuration of UL-TCIState from the reference BWP.

The terminal apparatus 1 need not expect that both of a first higher layer parameter and a second higher layer parameter are configured. The first higher layer parameter may be any one of TCI-State, SpatialRelationInfo, and PUCCH-SpatialRelationInfo. The second higher layer parameter may be any one of DLorJointTCIState and UL-TCIState. In a case that TCI-State is configured in any component carrier in a certain list, the second higher layer parameter need not be configured in any component carrier in the same band in the certain list. The certain list may be configured by a higher layer parameter simultaneousTCI-UpdateList1, a higher layer parameter simultaaneousTCI-UpdateList2, a higher layer parameter simultaneousSpatial-UpdatedList1, or a higher layer parameter simultaneousSpatial-UpdatedList2.

The terminal apparatus 1 may receive an activation command. The activation command may be used for up to eight “one or both of TCI states and pairs of TCI states” to be mapped to codepoints of the DCI field ‘Transmission Configuration Indication’. A pair of TCI states may involve one TCI state for multiple downlink channels/signals (DL TCI state) and one TCI state for multiple uplink channels/signals (UL TCI state). The multiple downlink channels/signals may be part or all of the PDSCH, the PDCCH, and the CSI-RS. The multiple uplink channels/signals may be part or all of a PUSCH, a PUCCH, and an SRS. The DCI (DCI format) may include one or multiple DCI fields. For example, the DCI (DCI format) may include the TCI field (‘Transmission Configuration Indication’field).

In a case that a first set of one or multiple TCI state IDs is activated in a second set, the first set may be applied for a downlink BWP in an indicated component carrier. In a case that the first set of one or multiple TCI state IDs is activated in a third set, the first set may be applied for the downlink BWP and an uplink BWP in the indicated component carrier. The second set may be a set of one or both of one or multiple component carriers and one or multiple downlink BWPs. The third set may be a set of some or all of one or multiple component carriers, one or multiple downlink BWPs, and one or multiple uplink BWPs.

In a case that the activation command maps one or both of DLorJointTCIState and UL-TCIState to one TCI codepoint (codepoint of the DCI field ‘Transmission Configuration Indication’), the terminal apparatus 1 may apply one or both of indicated DLorJointTCIState (Indicated DLorJointTCIState) and indicated UL-TCIState (Indicated UL-TCIState).

The terminal apparatus I may receive the DCI format 1_1/1_ 2 that provides indicated DLorJointTCIState or indicated UL-TCIState. The DCI format need not involve a downlink assignment. For example, in a case that the DCI format 1_1/1_2 does not involve the downlink assignment, the terminal apparatus 1 may assume some or all of the following: the CS-RNTI is used to scramble the CRC for the DCI, all redundancy versions (RVs) are 1, all MCSs are 1, the NDI is 0, all 0 is set for the FDRA type 0, and all 1 is set for the FDRA type 1.

The terminal apparatus 1 may receive the DCI format including the TRP indicator field. The TRP indicator field may select one or two TCI states from one or multiple “indicated TCI states”. The TCI state may be referred to as an “applied TCI state”, In a case that one TCI state is selected, one TCI state may be applied to a PDSCH, a PUSCH, a PUCCH, a CSI-RS, or an SRS scheduled according to the DCI format. In a case that two TCI states are selected, two TCI states may be applied to a PDSCH, a PUSCH, a PUCCH, a CSI-RS, or an SRS scheduled according to the DCI format. The “indicated TCI state” may be “indicated DLorJointTCIState” or “indicated UL-TCIState”. The DCI may be referred to as a DCI format.

N_{conf} TCI states may be configured. For example, N_{conf} TCI states may be configured in a radio resource control layer. For example, N_{conf} TCI states may be configured by a higher layer parameter. Each of N_{conf} TCI states may be referred to as a “configured TCI state”. N_{conf} may be an integer from 1 to 128. In a case that the TCI state is a DL TCI state or a Joint TCI state, N_{conf} may be an integer from 1 to 128. In case that the TCI state is a UL TCI state, N_{conf} may be an integer from 1 to 64.

N_{act} TCI states may be activated. For example, the N_{act} TCI states may be some or all of N_{conf} TCI states. For example, N_{act} TCI states may be activated in a medium access control layer. For example, N_{act} TCI states may be activated by the MAC CE. Each of N_{act} TCI states may be referred to as an “activated TCI state”. N_{act} may be an integer from 1 to 32.

N_{ind} TCI states may be indicated. For example, N_{ind} TCI states may be some or all of N_{act} TCI states. For example, N_{ind} TCI states may be indicated in the physical layer. For example, N_{ind} TCI states may be indicated by the DCI. For example, N_{ind} TCI states may be indicated by the TCI field in the DCI Each of N_{ind} TCI states may be referred to as an “indicated TCI state”. The “indicated TCI state” may be applied to the PDSCH, the PDCCH, and the CSI-RS. The “indicated TCI state” may be applied to a PUSCH, a PUCCH and an SRS. The “indicated TCI state” may be applied to a PDSCH, a PDCCH, a CSI-RS, a PUSCH, a PUCCH, and an SRS. N_{ind} may be an integer from 1 to 4.

Nₐₚₚ TCI states may be indicated and applied. For example, Nₐₚₚ TCI states may be some or all of N_{ind} TCI states. For example, Nₐₚₚ TCI states may be indicated in the physical layer. For example, Nₐₚₚ TCI states may be indicated by the DCI. For example, Nₐₚₚ TCI states may be indicated by the TRP indicator field in the DCI Each of Nₐₚₚ TCI states may be referred to as an “applied TCI state” Nₐₚₚ may be 1 or 2.

The terminal apparatus 1 may receive a higher layer configuration. After the “configured TCI state” is configured for the terminal apparatus 1 and before one “indicated TCI state” from the “configured TCI state” is applied to the terminal apparatus 1, the terminal apparatus I may assume that the DMRS of the PDSCH, the DMRS of the PDCCH, and the CSI-RS to which the “indicated TCI state” is applied are QCLed with the SS/PBCH block. For example, after the terminal apparatus 1 receives an initial configuration of multiple DLorJoint-TCIState and before one indicated TCI state from the configured TCI states is applied to the terminal apparatus 1, the terminal apparatus 1 may assume that the DMRS of the PDSCH, the DMRS of the PDCCH, and the CSI-RS to which the indicated TCI state is applied are QCLed with the SS/PBCH block.

The terminal apparatus I may receive a higher layer configuration. After the “configured TCI state” is configured for the terminal apparatus 1 and before one “indicated TCI state” from the “configured TCI state” is applied to the terminal apparatus 1, the terminal apparatus 1 may assume that the first uplink transmission spatial filter for the PUSCH, the PUCCH, and the SRS to which the “indicated TCI state” is applied is the same as the second uplink transmission spatial filter. For example, after the terminal apparatus 1 receives an initial configuration of multiple DLorJoint-TCIState or multiple UL-TCIState and before one indicated TCI state from the configured TCI states is applied to the terminal apparatus 1, the terminal apparatus 1 may assume that the first uplink transmission spatial filter (UL TX spatial filter) for the PUSCH, the PUCCH, and the SRS to which the indicated TCI state is applied is the same as the second uplink transmission spatial filter. The second uplink transmission spatial filter may be an uplink transmission spatial filter for a PUSCH transmission scheduled by a random access response grant in an initial access procedure.

After the terminal apparatus 1 receives a configuration of multiple DLorJoint-TCIState configurations (“configured TCI states”) and before one “indicated TCI state” from the configured TCI states is applied to the terminal apparatus 1, the DMRS of the PDSCH, the DMRS of the PDCCH, and the CSI-RS to which the indicated TCI state is applied may be QCLed with the SS/PBCH block or the CSI-RS resource. For example, the SS/PBCH block or the CSI-RS resource may be identified in a random access procedure initiated by a reconfiguration with sync. For example, the terminal apparatus 1 may receive the configuration of DLorJoint-TCIState as a part of the reconfiguration with sync.

After the terminal apparatus 1 receives a configuration of multiple DLorJoint-TCIState or multiple UL-TCIState (“configured TCI states”) and before one “indicated TCI state” from the configured TCI states is applied to the terminal apparatus 1, the terminal apparatus 1 may assume that the first uplink transmission spatial filter for the PUSCH, the PUCCH, and the SRS to which the indicated TCI state is applied is the same as the second uplink transmission spatial filter. The second uplink transmission spatial filter may be an uplink transmission spatial filter for a PUSCH transmission scheduled by a random access response grant in the random access procedure initiated by the reconfiguration with sync.

DLorJoint-TCIState may be used as an “indicated TCI state”. For example, the terminal apparatus 1 may acquire the QCL assumption (QCL relationship, QCL) from the “configured TCI states for the DMRS of the PDSCH, the DMRS of the PDCCH, and the CSI-RS to which the ”indicated TCI state“ is applied”. The “indicated TCI state” may be applied to the DMRS of the PDSCH, the DMRS of the PDCCH, and the CSI-RS. The “indicated TCI state” may be applied to the DMRS of the PDSCH, the DMRS of the PDCCH, the CSI-RS, the PUSCH, the PUCCH, and the SRS.

UL-TCIState may be used as an “indicated TCI state”. For example, the terminal apparatus 1 may determine the uplink transmission spatial filter from the “configured TCI states” for the PUSCH, the PUCCH, and the SRS to which the “indicated TCI state” is applied.

In a case that the terminal apparatus 1 transmits a first channel and that a first “indicated TCI state” is different from a second “indicated TCI state”, the first “indicated TCI state” may be applied starting from the first slot. The first channel may be a PUCCH with HARQ-ACK information or a PUSCH with the HARQ-ACK information. The HARQ-ACK information may be HARQ-ACK information corresponding to a DCI conveying a TCI state indication without a downlink assignment. The HARQ-ACK information may be HARQ-ACK information corresponding to a PDSCH scheduled by the DCI conveying the TCI state indication. The second indicated TCI state may be indicated prior to (before) the first indicated TCI state. The first slot may be the first slot at least beamAppTime symbols after the last OFDM symbol in the first channel. BeamAppTime may be the number of OFDM symbols. BeamAppTime may be configured by a higher layer parameter. BeamAppTime may be determined according to the terminal capability. The indicated TCI state may be indicated DLorJointTCIState or indicated UL-TCIState.

In a case that the higher layer parameter PDCCH-Config includes two different values of the CORESET pool indices (CORESET Pool Index or coresetPoolIndex), the terminal apparatus 1 may receive an activation command (“activated TCI state”) for the CORESET associated with each CORESET pool index. The activation command may be used to map up to eight TCI states to the codepoints of the DCI field ‘Transmission Configuration Indication’. In a case that a set of TCI state IDs is activated for one CORESET pool index, an “activated TCI state” corresponding to the one CORESET pool index may be associated with one physical cell ID, and an “activated TCI state” corresponding to a CORESET pool index different from the one CORESET pool index may be associated with a physical cell ID different from the one physical cell ID. The activation command may be transmitted as a MAC CE command. One or multiple CORESETs may be configured in one BWP. One CORESET may correspond to a CORESET pool index of ‘0’or ‘1’.

One codepoint of the DCI field ‘Transmission Configuration Indication’ may include up to four TCI states. For example, one of up to four TCI states may be a Joint TCI state. One of the up to four TCI states may be a DL TCI state. One of the up to four TCI states may be a UL TCI state. One codepoint of the DCI field ‘Transmission Configuration Indication’ may include two “pairs of TCI states”. The pair of TCI states may be a pair of a DL TCI state and a UL TCI state. The terminal apparatus 1 may receive an activation command. The activation command may be used to map up to eight combinations of four or less TCI states to the codepoints of the DCI field ‘Transmission Configuration Indication’. The activation command may be used to map up to eight combinations of one or two “pairs of TCI states” to a code map of the DCI field ‘Transmission Configuration Indication’. The terminal apparatus 1 need not expect to receive more than eight TCI states in the activation command. The terminal apparatus I need not expect to receive more than eight “pairs of TCI states” in the activation command.

In a case that the terminal apparatus 1 transmits a first PUCCH in the first slot, the mapping between the TCI state and the codepoints may be applied starting from the second slot. The first PUCCH may involve first HARQ-ACK information. The first PUCCH may be transmitted corresponding to a first PDSCH. The first PDSCH may convey an activation command.

In a case that the first higher layer parameter is configured, and that a first time offset is more than or equal to a first value, and after the terminal apparatus 1 receives the initial configuration of the TCI state (the configured TCI state) and before the activation command (the activated TCI state) is received, the DMRS port of the PDSCH may be QCLed with the SS/PBCH block with respect to the QCL type A. The first higher layer parameter may be configured for a CORESET scheduling a PDSCH. The CORESET may schedule the PDSCH. The first time offset may be an offset between reception of the DL DCI and the PDSCH. The first value may be a timeDurationForQCL.

In the case that the first higher layer parameter is configured, the terminal apparatus 1 may assume that the TCI field is present in the DCI format for the PDCCH transmitted in the CORESET. The first higher layer parameter may be a tci-PresentInDCI set to ‘enabled’. The first higher layer parameter may be tci-PresentInDCI set to ‘enabled’ for the CORESET scheduling the PDSCH or the multicast PDSCH. The first higher layer parameter may be tci-PresentDCI-1-2.

In a case that the first DCI format schedules a PDSCH and that a time offset is equal to or greater than a threshold, the TCI state or QCL assumption for the PDSCH may be the same as the TCI state or QCL assumption applied for the CORESET used for the PDCCH, in order to determine a PDSCH antenna port QCL. The time offset may be a time offset between the reception of the DL DCI and the corresponding PDSCH. The threshold may be timeDurationForQCL. The first DCI format need not include the TCI field.

In a case that the first and second higher layer parameters are configured, and that a time offset is equal to or greater than a threshold, and that DCI scheduling without a TCI state is supported, the TCI state or QCL assumption for the PDSCH may be the same as the TCI state or QCL assumption applied to the CORESET used for the reception of the DL DCI. The TCI states or QCL assumptions being the same may be independent of the number of activated TCI states of the CORESET. In a case that dynamic switching between an SFN PDSCH and a non-SFN PDSCH is not supported, the terminal apparatus 1 may be activated in the CORESET including two TCI states. In the case that dynamic switching between an SFN PDSCH and a non-SFN PDSCH is not supported, two “indicated TCI states” (applied TCI states) may be applied to the PDSCH. For example, in the case that dynamic switching between an SFN PDSCH and a non-SFN PDSCH is not supported, one “indicated TCI state” (applied TCI state) need not be expected to be applied to the PDSCH. The DL DCI may be received in an active BWP of the serving cell. The DL DCI may be DCI for a downlink channel (downlink physical channel). The SFN PDSCH may be a PDSCH to which an SFN is applied. The first higher layer parameter may be sfnSchemePdcch. The second higher layer parameter may be sfnSchemePdsch. The time offset may be a time offset between the reception of the DL DCI and the corresponding PDSCH. The threshold may be timeDurationForQCL. That fact that sfnSchemePdcch is configured may mean that a single frequency network (SFN) is applied to the PDCCH. The fact that an SFN scheme is applied may mean that the same DMRS port is transmitted from different panels at the same time. One beam may correspond to one panel. One TSI state may correspond to one panel.

In a case that the first higher layer parameter and the second higher layer parameter are not configured, and that scheduling is performed by the DCI format 1_1/1_2, and that the time offset is equal to or greater than the threshold, the terminal apparatus 1 may expect that the TCI field is present. The first higher layer parameter may be sfnSchemePdcch. The second higher layer parameter may be sfnSchemePdsch.

In a case that the PDSCH is scheduled by the DCI format 1 _0/1_1/1_2, and that the first higher layer parameter is configured, and that the second higher layer parameter is not configured, and that there is no TCI codepoint (codepoint in the TCI field) with two TCI states in the activation command, and that the time offset is equal to or greater than the threshold, in a case that the CORESET schedules the PDSCH indicated in the two TCI states, the TCI state or QCL assumption for the PDSCH may be a first TCI state or QCL assumption applied to the CORESET used for the PDCCH. The first higher layer parameter may be sfnSchemePdcch set to ‘sfnSchemeA’. The second higher layer parameter may be sfnSchemePdsch.

In a case that the time offset is equal to or less than the threshold and in a case at least one “configured TCI state” includes a QCL type of typeD, some or all of operations 1, 2, 3, 4, and 5 may be performed. The time offset may be a time offset between the reception of the DL DCI and the corresponding PDSCH. The threshold may be timeDurationForQCL.

In the operation 1, the DMRS port of the first PDSCH may be QCLed with a first reference signal with respect to a first QCL parameter. The first QCL parameter may be used for a PDCCH QCL indication of a CORESET. The CORESET may be associated with a search space (search space set) with the smallest CORESET ID (controlResourceSetId) of one or multiple CORESETS in an active BWP. Further, the CORESET may be a CORESET in the latest slot among one or multiple CORESETS in the active BWP.

In the operation 2, in the case that the first higher layer parameter and the second higher layer parameter are configured, a DMRS port of a second PDSCH associated with a first value of the CORESET pool index may be QCLed with a reference signal with respect to a second QCL parameter. The second QCL parameter may be used for a PDCCH QCL indication of a CORESET. The CORESET may be configured with the same CORESET pool index as the PDCCH scheduling the second PDSCH. The CORESET may be associated with the search space with the smallest CORESET ID. The CORESET may be a CORESET in the latest slot. The first higher layer parameter may be enableDefaultTCI-StatePerCoresetPoolIndex. The second higher layer parameter may be PDCCH-Config including two different CORESET pool index (coresetPoolIndex) values.

In the operation 3, in a case that a third higher layer parameter is configured and that at least one TCI codepoint indicates two TCI states, a DMRS port of a PDSCH (or a PDSCH transmission occasion) may be QCLed with a reference signal with respect to the third QCL parameter. The third QCL parameter may be associated with a TCI state corresponding to the smallest codepoint of the multiple TCI codepoints. Each of the multiple TCI codepoints may include two different TCI states. Also, in a case that a fourth higher layer parameter is configured and that the time offset is equal to or less than the threshold, the mapping of the TCI state to the PDSCH transmission occasion may be determined. For example, an “indicated TCI state” with a TCI state corresponding to the smallest codepoint among of the multiple TCI codepoints may be applied to the PDSCH transmission occasion. One TCI codepoint may indicate up to four TCI states. The third higher layer parameter may be enableTwoDefaultTCI-States. The fourth higher layer parameter may be repetition Scheme set to ‘tdm SchemeA’. The fourth higher layer parameter may be repetitionNumber. The fact that repetitionScheme is configured for the PDSCH may mean that a time division multiplexing (TDM) scheme is applied for the PDSCH. The time offset may be a time offset between the reception of the DL DCI and an initial PDSCH transmission occasion.

In the operation 4, in a case that a fifth higher layer parameter is not configured, and that a sixth higher layer parameter is configured, and that there is no TCI codepoint with multiple TCI states in the activation command, and that a CORESET with the smallest ID is indicated in multiple (e.g., two) TCI states, the DMRS port of the PDSCH may be QCLed with a reference signal with respect to a fourth QCL parameter. The fourth QCL parameter may be associated with the first TCI state of multiple (e.g., two) TCI states indicated for a CORESET. The CORESET may be a CORESET in the latest slot. The fifth higher layer parameter may be sfnSchemePdsch. The sixth higher layer parameter may be sfnSchemePdcch set to ‘sfnSchemeA’.

In the operation 5, in a case that the “configured TCI state” for the serving cell of the scheduled PDSCH is not configured with the QCL type of typeD, the terminal apparatus 1 may acquire a QCL assumption from the “indicated TCI state”.

In a case that the PDCCH conveying the scheduling DCI is received in a first component carrier and that the PDSCH scheduled by the scheduling DCI is in a second component carrier, the threshold may be determined based on the subcarrier spacing of the scheduled PDSCH (subcarrier spacing configuration) and an additional time may be added to the threshold. The additional time may be determined based on the subcarrier spacings (configurations of the subcarrier spacings) of the PDCCH and the PDSCH. In a case that the PDCCH conveying the scheduling DCI is received in the first component carrier, and that the PDSCH scheduled by the scheduling DCI is in the second component carrier, and that the first higher layer parameter is configured, and that the time offset is equal to or less than the threshold, the terminal apparatus 1 may acquire a QCL assumption for the scheduled PDSCH from the “activated TCI state” or the “indicated TCI state”. The “activated TCI state” or the “indicated TCI state” may involve the smallest ID and may be applied to a PDSCH in an active BWP of a scheduled serving cell. The scheduling DCI may be DCI for scheduling a downlink physical channel or an uplink physical channel. The first higher layer parameter may be enableDefaultBeamForCCS.

In a case that a first terminal capability is indicated to the terminal apparatus 1, the terminal apparatus 1 may determine a spatial domain filter. The spatial domain filter may be used while an applicable channel access procedure prior to a UL transmission in the channel is performed. In a case that an SRI corresponding to a UL transmission is indicated, the terminal apparatus 1 may use the spatial domain filter the same as the spatial domain filter associated with the indicated SRI The terminal apparatus 1 may use the spatial domain filter the same as the spatial domain filter used to receive the DL reference signal associated with the indicated TCI state. For example, in a case that DLorJointTCIState or the TCI state configuration with UL-TCIState (configured TCI state) is configured, the terminal apparatus 1 may use the spatial domain filter the same as the spatial domain filter used to receive the DL reference signal associated with the indicated TCI state. The first terminal capability may be beamCorrespondenceWithoutUL-Beam Sweeping set to ‘1’.

In order to determine the time offset, a PDCCH candidate (candidate for PDCCH) may be used in a case that the PDCCH reception includes two PDCCHs from two associated search space sets. The time offset may be a time offset between the reception of the DL DCI and the corresponding PDSCH. The PDCCH candidate may be a PDCCH candidate that ends later in time. In a case that the PDCCH reception includes two PDCCH candidates from two associated search space sets, in the configuration of the first higher layer parameter, the terminal apparatus 1 may expect the same configuration in a first CORESET and a second CORESET associated with the two PDCCH candidates. The fact that the PDCCH reception includes two PDCCHs (PDCCH candidates) from two associated search space sets may mean that search space linking is applied. The fact that PDCCH repetition is applied may mean that one PDCCH reception including two PDCCHs (PDCCH candidates) from two associated search space sets is applied.

In a case that a periodic CSI-RS resource in NZP-CSI-RS-ResourceSet is configured with the first higher layer parameter, the TCI state may indicate one of the multiple QCL types. The multiple QCL types may include type the C for an SS/PBCH block. The first higher layer parameter may be trs-Info. The first higher layer parameter may indicate that antenna ports for all Non Zero Power CSI-RS (NZP-CSI-RS) resources in a CSI-RS resource set are the same.

In the periodic CSI-RS and a semi-persistent CSI-RS, the indicated TCI state (e.g., indicated DLorJointTCIState) need not be applied.

In a CSI-RS resource in the NZP-CSI-RS-resource set (NZP-CSI-RS-ResourceSet) without the first higher layer parameter and the second higher layer parameter, the TCI state may indicate one of the multiple QCL types. The multiple QCL types may include the typeA for the CSI-RS in the NZP-CSI-RS resource set with the first higher layer parameter. The multiple QCL types may include typeB for the CSI-RS in the NZP-CSI-RS resource set with the first higher layer parameter. The first higher layer parameter may be trs-Info. The second higher layer parameter may be repetition.

In the CSI-RS resource in the NZP-CSI-RS resource set with the second higher layer parameter, the TCI state may indicate one of the multiple QCL types. The multiple QCL types may include typeB for the CSI-RS in the NZP-CSI-RS resource set with the first higher layer parameter. The multiple QCL types may include typeC for an SS/PBCH block. The second higher layer parameter may be repetition.

The DMRS port of the PDCCH may be QCLed with DL-RSs (downlink reference signals) in multiple (e.g., two) TCI states. For example, in a case that the first higher layer parameter is configured and that the CORESET is activated in multiple (e.g., two) TCI states, the DMRS port of the PDCCH in the CORESET may be QCLed with the DL-RSs in the multiple (e.g., two) TCI states. The first higher layer parameter may be sfnSchemePdcch. The first higher layer parameter may be sfnSchemePdcch set to ‘sfnSchemeA’. The first higher layer parameter may be sfnSchemePdcch set to ‘sfnSchemeB’. The second of two TCI states need not include the QCL parameters {Doppler shift, Doppler spread}. For example, in a case that the first higher layer parameter is configured and that the CORESET is activated in one TCI state, the DMRS port of the PDCCH in the CORESET may be QCLed with the DL-RSs in the multiple (e.g., two) “indicated TCI states”. For example, for example, in the case that the first higher layer parameter is configured, the DMRS port of the PDCCH in the CORESET may be QCLed with the DL-RSs in the multiple (e.g., two) “indicated TCI states” regardless of the number of activated TCI states of the CORESET. The fact that the first higher layer parameter is configured may mean that the SFN scheme is applied for the PDCCH.

The TCI state may indicate one QCL type for the DMRS of the PDSCH. One QCL type may be the typeA for the CSI-RS resources in the NZP-CSI-RS resource set configured with trs-Info. The TCI state may indicate one QCL type for the DMRS of the PDCCH. One QCL type may be the typeA for the CSI-RS resources in the NZP-CSI-RS resource set configured with trs-Info.

In a case that the first higher layer parameter is configured and that multiple (e.g., two) TCI states are indicated, the DMRS port of the PDSCH may be QCLed with the DL-RSs in the multiple (e.g., two) TCI states. The multiple TCI states in one codepoint of the DCI field ‘Transmission Configuration Indication’ in the DCI for scheduling the PDSCH may be indicated. The first higher layer parameter may be sfnSchemePdsch. The first higher layer parameter may be sfnSchemePdsch set to ‘sfnSchemeA’. The first higher layer parameter may be sfnSchemePdsch set to ‘sfnSchemeB’. The second of two TCI states need not include the QCL parameters {Doppler shift, Doppler spread}. In a case that the first higher layer parameter is configured, and that multiple (e.g., two) TCI states are indicated, and that the TRP indicator field indicates a third indication or a fourth indication, the DMRS port of the PDSCH may be QCLed with the DL-RSs in the multiple (e.g., two) TCI states. The fact that the first higher layer parameter is configured may mean that the SFN scheme is applied for the PDSCH.

The terminal apparatus 1 may receive a DMRS for a PDSCH scheduled by a PDCCH with the DCI format. In the case that two TCI states are indicated, and in a case the terminal apparatus 1 receives the DMRS for the PDSCH and the SS/PBCH block in the same OFDM symbol, at least one DMRS port for the PDSCH and the SS/PBCH block may be QCLed with the typeD (‘QCL-TypeD’). In a case that the first higher layer parameter is configured, and that multiple PDSCHs are overlapped by multiple PDCCHs in the time-frequency domain, different DMRS configurations need not be expected, and two TCI states need not indicate DMRS ports in one CDM group. The first higher layer parameter may be PDCCH-Config including two different CORESET pool indices.

In the downlink, up to 16 or 32 HARQ processes may be supported in one serving cell. The number of HARQ processes may be configured by a higher layer parameter. In a case that the higher layer parameter is not configured, the number of HARQ processes may be eight.

The terminal apparatus 1, in response to detecting a PDCCH with a DCI format, may receive (decode) the corresponding PDSCH as indicated by the DCI format.

The higher layer parameter may include values of two different CORESET pool indices. The PDCCHs scheduling two PDSCHs (first PDSCH and second PDSCH) may be associated with the CORESETs having the different values of the CORESET pool indices. The higher layer parameter may be PDCCH-Config. The terminal apparatus 1 may receive the first PDSCH and the second PDSCH.

The terminal apparatus 1 may assume that the DMRS port of the first PDSCH is QCLed with a first SS/PBCH block with respect to the first QCL parameter, The first PDSCH may be scheduled with the SI-RNTI, the P-RNTI, or a G-RNTI for broadcast. The terminal apparatus 1 may assume that the DMRS port of the second PDSCH is QCLed with a second SS/PBCH block or a second CSI-RS resource with respect to the first QCL parameter. The second SS/PBCH block or the second CSI-RS resource may be used for RACH association. The second PDSCH may be scheduled with the RA-RNTI, or an MSGB-RNTI The terminal apparatus I may assume that a DMRS port of the first PDCCH order, a DMRS port of a third PDSCH are QCLed with the second SS/PBCH block or the second CSI-RS resource with respect to the first QCL parameter. The third PDSCH may be scheduled with the RA-RNTI for a random access procedure triggered by the first PDCCH order. The first QCL parameter may include some or all of Doppler shift, Doppler spread, average delay, delay spread, and spatial RX parameters.

In a case that the decoding of the PDCCH with the CRC scrambled by the CS-RNTI is configured by the higher layer, the terminal apparatus 1 may receive the PDSCH without the corresponding PDCCH.

In the case that the first higher layer parameter is configured, the terminal apparatus 1 may receive multiple PDCCHs. The first higher layer parameter may be PDCCH-Config. The first higher layer parameter may include values of two different CORESET pool indices. Multiple PDCCHs may schedule multiple PDSCHs. The multiple PDSCHs may or may not overlap in the time-frequency domain. In a case that the multiple PDCCHs are associated with different CORESETs, the terminal apparatus 1 may simultaneously receive the multiple PDSCHs. The different CORESETs may have values of different CORESET pool indices (coresetPool Index).

In a case that the CORESET (the higher layer parameter ControlResourceSet) does not involve the CORESET pool index (the higher layer parameter coresetPoolIndex), the terminal apparatus 1 may assume that the CORESET is assigned with the CORESET pool index of 0.

A first physical cell ID associated with the first CORESET may be different from a second physical cell ID associated with the second CORESET. For example, the first and second CORESETs may be associated with different physical cell IDs via the activated TCI state. The first and second CORESETs may correspond to different CORESET pool indices.

In the case that repetition is configured for PDSCH, the first higher layer parameter need not be expected to be configured. The first higher layer parameter may be repetitionScheme. The fact that the repetition is configured for the PDSCH may mean that repetitionNumber is configured for the PDSCH. The fact that the first higher layer parameter is configured may mean that a frequency division multiplexing (FDM) scheme, a time division multiplexing (TDM) scheme, or a spatial division multiplexing (SDM) scheme is applied.

In a case that the first higher layer parameter is configured and that multiple (e.g., two) TCI states and one or multiple DMRS ports are indicated, some or all of operations 6, 7, and 8 may be performed. The first higher layer parameter may be repetitionScheme. In repetition Scheme, ‘fdmSchemeA’, ‘fdmSchemeB’ or ‘tdmSchemeA’ may be set. The multiple TCI states may be included in one codepoint of the DCI field ‘Transmission Configuration Indication’. One or multiple DMRS ports may be DMRS ports in one CDM group. One code division multiplexing (CDM) group may be indicated by a DCI field ‘Antenna Port(s)’.

In the operation 6, in a case that ‘fdmSchemeA’ is set in the terminal apparatus 1 and multiple (for example, two) TCI states are indicated by one piece of DCI, the terminal apparatus 1 may receive one PDSCH transmission occasion or transmit one PUSCH transmission occasion of one transport block in each TCI state. The fact that an FDM scheme A is applied may mean that ‘fdmSchemeA’ is set in the terminal apparatus 1. Each TCI state may be associated with non-overlapping frequency domain resource assignment.

In the operation 7, in a case that ‘fdmSchemeB’ is set in the terminal apparatus 1 and multiple (for example, two) TCI states are indicated by one piece of DCI, the terminal apparatus 1 may receive two PDSCH transmission occasions or transmit two PUSCH transmission occasions of the same transport block in each TCI state. The fact that an FDM scheme B is applied may mean that ‘fdmSchemeB’ is set in the terminal apparatus 1. Each TCI state may be associated with a first PDSCH transmission occasion of two PDSCH transmission occasions. The first PDSCH transmission occasion may have non-overlapping frequency domain resource assignment with respect to a second PDSCH transmission occasion of two PDSCH transmission occasions. Each TCI state may be associated with a first PUSCH transmission occasion of two PUSCH transmission occasions. The first PUSCH transmission occasion may have non-overlapping frequency domain resource assignment with respect to a second PUSCH transmission occasion of two PUSCH transmission occasions.

In the operation 8, in a case that ‘tdnSchemeA’ is set in the terminal apparatus 1 and multiple (for example, two) TCI states are indicated by one piece of DCI, the terminal apparatus 1 may receive two PDSCH transmission occasions of the same transport block in each TCI state. Each TCI state may be associated with a first PDSCH transmission occasion of two PDSCH transmission occasions. The first PDSCH transmission occasion may have non-overlapping time domain resource assignment with respect to a second PDSCH transmission occasion of two PDSCH transmission occasions. Two PDSCH transmission occasions may be received in one slot. The fact that a TDM scheme A is applied may mean that ‘tdm SchemeA’ is set in the terminal apparatus 1. The fact that the TDM scheme A is applied may mean that the higher layer parameter repetition Scheme set to ‘tdmSchemeA’is configured for the terminal apparatus 1.

The frequency division multiplexing (FDM) scheme (fdmScheme) may be applied to one or both of the PDSCH and the PUSCH. The FDM scheme A (fdmSchemeA) may be applied to one or both of the PDSCH and the PUSCH. The FDM scheme B (fdmSchemeB) may be applied to one or both of the PDSCH and the PUSCH. The time division multiplexing (TDM) scheme (tdmScheme) may be applied to one or both of the PDSCH and the PUSCH. The TDM scheme A (tdmSchemeA) may be applied to one or both of the PDSCH and the PUSCH. The TDM scheme B (tdmSchemeB) may be applied to one or both of the PDSCH and the PUSCH. fdmScheme may be a general term for fdmSchemeA and fdmSchemeB, tdmScheme may be a general term for tdmSchemeA and tdmSchemeB. The spatial division multiplexing (SDM) scheme (sdmScheme) may be applied to one or both of the PDSCH and the PUSCH.

In a case that the FDM scheme is applied, and that multiple (e.g., two) TCI states are indicated, and that DMRS ports in one CDM group are indicated, first multiple physical resource blocks may be assigned to the first TCI state and second multiple physical resource blocks may be assigned to the second TCI state. A sum of the first multiple physical resource blocks and the second multiple physical resource blocks may be the total number of physical resource blocks assigned for the terminal apparatus 1. In a case that the FDM scheme is applied, and that multiple (e.g., two) TCI states are indicated, and that DMRS ports in one CDM group are indicated, an even number of physical resource block groups may be assigned to the first TCI state and an odd number of physical resource block groups may be assigned to the second TCI state. Both the even number of physical resource block groups and the odd number of physical resource block groups may be in the assigned frequency domain resource. In a case that the FDM scheme is applied, and that multiple (e.g., two) TCI states are indicated, and that DMRS ports in one CDM group are indicated, the terminal apparatus 1 need not expect three or more PDSCH transmission layers for each PDSCH transmission occasion. The fact that the FDM scheme is applied may mean that the higher layer parameter repetition Scheme set to ‘fdmSchemeA’ or ‘fdmSchemeB’is configured for the terminal apparatus 1.

In a case that the FDM scheme B is applied, and that two TCI states are indicated, and that DMRS ports in one CDM group are indicated, each PDSCH transmission occasion may be mapped to a resource element. The resource element may be determined by a physical resource block assigned for the TCI state of the PDSCH transmission occasion. In a case that the FDM scheme B is applied, and that two TCI states are indicated, and that DMRS ports in one CDM group are indicated, and that a transmission layer 1 is scheduled, the terminal apparatus 1 may expect up to two code blocks for each PDSCH transmission occasion. In a case that the FDM scheme B is applied, and that two TCI states are indicated, and that DMRS ports in one CDM group are indicated, and that a transmission layer 2 is scheduled, the terminal apparatus I may expect one code block for each PDSCH transmission occasion. In two PDSCH transmission occasions, a first Redundancy version may be applied to the first TCI state, and a second Redundancy version may be applied to the second TCI state. The fact that the FDM scheme B is applied may mean that the higher layer parameter repetition Scheme set to ‘fdmSchemeB’ is configured for the terminal apparatus 1.

In a case that FDM scheme B is applied, and that two TCI states are indicated, and that DMRS ports in one CDM group are indicated, a modulation order of the first PDSCH transmission occasion may be applied to the second PDSCH transmission occasion. The first PDSCH transmission occasion may be associated with the first TCI state. The second PDSCH transmission occasion may be associated with the second TCI state.

In a case that the FDM scheme B is applied, and that two TCI states are indicated, and that DMRS ports in one CDM group are indicated, the terminal apparatus 1 may determine the total number of resource elements for the PDSCH. The total number of assigned physical resource blocks may correspond to the first TCI state. The TBS of the first PDSCH transmission occasion associated with the first TCI state may be applied to the second PDSCH transmission occasion associated with the second TCI state.

In a case that the TDM scheme A is applied, and that two TCI states are indicated, and that DMRS ports in one CDM group are indicated, the terminal apparatus 1 may determine, for PDSCH, the total number of resource elements in one physical resource block. The number of OFDM symbols for PDSCH assignment in one slot may correspond to the first TCI state. The TBS of the first PDSCH transmission occasion associated with the first TCI state may be applied to the second PDSCH transmission occasion associated with the second TCI state.

In a case that the TDM scheme A is applied and that DMRS ports in one CDM group are indicated, the number of PDSCH transmission occasions may be the number of TCI states indicated by the DCI field ‘Transmission Configuration Indication’. In the case that two TCI states (first and second TCI states) are indicated, two PDSCH transmission occasions (first and second PDSCH transmission occasions) may be expected to be received. In a case that one TCI state is indicated, the terminal apparatus 1 may be expected to receive one PDSCH transmission occasion. The first TCI state may be applied to the first PDSCH transmission occasion. The second TCI state may be applied to the second PDSCH transmission occasion. The second PDSCH transmission occasion may have the same number of OFDM symbols as the first PDSCH transmission occasion. The number K_bar of OFDM symbols may be the number of OFDM symbols from the last OFDM symbol of the first PDSCH transmission occasion to the initial OFDM symbol of the second PDSCH transmission occasion. K_bar may be determined by a higher layer parameter. The terminal apparatus 1 need not expect to receive three or more PDSCH transmission layers for each PDSCH transmission occasion. The first redundancy version may be applied to the first TCI state. The second redundancy version may be applied to the second TCI state. A PDSCH mapping type indicated by the DCI field ‘Time domain resource assignment’ may be expected to be a mapping type B, and the PDSCH mapping type may be applied to two PDSCH transmission occasions.

The repetition may be applied to one or both of the PDSCH and the PUSCH. The fact that the repetition is applied may mean that the higher layer parameter repetitionNumber is configured in a higher layer parameter PDSCH-TimeDomainResourceAllocation. In a case that the repetition is applied, the terminal apparatus 1 may expect that one or multiple (for example, two) TCI states are indicated. One or multiple TCI states may be included in one codepoint of the DCI field ‘Transmission Configuration Indication’. The DCI field ‘Time domain resource assignment’ may indicate an entry including the higher layer parameter repetitionNumber. The DMRS port indicated to the terminal apparatus 1 may be within one CDM group. In a case that multiple TCI states are indicated, the terminal apparatus 1 may receive the PDSCH transmission occasions of the same TB with the multiple TCI states across multiple slots. In the case that one TCI state is indicated, the terminal apparatus 1 may receive the PDSCH transmission occasions of the same TB with one TCI state across multiple slots. The PDSCH transmission occasion may be multiple slot level PDSCH transmission occasions. The fact that the repetition is applied may mean that the DCI field ‘Time domain resource assignment’ indicates an entry including the higher layer parameter repetitionNumber. repetitionNumber may be included in PDSCH-TimeDomainResourceAllocation in PDSCH-Config.

In a case that the repetition is applied for the PDSCH, the same SLIV may be applied to all PDSCH transmission occasions across multiple continuous slots. The number of continuous slots may be determined according to repetitionNumber. The SLIV may determine a starting OFDM symbol and the number of OFDM symbols.

In a case that the repetition is applied for the PDSCH, and that two TCI states are indicated by the DCI field ‘Transmission Configuration Indication’, and that DMRS ports in one CDM group are indicated, the same SLIV may be applied to all PDSCH transmission occasions across multiple continuous slots, and the first TCI state may be applied to the first PDSCH transmission occasion. In a case that the number of repetitions is two, the second TCI state may be applied to the second PDSCH transmission occasion. In a case that the number of repetitions is equal to or greater than three and that the cyclic mapping (cyclicMapping) is enabled, the first TCI state may be applied to the first PDSCH transmission occasion, the second TCI state may be applied to the second PDSCH transmission occasion, and the mapping pattern of the same TCI state may continue in the remaining PDSCH transmission occasions. In a case that the number of repetitions is equal to or greater than three and that the sequential mapping (SequenticalMapping) is enabled, the first TCI state may be applied to the first and second PDSCH transmission occasions, the second TCI state may be applied to third and fourth PDSCH transmission occasions, and the mapping pattern of the same TCI state may continue in the remaining PDSCH transmission occasions. The number of continuous slots may be determined according to repetitionNumber. The number of repetitions may be a value of repetitionNumber.

Each PDSCH transmission occasion may be limited to two transmission layers. In a case that all the PDSCH transmission occasions are associated with the first TCI state, the redundancy version (an index for determining the redundancy version) may be counted in consideration of only the PDSCH transmission occasion associated with the first TCI state,

In a case that the repetition is applied for the PDSCH, and in a case one TCI state is indicated by the DCI field ‘Transmission Configuration Indication’, and that DMRS ports in one CDM group are indicated, the same SLIV may be applied to all PDSCH transmission occasions across multiple continuous slots, and the same TCI state may be applied to all PDSCH transmission occasions.

In a case that the repetition is not applied by the first DCI format, and that multiple (e.g., two) TCI states are indicated by the first DCI format, and that DMRS ports in two CDM groups are indicated by the first DCI format, and that the SFN (SFN scheme) is not applied, the SDM scheme may be applied. For example, the fact that the SDM scheme may be applied in a case that conditions 1, 2, 3, and 4 are satisfied. The condition 1 may be that the repetition is not applied by the first DCI format. The condition 2 may be that multiple (for example, two) TCI states are indicated by the first DCI format. The condition 3 may be that DMRS ports in two CDM groups are indicated by the first DCI format. The condition 4 may be that an SFN (SFN scheme) is not applied. In a case that the repetition is not applied by the first DCI format, and that multiple (e.g., two) TCI states are indicated by the first DCI format, and that DMRS ports in two CDM groups are indicated by the first DCI format, and that the SEN (SFN scheme) is not applied, the terminal apparatus 1 may receive one PDSCH based on the SDM scheme. The fact that the repetition is not applied may mean that the DCI field ‘Time domain resource assignment’ in the first DCI format does not indicate an entry including repetitionNumber. The multiple TCI states may be included in one codepoint of the DCI field ‘Transmission Configuration Indication’ in the first DCI format. The DMRS ports in two CDM groups may be indicated by the DCI field ‘Antenna Port(s)’ in the first DCI format. In a case that the SDM scheme is applied, the first TCI state may correspond to the first CDM group of first antenna ports. The second TCI state may correspond to the second CDM group.

The single frequency network (SFN) scheme may be applied to one or both of the PDSCH and the PUSCH. The fact that the first higher layer parameter is configured may mean that the SFN scheme is applied. The first higher layer parameter may be sfnSchemePdsch. The first higher layer parameter may be sfnSchemePdsch set to ‘sfnSchemeA’. The first higher layer parameter may be sfnSchemePdsch set to ‘sfnSchemeB’. The SEN scheme may be a general term for the SFN scheme A and the SFN scheme B.

In a case that the SFN scheme is applied for the PDSCH and that the terminal apparatus 1 reports the first terminal capability, one or multiple (for example, two) TCI states may be indicated to the terminal apparatus 1. The first terminal capability may be dynamicSFN. The first terminal capability may be dynamic switching of the SFN scheme. In a case that the SFN scheme is applied and that the terminal apparatus 1 does not report the first terminal capability, the terminal apparatus 1 need not expect that one TCI state is indicated in the TCI codepoint by the MAC CE, and multiple (for example, two) TCI states may be indicated.

The single frequency network (SFN) scheme may be applied to the PDCCH. The fact that the first higher layer parameter is configured may mean that the SFN scheme is applied. The first higher layer parameter may be sfnSchemePdcch. The first higher layer parameter may be sfnSchemePdcch set to ‘sfnSchemeA’. The first higher layer parameter may be sfnSchemePdcch set to ‘sfnSchemeB’. The SFN scheme may be a general term for the SFN scheme A and the SFN scheme B.

In a case that the SEN scheme is applied for the PDSCH and the PDCCH, sfnSchemePdsch and sfnSchemePdcch may be expected to be set to the same scheme (e.g., ‘sfnSchemeA’ or ‘sfnSchemeB’). The fact that the SEN scheme is applied for the PDSCH may mean that sfnSchemePdsch is configured. The fact that the SFN scheme is applied for the PDCCH may mean that sfnSchemePdcch is configured.

In a case that the SFN scheme B is applied for the PDCCH and that multiple (for example, two) TCI states are activated by the MAC CE, the terminal apparatus 1 may expect that the SFN scheme B is applied for the PDSCH and two TCI states are indicated. The fact that the SFN scheme B is applied for the PDSCH may mean that sfnSchemePdsch set to ‘sfnSchemeB’ is configured. The fact that the SFN scheme B is applied for the PDCCH may mean that sfnSchemePdcch set to ‘sfnSchemeB’ is configured. The PDSCH may be scheduled by the DCI format 1_1/1_2.

In a case that the PDCCH reception includes two PDCCH candidates from the search space set, one PDCCH monitoring occasion may be a union of the PDCCH monitoring occasions for the two PDCCH candidates. The start of the PDCCH reception may be the start of a previous PDCCH candidate. The end of the PDCCH reception may be the end of a subsequent PDCCH candidate.

In a case that no CORESET pool index is provided in one BWP in one serving cell, three or less CORESETS may be provided. In a case that the same CORESET pool index is provided for all CORESETs in one BWP in one serving cell, three or less CORESETs may be provided. In a case that a CORESET pool index 0 is provided for the first CORESET in one BWP in one serving cell and that a CORESET pool index 1 is provided for the second CORESET, five or less CORESETs may be provided.

In each CORESET, there may be provided at least a CORESET index by the first higher layer parameter, a QCL relationship (antenna port QCL) by the second higher layer parameter, and an indication of whether a TCI field is present by the third higher layer parameter. The first higher layer parameter may be controlResourceSetId. The second higher layer parameter may be TCI-State. The third higher layer parameter may be tei-PresentInDCI or tci-PresentDCI-1-2.

In a case that a value of 0 is provided for a search space ID, the terminal apparatus 1 may determine a search occasion for the PDCCH candidate. The search space ID may be searchSpaceID. The search space ID may be included in PDCCH-Config or PDCCH-ConfigCommon.

In a case that two TCI states are provided in one CORESET, the terminal apparatus 1 may assume QCL information indicated by both of the two TCI states for the PDCCH reception in one CORESET. The two TCI states may indicate the QCL information (QCL relationship) of the DMRS antenna port for the PDCCH reception.

In a case that a configuration of the TCI state is not provided in one CORESET, and that initial configurations of two or more TCI states are provided, and that a MAC CE activation command is not received, the terminal apparatus 1 may assume that the DMRS antenna port related to the PDCCH reception is the QCLed with the SS/PBCH block. The SS/PBCH block may be identified by the terminal apparatus 1 at the time of an initial access procedure.

In a case that the configurations of two or more TCI states are provided by reconfiguration with synchronization (Reconfiguration with synch) in one CORESET, and that the MAC CE activation command is not received, the terminal apparatus 1 may assume that the DMRS antenna port related to the PDCCH reception is QCLed with the SS/PBCH block or the CSI-RS resource. The SS/PBCH block or the CSI-RS resource may be identified by the terminal apparatus 1 in the random access procedure initiated by the reconfiguration with sync.

In a case that the TCI state (for example, unified TCI state) is provided in the CORESET with the index of 0 and the unified TCI state is applied, the terminal apparatus 1 may assume that the DMRS antenna port (DMRS port) for a first PDCCH reception and the DMRS antenna port for a first PDSCH reception are QCLed with the reference signal indicated in the TCI state. The fact that the unified TCI state is applied may mean that followUnifiedTCIstate set to ‘enable’ is configured. The first PDSCH reception may be scheduled by the DCI format provided by the first PDCCH reception. The unified TCI state may be DLorJoint-TCIState.

In a case that the TCI state (for example, unified TCI state) is provided in the CORESET with the index of 0 and the unified TCI state is not applied, the terminal apparatus 1 and the DMRS antenna port (DMRS port) for the first PDCCH reception are QCLed with one or multiple reference signals according to the activated TCI state.

In a case that one TCI state is provided in a CORESET with an index of other than 0, or in a case that the MAC CE activation command is received for one or two provided TCI states, the terminal apparatus 1 may assume that the DMRS antenna port for the PDCCH reception is QCLed with one or multiple DL RSs configured by the TCI state. The TCI state indicated by the MAC CE activation command may be the “activated TCI state”.

In a case that the unified TCI state is provided, the DMRS antenna port for the PDCCH reception in one CORESET with the index of other than 0 and the DMRS antenna port for the PDSCH scheduled by the DCI format provided by the PDCCH reception may be QCLed with a reference signal provided by the indicated unified TCI state (“indicated TCI state”).

In a case that multiple (e.g., two) unified TCI states are provided (or indicated), the DMRS antenna port for the PDCCH reception in one CORESET with the index of other than 0 and the DMRS antenna port for the PDSCH scheduled by the DCI format provided by the PDCCH reception may be QCLed with a reference signal provided by one or both of the indicated unified TCI states (“indicated TCI states”).

In a case that the unified TCI state is applied, the DMRS antenna port for the PDCCH reception in one CORESET with the index of other than 0 and the DMRS antenna port for the PDSCH scheduled by the DCI format provided by the PDCCH reception may be QCLed with a reference signal provided by the indicated unified TCI state (“indicated TCI state”).

Ten or less search space sets may be provided in one BWP in one serving cell. For each search space set, at least a search space set index by the first higher layer parameter, the relationship between the search space set and the CORESET by the second higher layer parameter, and the search space set (search space set index) linked by the third higher layer parameter may be determined. The first higher layer parameter may be searchSpaceId. The second higher layer parameter may be controlResourceSetId. In a first search space set, a second search space set index may be provided by the third higher layer parameter. The third higher layer parameter may link the first search space set to the second search space set. The third higher layer parameter may be searchSpaceLinking. The fact that the third higher layer parameter is provided may mean that the search space linking is applied.

In a case that the first search space set is linked to the second search space set, the terminal apparatus 1 may perform monitoring in accordance with each search space set in the monitoring occasion in one slot. The count of PDCCH candidate corresponding to the first search space set and the second search space set may be 3. A CORESET pool index of the first CORESET associated with the first search space set may be different from a CORESET pool index of the second CORESET associated with the second search space set. The fact that the first search space set is linked to the second search space set may mean that the first search space set includes searchSpaceLinking with the second search space set and the second search space set includes searchSpaceLinking with the first search space set.

In a case that the first search space set is linked to the second search space set and that a third search space set is not linked, the terminal apparatus 1 may monitor a first PDCCH candidate corresponding to the first search space set and may monitor a second PDCCH candidate corresponding to the second search space set for the first DCI format. The terminal apparatus 1 may monitor a third PDCCH candidate corresponding to the third search space set for the second DCI format. In one CORESET and in the same symbol in one slot, the first PDCCH candidate corresponding to the first search space set or the second PDCCH candidate corresponding to the second search space set and the third PDCCH candidate corresponding to the third search space set may use the same set of CCEs and may be subjected to the same scrambling. The third PDCCH candidate corresponding to the third search space set need not be counted for monitoring. The detected DCI format need not be assumed to be the first DCI format.

In a case that the first search space set is linked to the second search space set, and that the third search space set is linked to a fourth search space set, and that sizes of the detected DCI formats are the same, the terminal apparatus 1 may expect different CCEs or different scrambling in one CORESET.

In a case that the terminal apparatus monitors multiple PDCCHs in the first CORESET and the second CORESET, the first CORESET may correspond to the CSS set with the smallest index or may correspond to the USS set with the smallest index. The second CORESET may have the same ‘typeD’ property as the first CORESET. The repetition may be applied for the PDCCH. The fact that the repetition is applied for the PDCCH may mean that two-QCLTypeDforPDCCHRepetition is provided.

In the case that the first search space set is linked to the second search space set, the terminal apparatus 1 may detect that one of two PDCCH receptions which ends later is the DCI format.

A MAC protocol data unit (PDU) may be a bit string that is byte aligned (in other words, a multiple of 8 bits) in length. A MAC service data unit (SDU) may be a bit string that is byte aligned (in other words, a multiple of 8 bits) in length. One MAC SDU may be included into one MAC PDU from the first bit onward. The MAC CE may be a bit string that is byte aligned (in other words, a multiple of 8 bits) in length. A MAC subheader may be a bit string that is byte aligned (in other words, a multiple of 8 bits) in length. Each MAC subheader may be placed immediately before the corresponding MAC SDU, MAC CE, or padding.

The MAC protocol data unit (PDU) may include one or multiple MAC subPDUs. Each MAC subPDU may include one MAC subheader. Each MAC subPDU may include one MAC subheader and one MAC service data unit (SDU). Each MAC subPDU may include one MAC subheader and one MAC CE. Each MAC subPDU may include one MAC subheader and padding. The MAC SDU may have a variable size. Each MAC subheader may correspond to one MAC SDU, one MAC CE, or padding. One MAC PDU may be one transport block.

A first MAC CE may be an activation command A. The first MAC CE may be a MAC CE for activation or deactivation of a TCI state for a PDSCH (a UE-specific PDSCH). The MAC CE for the activation/deactivation of the TCI state for the PDSCH may be identified by a first MAC subheader. For example, the first MAC subheader may involve a first Logical channel ID (LCID). For example, a value of the first LCID may be “TCI States Activation/Deactivation for UE-specific PDSCH”.

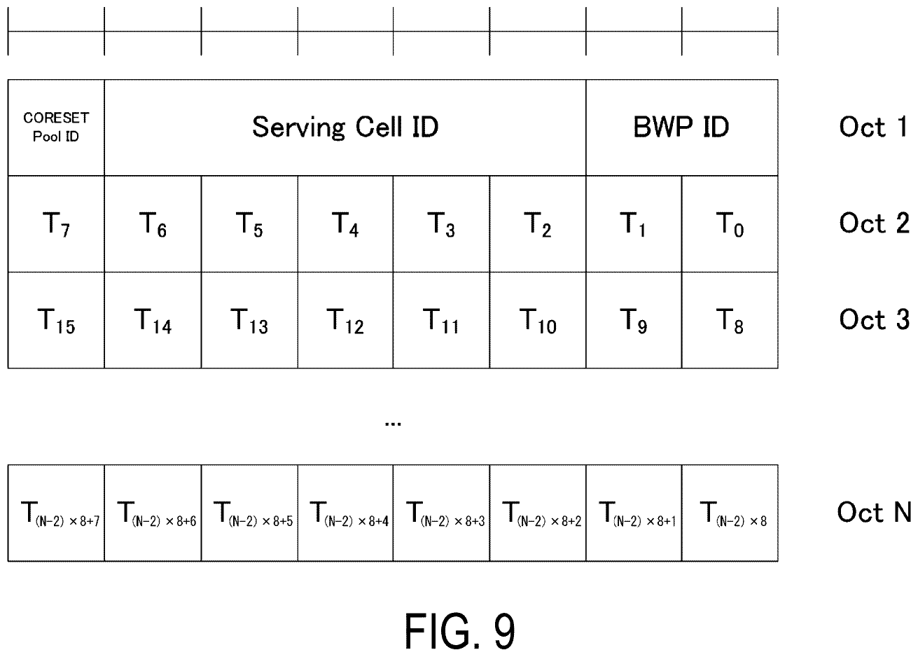

FIG. 9 is a diagram illustrating an example of the activation command A according to an aspect of the present embodiment. A field of a serving cell ID may indicate an identifier of a serving cell to which the first MAC CE is applied. A field of a BWP ID may indicate a DL BWP to which the MAC CE is applied as a codepoint of the ‘bandwidth part indicator field’ of the DCI In a case that the first MAC CE is applied to a set of multiple serving cells, the field of the BWP ID may be disregarded. A field of “Tᵢ” may indicate an activation/deactivation status of a TCI state with a TCI state ID i. The field of “Tᵢ” set to 1 may indicate that the TCI state with the TCI state ID i is activated. The field of “Tᵢ” set to 1 may indicate that the TCI state with the TCI state ID i is mapped to one codepoint of ‘Transmission Configuration Indication field’ of the DCI The field of “Tᵢ” set to 0 may indicate that the TCI state with the TCI state ID i is deactivated. The field of “Tᵢ” set to 1 may indicate that the TCI state with the TCI state ID i is not mapped to one codepoint of ‘Transmission Configuration Indication field’ of the DCI i may be a TCI state ID (or TCI-StateID). The TCI state may involve a TCI state ID. A maximum number of “activated TCI states” may be eight. A field of the CORESET pool ID may indicate that first mapping is specific to a CORESET ID (ControlResourceSetId) configured with a CORESET pool ID (CORESET pool index). The first mapping may be mapping between the “activated TCI state” and the codepoint of the DCI ‘Transmission Configuration Indication’ set by the “Tᵢ” field. The field of the CORESET pool ID set to 1 may indicate that the first MAC CE is applied to a downlink transmission scheduled by the CORESET with the CORESET pool ID (CORESET pool index) having a value of 1. The field of the CORESET pool ID set to 0 may indicate that the first MAC CE is applied to a downlink transmission scheduled by the CORESET with the CORESET pool ID (CORESET pool index) having a value of 0. In a case that the CORESET pool index (coresetPoolIndex) is not configured, the field of the CORESET pool ID in the first MAC CE may be disregarded.

A second MAC CE may be an activation command B. The second MAC CE may be a MAC CE for activation or deactivation of a TCI state for a PDSCH (a UE-specific PDSCH). The MAC CE for the activation/deactivation of the TCI state for the PDSCH may be identified by a second MAC subheader. For example, the second MAC subheader may involve a second Logical channel ID (LCID). The second LCID may be an eLCID. For example, a value of the second LCID may be “Enhanced TCI States Activation/Deactivation for UE-specific PDSCH”.

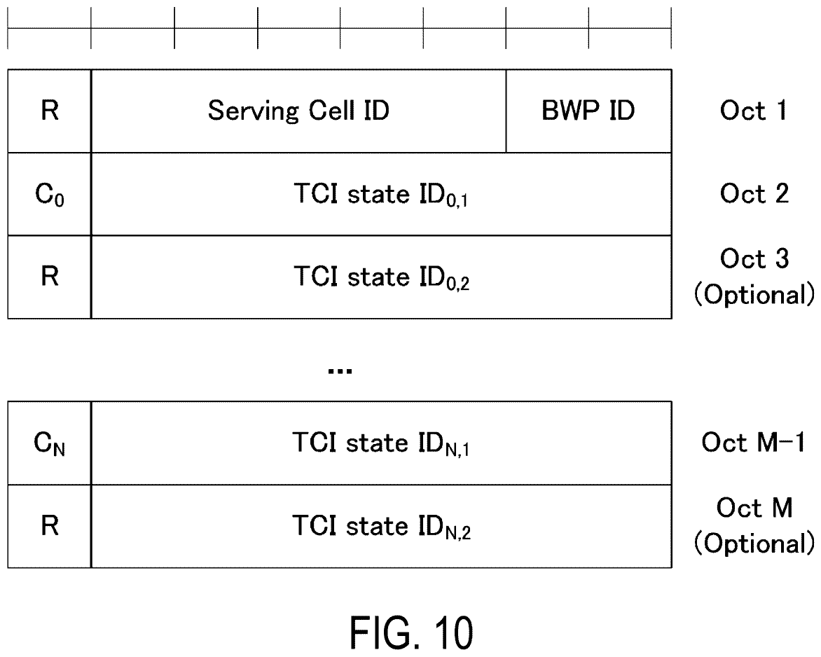

FIG. 10 is a diagram illustrating an example of the activation command B according to an aspect of the present embodiment. A field of “Cᵢ” may indicate whether an octet including the TCI state ID_{i, 2} is present. For example, in a case that the field of “Cᵢ” is set to 1, an octet including the TCI state ID_{i, 2} may be present. For example, in a case that the field of “Cᵢ” is set to 0, no octet including the TCI state ID_{i, 2} need not be present. The field of the TCI state ID_{i, j} may indicate a TCI state identified by the TCI state ID (TCI-StateId). The TCI state ID_{i, j} may represent the j-th TCI state indicated for the i-th codepoint of the DCI ‘Transmission configuration indication’ field. The TCI state ID_{i, 2} may be optional based on the indication of the “Cᵢ” field. i may be an index of a codepoint of the DCI ‘Transmission configuration indication’ field. j may be 1 or 2.

A third MAC CE may be an activation command C. The third MAC CE may be a MAC CE for activation or deactivation of a unified TCI state. The MAC CE for the activation/deactivation of the unified TCI state may be identified by a third MAC subheader. For example, the third MAC subheader may involve a third Logical channel ID (LCID). The third LCID may be an eLCID. For example, a value of the third LCID may be “Unified TCI States Activation/Deactivation MAC CE”.

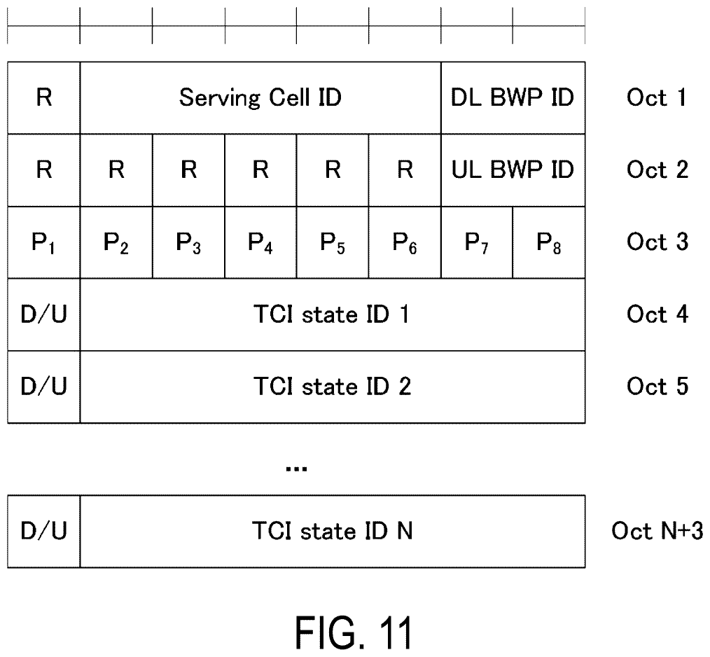

FIG. 11 is a diagram illustrating an example of the activation command C according to an aspect of the present embodiment. A field of a DL BWP ID may indicate one downlink BWP to which the MAC CE is applied as one codepoint of the DCI ‘bandwidth part indicator’ field. A field of a UL BWP ID may indicate one uplink BWP to which the MAC CE is applied as one codepoint of the DCI ‘bandwidth part indicator’ field. A field of “Pᵢ” may indicate whether each TCI codepoint has multiple TCI states or one TCI state. For example, in a case that the “Pᵢ” field is set to 1, the i-th TCI codepoint may include both the DL TCI state and the UL TCI state. For example, in a case that the “Pᵢ” field is set to 0, the i-th TCI codepoint may include one of the DL TCI state and the UL TCI state. A field of “D/U” may indicate whether the TCI state ID in the same octet is for joint (both DL and UL)/DL or UL. For example, in a case that the “D/U” field is set to 1, the TCI state ID in the same octet may be for DL/joint. For example, in a case that the “D/U” field is set to 0, the TCI state ID in the same octet may be for UL. A “TCI state ID” field may indicate a TCI state identified by the TCI state ID (TCI-StateId). In a case that the “D/U” field is set to 1, a 7-bit long “TCI state ID” may be used. In a case that the “D/U” field is set to 0, the most significant bit of the “TCI state ID” may be regarded as reserved and the remaining 6 bits may indicate the ID of the UL-TCIState (UL-TCIState-Id). The DL TCI state may be a TCI state applied to some or all of the PDSCH, the PDCCH, and the CSI-RS. The UL TCI state may be a TCI state applied to some or all of the PUSCH, the PUCCH, and the SRS. The Joint TCI state may be a TCI state representing both the DL TCI state and the UL TCI state, DLorJointTCIState may be a DL TCI state or a Joint TCI state. UL-TCIState may be a UL TCI state. The DL TCI state may be a TCI state for DL. The Joint TCI state may be a TCI state for both DL and UL. The UL TCI state may be a TCI state for UL. The TCI codepoint may be a codepoint of the DCI ‘Transmission configuration indication’ field. An “R” field in the MAC CE may be a reserved bit. The reserved bit may be set to 0.

A fourth MAC CE may be an activation command D. A fifth MAC CE may be an activation command E. The fourth MAC CE may be a MAC CE for activation or deactivation of a unified TCI state. For example, the fourth MAC CE may be a MAC CE for activation or deactivation of an enhanced unified TCI state. The fifth MAC CE may be a MAC CE for activation or deactivation of a unified TCI state. For example, the fifth MAC CE may be a MAC CE for activation or deactivation of an enhanced unified TCI state. The MAC CE for the activation/deactivation of the unified TCI state may be identified by a fourth MAC subheader. The MAC CE for the activation/deactivation of the unified TCI state may be identified by a fifth MAC subheader. For example, the fourth MAC subheader may involve a fourth Logical channel ID (LCID). For example, the fifth MAC subheader may involve a fifth Logical channel ID (LCID). The fourth LCID may be an eLCID. The fifth LCID may be an eLCID. For example, a value of the fourth LCID may be “Enhanced unified TCI States Activation/Deactivation MAC CE 1”. For example, a value of the fifth LCID may be “Enhanced unified TCI States Activation/Deactivation MAC CE 2”.

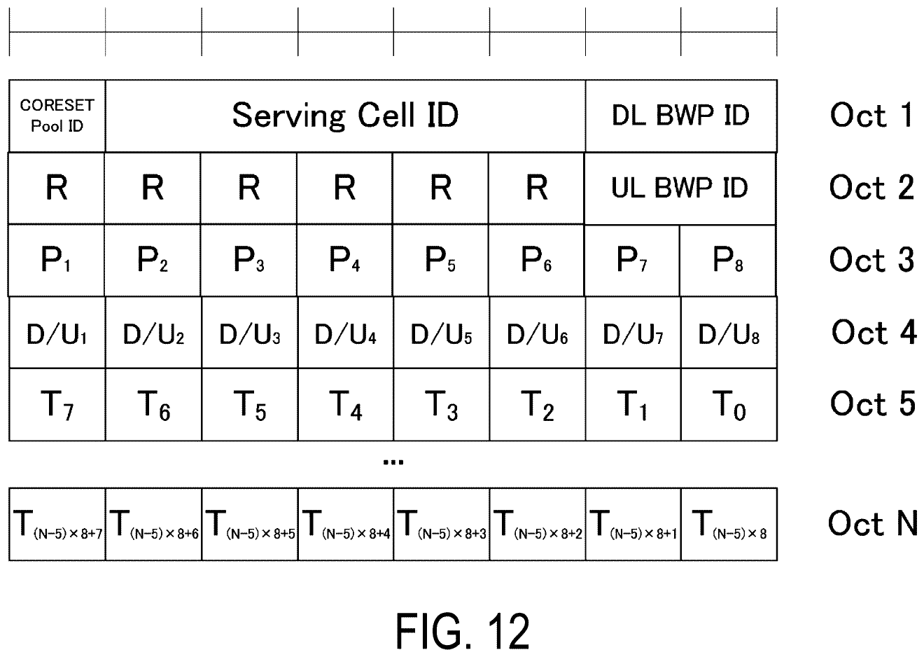

FIG. 12 is a diagram illustrating an example of the activation command D according to an aspect of the present embodiment. A field of a serving cell ID may indicate an identifier of a serving cell to which the fourth MAC CE is applied. A field of a DL BWP ID may indicate one downlink BWP to which the fourth MAC CE is applied. A field of a DL BWP ID may indicate one downlink BWP to which the fourth MAC CE is applied as one codepoint of the DCI ‘bandwidth part indicator’ field. A field of a UL BWP ID may indicate one uplink BWP to which the fourth MAC CE is applied. A field of a UL BWP ID may indicate one uplink BWP to which the fourth MAC CE is applied as one codepoint of the DCI ‘bandwidth part indicator’ field. A field of “Pᵢ” may indicate whether each TCI codepoint has multiple TCI states or one TCI state. For example, in a case that the “Pᵢ” field is set to 1, the i-th TCI codepoint may include both the DL TCI state and the UL TCI state. For example, in a case that the “Pᵢ” field is set to 0, the i-th TCI codepoint may include one of the DL TCI state and the UL TCI state. A field of “D/Uᵢ” may indicate whether each TCI codepoint is for joint (both DL and UL)/DL or UL. For example, in a case that the “D/Uᵢ” field is set to 1, the i-th TCI codepoint may be for DL/joint. For example, in a case that the “D/Uᵢ” field is set to 0, the i-th TCI codepoint may be for UL. A field of “T” may indicate an activation/deactivation status of a TCI state with a TCI state ID j. The field of “Tⱼ” set to 1 may indicate that the TCI state with the TCI state ID j is activated. The field of “Tⱼ” set to 1 may indicate that the TCI state with the TCI state ID j is mapped to one codepoint of ‘Transmission Configuration Indication field’ of the DCI. The field of “Tⱼ” set to 0 may indicate that the TCI state with the TCI state ID j is deactivated. The field of “Tⱼ” set to 1 may indicate that the TCI state with the TCI state ID j is not mapped to one codepoint of ‘Transmission Configuration Indication field’ of the DCI j may be a UL TCI state ID (UL-TCIState-Id) or a DL/Joint TCI state ID (DLorJoint-TCIState-Id). The number of UL TCI state IDs may be up to 64. The number of DL/Joint TCI state IDs may be up to 128. j may be {0, . . . , 63}. j may be {0, . . . 127. j may be {0, . . . , 191}. For example, in a case that the i-th TCI codepoint corresponds to a UL TCI state, the field of “Tⱼ” may indicate an activation/deactivation status of a TCI state with the TCI state ID j-128. For example, in a case that the i-th TCI codepoint corresponds to a DL TCI state or a Joint TCI state, the field of “Tⱼ” may indicate an activation/deactivation status of a TCI state with the TCI state ID j-64. For example, in the case that the i-th TCI codepoint corresponds to a UL TCI state, the field of “Tⱼ” set to 1 may indicate that the TCI state with the TCI state ID j-128 is activated. For example, in the case that the i-th TCI codepoint corresponds to a UL TCI state, the field of “Tⱼ” set to I may indicate that the TCI state with the TCI state ID j-128 is mapped to the i-th TCI codepoint. For example, in the case that the i-th TCI codepoint corresponds to a DL TCI state or a Joint TCI state, the field of “Tⱼ” set to 1 may indicate that the TCI state with the TCI state ID j-64 is activated. For example, in the case that the i-th TCI codepoint corresponds to a DL TCI state or a Joint TCI state, the field of “Tⱼ” set to 1 may indicate that the TCI state with the TCI state ID j-64 is mapped to the i-th TCI codepoint. The field of the CORESET pool ID may indicate that second mapping is specific to a CORESET ID (ControlResourceSetId) configured with a CORESET pool ID (CORESET pool index). The second mapping may be mapping between the “activated TCI state” and the codepoint of the DCI ‘Transmission Configuration Indication’ set by the “Tᵢ” field. The field of the CORESET pool ID set to 1 may indicate that the MAC CE is applied to a downlink or uplink transmission scheduled by the CORESET with the CORESET pool ID (CORESET pool index) having a value of 1. The field of the CORESET pool ID set to 0 may indicate that the MAC CE is applied to a downlink or uplink transmission scheduled by the CORESET with the CORESET pool ID (CORESET pool index) having a value of 0. In the case that the CORESET pool index (coresetPoolIndex) is not configured, the field of the CORESET pool ID in the fourth MAC CE may be disregarded.

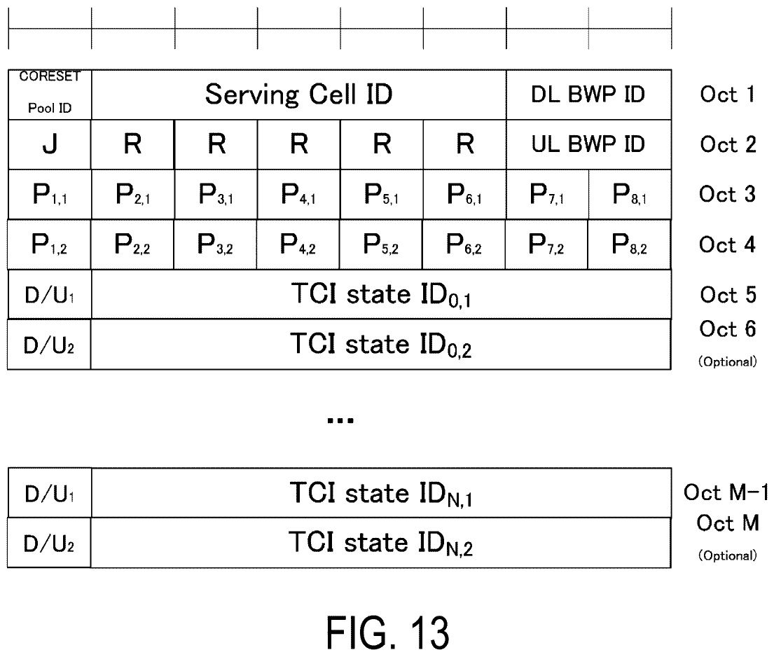

FIG. 13 is a diagram illustrating an example of the activation command E according to an aspect of the present embodiment. A field of a CORESET pool ID in FIG. 13 may be reserved. A field of “P_{i, j}” may indicate whether each TCI codepoint has multiple TCI states or one TCI state. For example, in a case that the “P_{i, j}” field is set to 1, the j-th TCI state in the i-th TCI codepoint may include two TCI states (e.g., DL TCI state and UL TCI state). For example, in a case that the “P_{i, j}” field is set to 0, the j-th TCI state in the i-th TCI codepoint may include one TCI state (e.g., DL TCI state or UL TCI state). A field of “D/Uⱼ” may indicate whether the TCI state ID in the same octet is for joint (both DL and UL)/DL or UL. The field of “D/Uⱼ” may indicate whether the TCI state ID in the same octet is for joint (both DL and UL)/DL or UL. For example, in a case that the “D/Uⱼ” field is set to 1, the TCI state ID in the same octet may be for DL/joint. For example, in a case that the “D/Uⱼ” field is set to 0, the TCI state ID in the same octet may be for UL. A “TCI state ID_{i, j}” field may indicate a TCI state identified by the DL/Joint TCI state ID (TCI-StateId) or the UL TCI state ID (UL-TCIState-Id). In a case that the “D/Uⱼ” field is set to 1, a 7-bit long “TCI state ID_{i, j}” may be used. In a case that the “D/Uⱼ” field is set to 0, the most significant bit of the “TCI state ID_{i, j}” may be regarded as reserved and the remaining 6 bits may indicate the ID of the UL-TCIState (UL TCI state, UL-TCIState-Id).

j in FIG. 13 may correspond to a CORESET pool ID (CORESET pool index). For example, j=1 may correspond to a CORESET pool ID (CORESET pool index)=0. For example, j=2 may correspond to a CORESET pool ID (CORESET pool index)=1. For example, j=0 may correspond to a CORESET pool ID (CORESET pool index)=0. For example, j=1 may correspond to a CORESET pool ID (CORESET pool index)=1. Whether j corresponds to a CORESET pool ID (CORESET pool index) may be determined according to the “J” field. For example, in a case that the “J” field is set to 1, j may correspond to a CORESET pool ID (CORESET pool index). For example, in a case that the “J” field is set to 0, j may correspond to an index of a TCI state in one codepoint. The field of “P_{i, j}” may indicate whether each TCI codepoint of the DCI associated with the CORESET pool ID corresponding to j has multiple TCI states or one TCI state. For example, in a case that the “P_{i, j}” field is set to 1, the i-th TCI codepoint of the DCI associated with the CORESET pool ID corresponding to j may correspond to both the DL TCI state and the UL TCI state. For example, in a case that the “P_{i, j}” field is set to 0, the i-th TCI codepoint of the DCI associated with the CORESET pool ID corresponding to j may correspond to one of the DL TCI state and the UL TCI state. In a case that the CORESET pool index (higher layer parameter coresetPoolIndex) is not configured, j need not correspond to the CORESET pool ID.

An activation command F may be a MAC CE for TCI state indication for a PDCCH. The activation command F may include a 5-bit serving cell ID, a 4-bit CORESET ID, and a 7-bit TCI state ID.

An activation command G may be a MAC CE for TCI state indication for a PDCCH. The activation command G may include a 5-bit serving cell ID, a 4-bit CORESET ID, a first 7-bit TCI state ID, and a second 7-bit TCI state ID. In a case that one or multiple CORESETs in one BWP are configured with different CORESET pool index values, the activation command G need not be applied to the one or multiple CORESETs. In a case that the SFN is applied for the PDCCH, the activation command G may be applied. The fact that the SFN for the PDCCH is applied may mean that sfnSchemePdcch is configured.

The terminal apparatus 1 may receive an activation command. The activation command may be a general term for the activation commands A, B, C, D, E, F, and G.

The DCI format 1_0/1_1/1_2 may be used for scheduling the PDSCH. The bandwidth part indicator (BWP indicator) field may be included in one or both of the DCI format 1_1 and the DCI format 1_2. The number of information bits constituting the BWP indicator field may be determined based on the number of DL BWPs. A TPC command (TPC command for scheduled PUCCH) field may be included in one or both of the DCI format 1_1 and the DCI format 1_2. A second TPC (second TPC command for scheduled PUCCH) field may be included in one or both of the DCI format 1_1 and the DCI format 1_2. For example, in a case that a higher layer parameter SecondTPCFieldDCI is configured, the second TPC command (second TPC command for scheduled PUCCH) field may be included in the DCI format 1_1.

The DCI format 1_0, the DCI format 1_1, and the DCI format 1_2 may be DCI formats for PDSCH scheduling. The DCI format 1_0 may be used for scheduling the PDSCH in a single downlink cell.

The antenna port field (Antenna port(s) field) may be included in the DCI format 1_1 and the DCI format 1_2. The number of information bits constituting the antenna port field may be 4, 5, or 6 bits. The number of information bits constituting the antenna port field may be 4, 5, 6, or 7 bits. The number of information bits constituting the antenna port field may be 4, 5, 6, 7, or 8 bits. The number of CDM groups without data may be any of a value 1, a value 2, and a value 3. The number of CDM groups without data of the value 1 may refer to a CDM group 0. The number of CDM groups without data of the value 2 may refer to a CDM group {0, 1}. The number of CDM groups without data of the value 3 may refer to a CDM groups {0, 1, 2}.

The higher layer parameter dmrs-Type being 1 may mean that DMRS configuration type 1 is configured. The higher layer parameter dmrs-Type being 2 may mean that the DMRS configuration type 2 is configured. The higher layer parameter maxLength being 1 may mean that the maximum number of the front-loaded DMRS symbols is 1. The higher layer parameter maxLength being 2 may mean that the maximum number of the front-loaded DMRS symbols is 2. For example, the higher layer parameter maxLength being 1 may mean that a single symbol front-loaded DMRS (front-loaded DMRS symbol) is configured. For example, the higher layer parameter maxLength being 2 may mean that a single symbol front-loaded DMRS (front-loaded DMRS symbol) or a double symbol front-loaded DMRS may be configured.

The number of DMRS ports may be the number of layers (transmission layers) of v. An antenna port {p0, . . . pv−1} (antenna port value, antenna port number) may be a sum of a DMRS port (DMRS port value, DMRS port number) and 1000. For example, the DMRS port 0 may correspond to the antenna port p0=1000. For example, the DMRS port 1 may correspond to the antenna port p1=1001. For example, the DMRS ports {0, 1} may correspond to the antenna ports {p0=1000, p1=1001}. For example, the DMRS ports {2, 3} may correspond to the antenna ports {p2=1002, p3=1003}.

The transmission configuration indication (TCI) field may be included in one or both of the DCI format 1_1 and the DCI format 1_2. For example, in a case that the higher layer parameter is configured, the transmission configuration indication (TCI) field may be included in one or both of the DCI format 1_1 and the DCI format 1_2. For example, in a case that the higher layer parameter tci-PresentInDCI is configured, the transmission configuration indication (TCI) field may be included in one or both of DCI format 1_1 and DCI format 1_2. One or two TCI states may be indicated by the DCI format. One or multiple (e.g., two) TCI states may be indicated by the TCI field in the DCI format.

The DCI format 0_0/0_1/0_2 may be used for scheduling the PUSCH. The bandwidth part indicator (BWP indicator) field may be included in some or all of the DCI format 0_1 and the DCI format 0_2. The number of information bits constituting the BWP indicator field may be determined based on the number of UL BWPs. A TPC command (TPC command for scheduled PUSCH) field may be included in one or both of the DCI format 0_1 and the DCI format 0_2. A second TPC (second TPC command for scheduled PUSCH) field may be included in one or both of the DCI format 0_1 and the DCI format 0_2. For example, in the case that a higher layer parameter SecondTPCFieldDCI is configured, the second TPC command (second TPC command for scheduled PUSCH) field may be included in the DCI format 1_1.

The SRS resource indicator field may be included in one or both of the DCI format 0_1 and the DCI format 0_2. The SRS resource set indicator field may be included in one or both of the DCI format 0_1 and the DCI format 0_2. In a case that the SRS resource set indicator field indicates 0 (“00”), the SRS resource indicator field and the field of the precoding information and number of layers may be associated with the first SRS resource set. In a case that the SRS resource set indicator field indicates 1 (“01”), the SRS resource indicator field and the field of the precoding information and number of layers may be associated with the second SRS resource set. In a case that the SRS resource set indicator field indicates 2 (“10”), the SRS resource indicator field and the field of the precoding information and number of layers may be associated with the first SRS resource set. In the case that the SRS resource set indicator field indicates 2 (“10”), a second SRS resource indicator field and a second “field of the precoding information and number of layers” (a second precoding information field) may be associated with the second SRS resource set. In a case that the SRS resource set indicator field indicates 3 (“11”), the SRS resource indicator field and the field of the precoding information and number of layers may be associated with the first SRS resource set. In the case that the SRS resource set indicator field indicates 3 (“11”), the second SRS resource indicator field and the second “field of the precoding information and number of layers” may be associated with the second SRS resource set.

One TCI state enables the beam management of one or both of multiple uplink channels/signals (e.g., PUSCH, PUCCH, SRS) and multiple downlink channels/signals (e.g., PDSCH, PDCCH, and CSI-RS). In other words, applying one TCI state to multiple channels/signals allows efficiency of the beam management to be expected to be improved. However, in the case of the Multi-TRP (Multiple Transmission and Reception Points), it is difficult to switch beams for each TRP by applying one TCI state to multiple channels/signals. Thus, a problem is that one TCI state needs to be applied to multiple channels/signals and each TRP. Accordingly, efficient communication and efficient beam management may be expected. In addition, efficient beam management is expected in consideration of the time from when a beam is indicated to when the beam is applied. An aspect of the present invention may be used for the beam management for a physical channel in consideration of some or all switching times of the “configured TCI state”, the “activated TCI state”, the “indicated TCI state”, and the “applied TCI state” as a means for solving the problem.

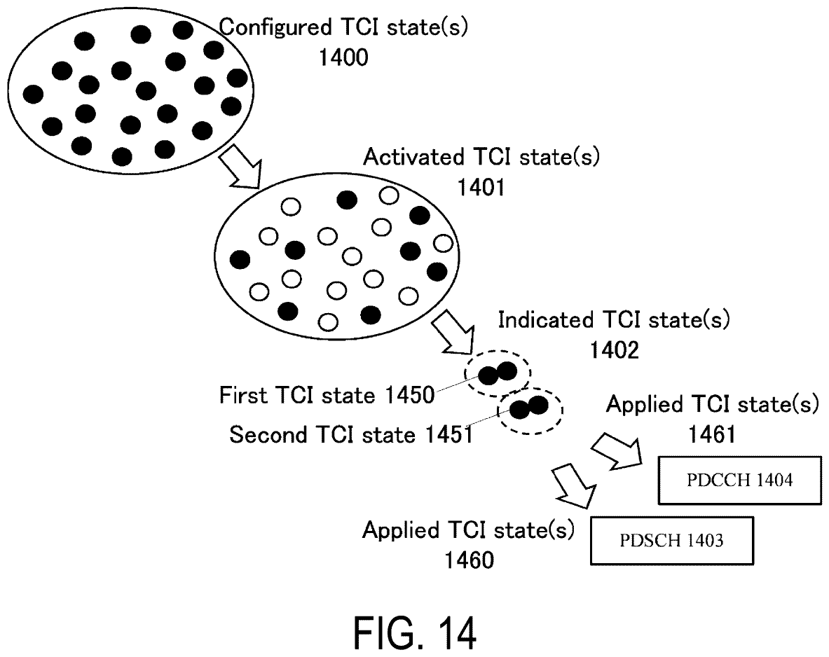

FIG. 14 is a diagram illustrating an example of management of the TCI state according to an aspect of the present embodiment. The terminal apparatus 1 may receive one or both of a PDSCH 1403 and a PDCCH 1404. The PDSCH 1403 may be transmitted for conveying a transport block. The terminal apparatus I may receive the PDCCH 1404 to which the DCI is mapped. A black circle in FIG. 14 may be one TCI state.

One or multiple TCI states 1400 may be configured by the higher layer parameter. For example, one or multiple UL TCI states (UL-TCIState) may be configured by the higher layer parameter for each uplink BWP (BWP-UplinkDedicated). For example, one or multiple DL/Joint TCI states (DLorJointTCIState) may be configured by the higher layer parameter for each PDSCH configuration (PDSCH-Config). One TCI state may be associated with one TCI state ID. For example, one UL TCI state may be associated with one UL TCI state ID (TCI-UL-State-Id, UL-TCIState-Id). For example, one DL/Joint TCI state may be associated with one TCI state ID (TCI-stateId). The one or multiple TCI states configured by the higher layer parameter may be the configured TCI states 1400.

One or multiple TCI states 1401 may be activated by the MAC CE (e.g., activation command). The first PDSCH may convey the first transport block. The first transport block may be one MAC PDU. One MAC PDU may include an activation command or a MAC CE referred to as an activation command. For example, the activation command may be the activation command D or the activation command E. One or both of the one or multiple TCI states and the one or multiple “pairs of TCI states” may be mapped to one or multiple codepoints. For example, one or both of the one or multiple TCI states and the “pairs of TCI states” may be mapped to one or multiple codepoints by the activation command. Each TCI state or each pair of TCI states may be mapped to one codepoint. For example, each TCI state or each pair of TCI states may be mapped to one codepoint by the activation command. The codepoint to which the TCI state or the pair of TCI states is mapped may be a codepoint in the TCI field. The codepoint to which the TCI state or the pair of TCI states is mapped may be a codepoint in the TCI field in the DCI format 1_1 or DCI format 1_2. The codepoint to which the TCI state or the pair of TCI states is mapped may be a codepoint in a TCI field in DCI 1410. The TCI state activated by the MAC CE may be the activated TCI state 1401. The TCI state mapped to the codepoint in the TCI field may be the activated TCI state 1401.

In a case that the CORESET pool index (coresetPoolIndex) is not configured in one or multiple CORESETS (ControlResourceSet), the activation command E may be used. In a case that the CORESET pool index (coresetPoolIndex) is configured in one or multiple CORESETS (ControlResourceSet), the activation command D or the activation command E may be used. For example, in the single-DCI mode, the activation command E may be used. For example, in the multi-DCI mode, the activation command D may be used. For example, in the single-DCI mode and the multi-DCI mode, the activation command E may be used.

One or multiple TCI states 1402 may be indicated by the first DCI The first DCI may be the DCI format 1_1 or the DCI format 1_2. The first DCI may include the TCI field (Transmission Configuration Indication field). The TCI field may indicate one or multiple (e.g., two or four) TCI states. For example, one value of the TCI field may correspond to one codepoint in the TCI field, The TCI state indicated by the first DCI format may be the indicated TCI state 1402. The indicated TCI state 1402 may be some or all of a UL TCI state, a DL TCI state, and a Joint TCI state. The UL TCI state may be a TCI state for a PUSCH, a PUCCH, and an SRS. The DL TCI state may be a TCI state for a PDSCH, a PDCCH, and a CSI-RS. The Joint TCI state may be a TCI state for a PUSCH, a PUCCH, an SRS, a PDSCH, a PDCCH, and a CSI-RS.

The number of indicated TCI states 1402 may be four. For example, the indicated TCI states 1402 may include a first pair of a first UL TCI state and a first DL TCI state, and a second pair of a second UL TCI state and a second DL TCI state. The first pair may be associated with a first TRP. The second pair may be associated with a second TRP.

The number of indicated TCI states 1402 may be three. For example, the indicated TCI states 1402 may include the first pair of the first UL TCI state and the first DL TCI state, and a third DL/UL/Joint TCI state. The first pair may be associated with the first TRP and the third DL/UL/Joint TCI state may be associated with the second TRP. The first pair may be associated with the second TRP and the third DL/UL/Joint TCI state may be associated with the first TRP.

The number of indicated TCI states 1402 may be two. For example, the indicated TCI states 1402 may include a first DL/UL/Joint TCI state and a second DL/UL/Joint TCI state. The first DL/UL/Joint may be associated with the first TRP and the second DL/UL/Joint TCI state may be associated with the second TRP.

The number of indicated TCI states 1402 may be two. For example, the indicated TCI states 1402 may include the first pair of the first DL TCI state and the first UL TCI state. The first pair may be associated with the first TRP. The first pair may be associated with the second TRP.

The number of indicated TCI states 1402 may be one. For example, the indicated TCI states 1402 may include the first DL/UL/Joint TCI state. The first DL/UL/Joint need not be associated with a TRP. The first DL/UL/Joint TCI state may be associated with the first TRP. The first DL/UL/Joint TCI state may be associated with the second TRP.

The indicated TCI state 1402 may be applied starting from the first slot N_{symb} symbols after the last OFDM symbol of the PDCCH to which the DCI format 1_1/1_2 is mapped. The indicated TCI state 1402 may be applied to multiple channels/signals. N_{symb} may be BeamAppTime.

Some or all of the one or multiple TCI states 1402 may be applied to the PDSCH 1403. The “indicated TCI state 1402” applied to the PDSCH 1403 may include one or both of one or multiple DL TCI states and one or multiple Joint TCI states. The “indicated TCI state” 1402 applied to the PDSCH 1403 may be an “applied TCI state” 1460. The TCI state 1460 may be an “applied TCI state” for the PDSCH 1403.

Some or all of the one or multiple TCI states 1402 may be applied to the PDCCH 1404. The “indicated TCI state 1402” applied to the PDCCH 1404 may be one or both of the one or multiple DL TCI states and the one or multiple Joint TCI states. The “indicated TCI state” 1402 applied to the PDCCH 1404 may be an “applied TCI state” 1461. The TCI state 1461 may be an “applied TCI state” for the PDCCH 1404.

The indicated TCI state 1402 may include at least a TCI state 1450 and a TCI state 1451. One or both of the TCI state 1450 and the TCI state 1451 may be applied to the PDSCH 1403. One or both of the TCI state 1450 and the TCI state 1451 may be applied to the PDCCH 1404. One or both of the TCI state 1450 and the TCI state 1451 applied to the PDSCH 1403 may be the TCI state 1460. One or both of the TCI state 1450 and the TCI state 1451 applied to the PDCCH 1404 may be the TCI state 1461.

The DCI format for the PDSCH 1403 may perform some or all of the first indication, the second indication, the third indication, and the fourth indication. The DCI format for the PDSCH 1403 may provide any one of the first indication, the second indication, the third indication, and the fourth indication. For example, one field in the DCI format for the PDSCH 1403 may perform any one of the first indication, the second indication, the third indication, and the fourth indication. One field in the DCI format for the PDSCH 1403 may provide any one of the first indication, the second indication, the third indication, and the fourth indication. The DCI format for the PDSCH 1403 may perform any one of the first indication, the second indication, the third indication, and the fourth indication to the PDSCH 1403 scheduled by the DCI format.

The higher layer parameter for the PDCCH 1404 may perform some or all of the first indication, the second indication, the third indication, and the fourth indication. The higher layer parameter for the PDCCH 1404 may provide any one of the first indication, the second indication, the third indication, and the fourth indication. The higher layer parameter for the PDCCH 1404 may perform any one of the first indication, the second indication, the third indication, and the fourth indication to the PDCCH 1404. The higher layer parameter for PDCCH 1404 may be configured for a CORESET for the PDCCH 1404.

Some or all of the first indication, the second indication, the third indication, and the fourth indication may be provided to determine the “applied TCI state” 1460 or the “applied TCI state” 1461. Determining the “applied TCI state” may be providing some or all of the first indication, the second indication, the third indication, and the fourth indication.

The first indication and the second indication may indicate that one of the first TCI state 1450 and the second TCI state 1451 is applied to one or both of the PDSCH 1403 and the PDCCH 1404. The first indication may indicate that the first TCI state 1450 is applied to one or both of the PDSCH 1403 and the PDCCH 1404. The second indication may indicate that the second TCI state 1451 is applied to one or both of the PDSCH 1403 and the PDCCH 1404. The third indication and the fourth indication may indicate that both the first TCI state 1450 and the second TCI state 1451 are applied to one or both of the PDSCH 1403 and the PDCCH 1404. The first indication may indicate that the first TCI state 1450 is to be used. The second indication may indicate that the second TCI state 1451 is to be used. The third indication and the fourth indication may indicate that both the first TCI state 1450 and the second TCI state 1451 are to be used. The first indication may indicate that the first TCI state 1450 is applied to multiple downlink channels/signals including the PDSCH 1403. The second indication may indicate that the second TCI state 1451 is applied to multiple downlink channels/signals including the PDSCH 1403. The third indication and the fourth indication may indicate that both the first TCI state 1450 and the second TCI state 1451 are applied to multiple uplink channels/signals including the PDSCH 1403.

The DCI format for the PDSCH 1403 may include the TRP indicator field. The TRP indicator field may provide any one of the first indication, the second indication, the third indication, and the fourth indication. For example, in a case that the TRP indicator field indicates 0 (“00”), the first indication may be performed. For example, in a case that the TRP indicator field indicates 1 (“01”), the second indication may be performed. For example, in a case that the TRP indicator field indicates 2 (“10”), the third indication may be performed. For example, in a case that the TRP indicator field indicates 3 (“11”), the fourth indication may be performed. For example, the TRP indicator field being 0 (“00”) may mean that the first indication is provided. For example, the TRP indicator field being 1 (“01”) may mean that the second indication is provided. For example, the TRP indicator field being 2 (“10”) may mean that the third indication is provided. For example, the TRP indicator field being 3 (“11”) may mean that the fourth indication is provided. The TRP indicator field may be a field different from the TCI field. In the case that the higher layer parameter is configured, the number of information bits constituting the TRP indicator field may be two. In the case that the higher layer parameter is not configured, the number of information bits constituting the TRP indicator field may be zero. The TRP indicator field may be included in both a UL scheduling DCI format and a DL scheduling DCI format. The UL scheduling DCI format may be some or all of the DCI format 0_0, the DCI format 0_1, and the DCI format 0_2. The DL scheduling DCI format may be some or all of the DCI format 1_0, the DCI format 1_1, and the DCI format 1_2.

The DCI format for the PDSCH 1403 may include the TCI field. The TCI field may provide any one of the first indication, the second indication, the third indication, and the fourth indication. For example, in a case that the TCI field indicates 0 (“00”), the first indication may be performed. For example, in a case that the TCI field indicates 1 (“01”), the second indication may be performed. For example, in a case that the TCI field indicates 2 (“10”), the third indication may be performed. For example, in a case that the TCI field indicates 3 (“11”), the fourth indication may be performed. For example, the TCI field being 0 (“00”) may mean that the first indication is provided. For example, the TCI being 1 (“01”) may mean that the second indication is provided. For example, the TCI field being 2 (“10”) may mean that the third indication is provided. For example, the TCI field being 3 (“11”) may mean that the fourth indication is provided.

The higher layer parameter for the PDCCH 1403 may provide any one of the first indication, the second indication, the third indication, and the fourth indication. For example, in a case that the higher layer parameter for the PDCCH 1403 indicates 0 (“00”), the first indication may be performed. For example, in a case that the higher layer parameter for the PDCCH 1403 indicates 1 (“01”), the second indication may be performed. For example, in a case that the higher layer parameter for the PDCCH 1403 indicates 2 (“10”), the third indication may be performed. For example, in a case that the higher layer parameter for the PDCCH 1403 indicates 3 (“11”), the fourth indication may be performed. For example, the higher layer parameter for the PDCCH 1403 being 0 (“00”) may mean that the first indication is provided. For example, the higher layer parameter for the PDCCH 1403 being 1 (“01”) may mean that the second indication is provided. For example, the higher layer parameter for the PDCCH 1403 being 2 (“10”) may mean that the third indication is provided. For example, the higher layer parameter for the PDCCH 1403 being 3 (“11”) may mean that the fourth indication is provided.

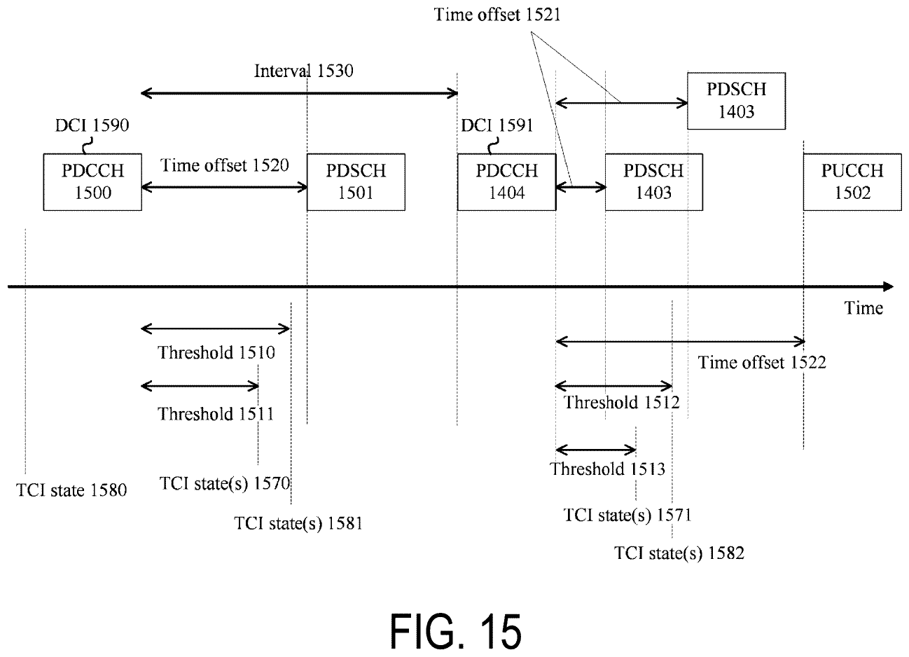

FIG. 15 is a diagram illustrating an example of a timeline management for the TCI state according to an aspect of the present embodiment. The terminal apparatus 1 may receive a PDCCH 1500. The terminal apparatus 1 may receive the PDCCH 1500 to which DCI 1590 is mapped. The DCI 1590 in the PDCCH 1500 may include one or both of the TCI field and the TRP indicator field. The DCI 1590 may schedule a PDSCH 1501. The DCI 1590 may indicate reception of the PDSCH 1501. The DCI 1590 may indicate transmission of the PDSCH 1501.

The terminal apparatus 1 may receive the PDSCH 1501. The terminal apparatus 1 may receive the PDSCH 1501 a time offset 1520 after the last OFDM symbol of the PDCCH 1500. The time offset 1520 may be a time offset between reception of the DL DCI (DCI 1590) and the PDSCH 1501. The DL DCI may be mapped to the PDCCH 1500. The PDSCH 1501 may correspond to the DL DCI (DCI 1590). The time offset 1520 may be a time offset between the last OFDM symbol of the PDCCH 1500 and an initial OFDM symbol of the PDSCH 1501. The time offset may be represented by the number of OFDM symbols. The time offset may be represented by milliseconds. The time offset may be represented by the number of slots. The time offset may be a time offset between reception of the DL DCI and the corresponding PDSCH.

The time offset 1520 may be equal to or greater than a threshold 1510. The threshold 1510 may be a time for “indicated TCI state(s)” 1581 to apply. For example, the threshold 1510 may be a time for the “indicated TCI state(s)” 1581 to apply for multiple channels including the PDSCH 1501. The threshold 1510 may be used to determine a TCI state or a QCL assumption for the PDSCH 1501. The threshold 1510 may be used to determine an antenna port QCL for the PDSCH 1501. The threshold 1510 may be configured by the higher layer parameter. The threshold 1510 may be determined based on the terminal capability. The threshold 1510 may be BeamAppTime. The threshold 1510 may be timeDurationForQCL. The threshold 1510 need not be expected to be less than a threshold 1511.

The time offset 1520 may be equal to or greater than a threshold 1511. The threshold 1511 may be a time for “applied TCI state(s)” 1570 to apply. For example, the threshold 1511 may be a time for one or two “indicated TCI states” 1570 to apply for the PDSCH 1501. The threshold 1511 may be used to determine a TCI state or a QCL assumption for the PDSCH 1501. The threshold 1511 may be used to determine a TCI state or a QCL assumption for the PDSCH 1501. The threshold 1511 may be used to determine an antenna port QCL for the PDSCH 1501. The threshold 1511 may be configured by the higher layer parameter. The threshold 1511 may be determined based on the terminal capability. The threshold 1511 may be BeamAppTime. The threshold 1511 may be BeamAppTime-r18. The threshold 1511 may be timeDurationForQCL. The threshold 1511 may be equal to the threshold 1510 or less than the threshold 1510.

In a case that the time offset 1520 is equal to or greater than the threshold 1510 or 1511, some or all of the “indicated TCI states” 1581 may be applied to the PDSCH 1501. Some or all of the “indicated TCI states” 1581 applied to the PDSCH 1501 may be the “applied TCI state(s)” 1570. For example, the DCI 1590 may indicate one or multiple “indicated TCI states” 1581. For example, the DCI 1590 may determine one or two “applied TCI states” 1570 for the PDSCH 1501 from one or multiple “indicated TCI states” 1581.

The DCI 1590 may indicate one or multiple “indicated TCI states” 1581. For example, the TCI field in the DCI 1590 may indicate one or multiple “indicated TCI states” 1581. In a case that the time offset 1520 is equal to or greater than the threshold 1510, some or all of one or multiple “indicated TCI states” 1581 may be applied to the PDSCH 1501.

The DCI 1590 may indicate one or two “applied TCI states” 1570. For example, the TRP indicator field in the DCI 1590 may be used to determine one or two “applied TCI states” 1570. For example, the TRP indicator field in the DCI 1590 may be used to determine one or two “applied TCI states” 1570 for the PDSCH 1501. In a case that the time offset 1520 is equal to or greater than the threshold 1511, the “applied TCI state” 1570 may be applied to the PDSCH 1501.

In a case that one or multiple TCI states 1581 are different from some or all of one or multiple TCI states 1580 and that the time offset 1520 is equal to or greater than threshold 1510, one or two TCI states 1570 may be applied to the PDSCH 1501. One or multiple TCI states 1581 may be indicated by the DCI 1590. For example, one or multiple TCI states 1581 may be indicated by the TCI field in the DCI 1590. One or two TCI states 1570 may be some or all of one or multiple TCI states 1581. One or two TCI states 1570 may be indicated by the DCI 1590. For example, one or two TCI states 1570 may be indicated by the TRP indicator field in the DCI 1590. The TCI state 1580 may be indicated prior to (before) the TCI state 1581. In other words, the TCI state 1580 may be older information than the TCI state 1581. In other words, the TCI state 1580 may be indicated before the TCI state 1581 is indicated.

In a case that one or multiple TCI states 1581 are the same as one or multiple TCI states 1580 and that the time offset 1520 is equal to or greater than threshold 1511, one or two TCI states 1570 may be applied to the PDSCH 1501.

In a case that one or multiple TCI states 1581 are different from some or all of one or multiple TCI states 1580, and that the time offset 1520 is equal to or greater than threshold 1511, and that the time offset 1520 is less than threshold 1510, some or all of operations a, b, c, d, e, f, g, h, and i may be performed.

The operation a may mean that one or two TCI states 1570 and one or multiple TCI states 1581 are not applied to the PDSCH 1501.

The operation b may mean that some or all of one or multiple TCI states 1580 are applied to the PDSCH 1501.

The operation c may mean that some or all of one or multiple TCI states 1580 are applied to the PDSCH 1501 based on the higher layer parameter. The higher layer parameter may be used to determine the “applied TCI state”. The operation d may mean that some or all of the one or multiple TCI states 1580 are applied to the PDSCH 1501 based on a PDSCH-MTRP scheme, The PDSCH-MTRP scheme may be some or all of the SFN scheme, the FDM scheme, the TDM scheme, and the SDM scheme.

The operation e may mean that the TCI state applied to the PDCCH 1500 or the CORESET of the PDCCH 1500 is applied to the PDSCH 1501.

The operation f may mean that the TCI state applied to a CORESET having the smallest CORESET ID among one or multiple CORESETS in one BWP associated with the PDCCH 1500 is applied to the PDSCH 1501.

The operation g may mean that two of multiple “configured TCI states” are applied to the PDSCH 1501.

The operation h may mean that one or two of one or multiple TCI states 1580 are applied to the PDSCH 1501 based on certain DCI. The certain DCI may be received prior to the DCI 1590. The certain DCI may determine the “applied TCI state”. The certain DCI may indicate a TCI state for a PDSCH different from the PDSCH 1501. The certain DCI may be DCI indicating the TCI state 1580.

The operation i may mean that some or all of one or multiple TCI states 1580 are applied to the PDSCH 1501 based on the DCI 1590 or the TRP indicator field in the DCI 1590.

In a case that the time offset 1520 is less than the threshold 1511, some or all of the operations a, b, c, d, e, f, g, and h may be performed. In the case that the time offset 1520 is less than the threshold 1511, the operation i need not be performed.

The terminal apparatus I may receive the PDCCH 1404. The terminal apparatus 1 may receive the PDCCH 1404 to which DCI 1591 is mapped. A time interval 1530 may be a time between the PDCCH 1500 and the PDCCH 1404. For example, the time interval 1530 may be a time from the last OFDM symbol of the PDCCH 1500 to an initial OFDM symbol of the PDCCH 1404. For example, the time interval 1530 may be represented by OFDM symbols.

In a case that the time interval 1530 is equal to or greater than the threshold 1510, some or all of one or multiple TCI states 1581 may be applied to the PDCCH 1404. In the case that the time interval 1530 is equal to or greater than the threshold 1510, some or all of one or multiple TCI states 1581 may be applied to the PDCCH 1404 based on the higher layer parameter. In a case that the time interval 1530 is less than the threshold 1510, some or all of one or multiple TCI states 1580 may be applied to the PDCCH 1404. In the case that the time interval 1530 is less than threshold 1510, some or all of one or multiple TCI states 1580 may be applied to the PDCCH 1404 based on higher layer parameter. The higher layer parameter may be used to determine the “applied TCI state” for the PDCCH.

The terminal apparatus 1 may receive the PDSCH 1403. The DCI 1591 may schedule the PDSCH 1403. The DCI 1591 may indicate transmission or reception of the PDSCH 1403. The DCI 1591 may include the TCI field. The DCI 1591 may include the TRP indicator field. The DCI 1591 may include the PUCCH resource indicator field. A time offset 1522 may be a time between the PDCCH 1404 and the PDSCH 1403. For example, the time offset 1522 may be a time from the last OFDM symbol of the PDCCH 1404 to an initial OFDM symbol of the PDSCH 1403. The time offset 1522 may be represented by OFDM symbols.

A threshold 1512 may be a time for “indicated TCI state(s)” 1582 to apply. For example, the threshold 1512 may be a time for the “indicated TCI state(s)” 1582 to apply for multiple channels including the PDSCH 1403. The threshold 1512 may be used to determine a TCI state or a QCL assumption for the PDSCH 1403. The threshold 1511 may be used to determine an antenna port QCL for the PDSCH 1403. The threshold 1512 may be configured by the higher layer parameter. The threshold 1512 may be determined based on the terminal capability. The threshold 1512 may be equal to the threshold 1510. The threshold 1512 may be BeamAppTime. The threshold 1512 may be timeDurationForQCL. The threshold 1512 need not be expected to be less than the threshold 1511.

A threshold 1513 may be a time for “applied TCI state(s)” 1571 to apply. For example, the threshold 1513 may be a time for one or two “indicated TCI states” 1571 to apply for the PDSCH 1403. The threshold 1513 may be used to determine a TCI state or a QCL assumption for the PDSCH 1403. The threshold 1513 may be used to determine a TCI state or a QCL assumption for the PDSCH 1403. The threshold 1513 may be used to determine an antenna port QCL for the PDSCH 1403. The threshold 1513 may be configured by the higher layer parameter. The threshold 1513 may be determined based on the terminal capability. The threshold 1513 may be BeamAppTime. The threshold 1513 may be BeamAppTime-r18. The threshold 1513 may be timeDurationForQCL. The threshold 1513 may be equal to the threshold 1512 or less than the threshold 1510. The threshold 1513 may be equal to the threshold 1511.

In a case that the time offset 1521 is equal to or greater than the threshold 1512 or 1513, some or all of the “indicated TCI states” 1582 may be applied to the PDSCH 1403. Some or all of the applied TCI states 1581 applied to the PDSCH 1403 may be the “applied TCI state(s)” 1571. For example, the DCI 1591 may indicate one or multiple “indicated TCI states” 1582. For example, the DCI 1591 may determine one or two “applied TCI states” 1571 for the PDSCH 1403 from one or multiple “indicated TCI states” 1582.

The DCI 1591 may indicate one or multiple “indicated TCI states” 1582. For example, the TCI field in the DCI 1591 may indicate one or multiple “indicated TCI states” 1582. In a case that the time offset 1521 is equal to or greater than the threshold 1512, some or all of one or multiple “indicated TCI states” 1582 may be applied to the PDSCH 1403.

The DCI 1590 may indicate one or two “applied TCI states” 1570. For example, the TRP indicator field in the DCI 1590 may be used to determine one or two “applied TCI states” 1570. For example, the TRP indicator field in the DCI 1590 may be used to determine one or two “applied TCI states” 1570 for the PDSCH 1501. In a case that the time offset 1520 is equal to or greater than the threshold 1511, the “applied TCI state” 1570 may be applied to the PDSCH 1501.

In a case that one or multiple TCI states 1582 are different from some or all of one or multiple TCI states 1581 and that the time offset 1521 is equal to or greater than threshold 1512, one or two TCI states 1571 may be applied to the PDSCH 1403. One or multiple TCI states 1582 may be indicated by the DCI 1591. For example, one or multiple TCI states 1582 may be indicated by the TCI field in the DCI 1591. One or two TCI states 1571 may be some or all of one or multiple TCI states 1582. One or two TCI states 1571 may be indicated by the DCI 1591. For example, one or two TCI states 1571 may be indicated by the TRP indicator field in the DCI 1591.

In a case that one or multiple TCI states 1582 are the same as one or multiple TCI states 1581 and that the time offset 1521 is equal to or greater than threshold 1512, one or two TCI states 1571 may be applied to the PDSCH 1403

In a case that one or multiple TCI states 1582 are different from some or all of one or multiple TCI states 1581, and that the time offset 1521 is equal to or greater than threshold 1513, and that the time offset 1521 is less than threshold 1512, some or all of operations aa, bb, cc, dd, ee, ff, gg, hh, and ii may be performed.

The operation aa may mean that one or two TCI states 1571 and one or multiple TCI states 1582 are not applied to the PDSCH 1403.

The operation bb may mean that some or all of one or multiple TCI states 1581 are applied to the PDSCH 1403.

The operation cc may mean that some or all of one or multiple TCI states 1581 are applied to the PDSCH 1403 based on the higher layer parameter. The higher layer parameter may be used to determine the “applied TCI state”. The operation dd may mean that some or all of the one or multiple TCI states 1581 are applied to the PDSCH 1403 based on the PDSCH-MTRP scheme. The PDSCH-MTRP scheme may be some or all of the SFN scheme, the FDM scheme, the TDM scheme, and the SDM scheme.

The operation ee may mean that the TCI state applied to the PDCCH 1404 or the CORESET of the PDCCH 1404 is applied to the PDSCH 1403.

The operation ff may mean that the TCI state applied to a CORESET having the smallest CORESET ID among one or multiple CORESETS in one BWP associated with the PDCCH 1404 is applied to the PDSCH 1403.

The operation gg may mean that two of multiple “configured TCI states” are applied to the PDSCH 1403.

The operation hh may mean that one or two of one or multiple TCI states 1581 are applied to the PDSCH 1403 based on the DCI 1590.

The operation ii may mean that some or all of one or multiple TCI states 1581 are applied to the PDSCH 1403 based on the DCI 1591 or the TRP indicator field in the DCI 1591.

In a case that the time offset 1521 is less than the threshold 1513, some or all of the operations aa, bb, cc, dd, ee, ff, gg, and hh may be performed. In the case that the time offset 1521 is less than the threshold 1513, the operation ii need not be performed.

The fact that one or multiple TCI states are applied to the physical channel may mean that the DMRS port (DMRS antenna port) of the physical channel is QCLed with the DL-RS in the one or multiple TCI states. The fact that one or multiple TCI states are applied to the PDCCH may mean that the one or multiple TCI states are applied to the CORESET for the PDCCH. The fact that one or multiple TCI states are applied to the physical channel may mean that the uplink transmission spatial filter for the physical channel is determined based on the one or multiple TCI states.

The terminal apparatus 1 may transmit a PUCCH 1502. The terminal apparatus 1 may transmit the PUCCH 1502 to which the uplink control information for the PDSCH 1403 is mapped. The terminal apparatus 1 may provide (transmit) the HARQ-ACK information in the PUCCH 1502. The terminal apparatus 1 may provide (transmit) the HARQ-ACK information in the PUSCCH 1502 in response to detecting the DCI 1404 scheduling the PDSCH 1403.

The time offset 1522 may be a time between the PDCCH 1404 and the PUCCH 1502. For example, the time offset 1522 may be a time from the last OFDM symbol of the PDCCH 1404 to an initial OFDM symbol of the PUCCH 1502.

In a case that the time offset 1522 is equal to or greater than the threshold 1512, some or all of one or multiple TCI states 1582 may be applied to the PUCCH 1502. For example, in the case that the time offset 1522 is equal to or greater than the threshold 1512, some or all of one or multiple TCI states 1582 may be applied to the PUCCH 1502 based on the higher layer parameter. The higher layer parameter may be configured for one PUCCH resource. One PUCCH resource may be indicated by the DCI 1591. One PUCCH resource may be indicated by the PUCCH resource indicator field in the DCI 1591. The higher layer parameter may be used to determine the “applied TCI state” for the PUCCH 1502.

In a case that the time offset 1522 is equal to or greater than the threshold 1512 and that the time offset 1521 is less than the threshold 1513, one or multiple TCI states applied to the PDSCH 1403 may be applied to the PUCCH 1502.

In a case that the time offset 1522 is less than the threshold 1512, some or all of one or multiple TCI states 1581 may be applied to the PUCCH 1502.

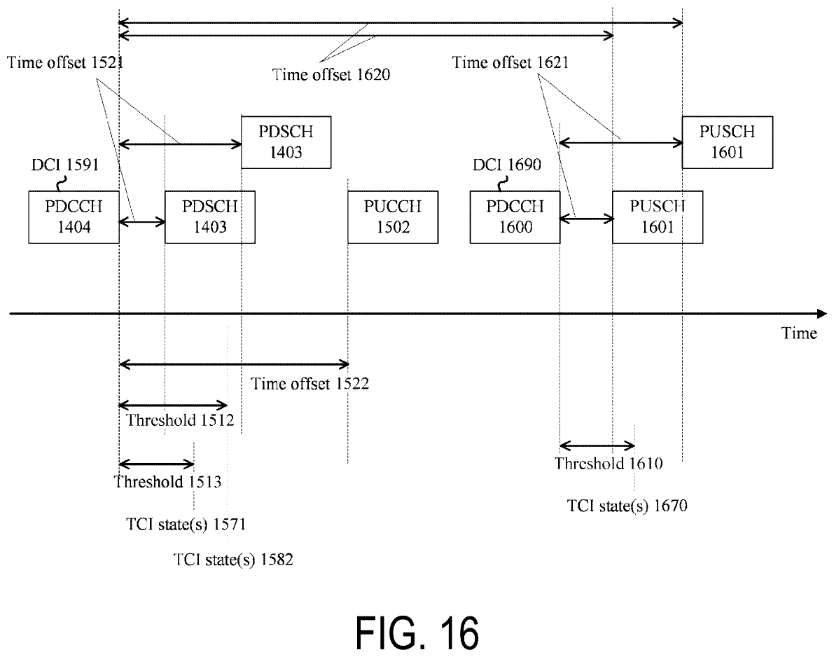

FIG. 16 is a diagram illustrating a second example of the timeline management for the TCI state according to an aspect of the present embodiment. The terminal apparatus 1 may receive a PDCCH 1600. The terminal apparatus 1 may receive the PDCCH 1600 to which DCI 1690 is mapped. The DCI 1690 in the PDCCH 1600 may include the TRP indicator field. The DCI 1690 may schedule a PUSCH 1601. The DCI 1690 may indicate reception of the PUSCH 1601. The DCI 1690 may indicate transmission of the PUSCH 1601.

The terminal apparatus 1 may transmit a PUSCH 1601. The terminal apparatus 1 may transmit the PUSCH 1601 a time offset 1621 after the last OFDM symbol of the PDCCH 1600. The time offset 1621 may be a time offset between reception of the UL DCI (DCI 1690) and the PUSCH 1601. The UL DCI may be mapped to the PDCCH 1600. The PUSCH 1601 may correspond to the UL DCI (DCI 1690). The time offset 1621 may be a time offset between the last OFDM symbol of the PDCCH 1600 and an initial OFDM symbol of the PUSCH 1601. The time offset 1620 may be a time offset between reception of the DCI 1591 and the PUSCH 1601. The time offset 1620 may be a time offset between the last OFDM symbol of the PDCCH 1404 and an initial OFDM symbol of the PUSCH 1601. The time offset may be represented by the number of OFDM symbols. The time offset may be represented by milliseconds. The time offset may be represented by the number of slots. The time offset may be a time offset between the reception of the UL DCI and the corresponding PUSCH.

A threshold 1610 need not be a time for “indicated TCI state(s)” to apply. For example, a time for the “indicated TCI state(s)” 1581 to apply for multiple channels including the PUSCH 1601 may be the threshold 1512.

The threshold 1610 may be a time for “applied TCI state(s)” 1670 to apply. For example, the threshold 1610 may be a time for one or two “indicated TCI states” 1670 to apply for the PUSCH 1601. The threshold 1610 may be used to determine a TCI state or a QCL assumption for the PUSCH 1601. The threshold 1610 may be used to determine a TCI state or a QCL assumption for the PUSCH 1601. The threshold 1610 may be used to determine an antenna port QCL for the PUSCH 1601. The threshold 1610 may be used to determine the uplink transmission spatial filter for the PUSCH 1601. The threshold 1610 may be configured by the higher layer parameter. The threshold 1610 may be determined based on the terminal capability. The threshold 1610 may be BeamAppTime. The threshold 1610 may be BeamAppTime-r18. The threshold 1610 may be timeDurationForQCL. The threshold 1610 may be equal to the threshold 1513.

In a case that the time offset 1621 is equal to or greater than the threshold 1610, some or all of the “indicated TCI states” 1582 may be applied to the PUSCH 1601. Some or all of the “indicated TCI states” 1582 applied to the PUSCH 1601 may be the “applied TCI state(s)” 1670. For example, the DCI 1690 may determine one or two “applied TCI states” 1670 for the PUSCH 1601 from one or multiple “indicated TCI states” 1582.

The DCI 1690 may indicate one or two “applied TCI states” 1670. For example, the TRP indicator field in the DCI 1690 may be used to determine one or two “applied TCI states” 1670. For example, the TRP indicator field in the DCI 1690 may be used to determine one or two “applied TCI states” 1670 for the PUSCH 1601. In a case that the time offset 1621 is equal to or greater than the threshold 1610, the “applied TCI state” 1670 may be applied to the PUSCH 1601.

The time offset 1620 may be equal to or greater than the threshold 1512. In a case that the time offset 1621 is equal to or greater than the threshold 1610, one or two TCI states 1670 may be applied to the PUSCH 1601. One or two TCI states 1670 may be some or all of one or multiple TCI states 1582. One or two TCI states 1670 may be indicated by the DCI 1690. For example, one or two TCI states 1670 may be indicated by the TRP indicator field in the DCI 1690.

The time offset 1620 may be equal to or greater than the threshold 1512. In a case that the time offset 1621 is less than the threshold 1610, some or all of operations aaa, bbb, ccc, ddd, eee, fff, ggg, hhh and iii may be performed.

The operation aaa may mean that one or two TCI states 1670 are not applied to the PUSCH 1601.

The operation bbb may mean that some or all of one or multiple TCI states 1582 are applied to the PUSCH 1601.

The operation ccc may mean that some or all of one or multiple TCI states 1582 are applied to the PUSCH 1601 based on the higher layer parameter. The higher layer parameter may be used to determine the “applied TCI state”. The operation ddd may mean that all of one or multiple TCI states 1582 are applied to the PUSCH 1601.

The operation eee may mean that the TCI state applied to the PUCCH 1502 is applied to the PUSCH 1601.

The operation fff may mean that two of multiple “configured TCI states” are applied to the PUSCH 1601.

The operation ggg may mean that some or all of one or multiple TCI states 1582 are applied to the PUSCH 1601 based on the DCI 1404 or the PUCCH resource indicator field in the DCI 1404. A certain DCI may be received prior to the DCI 1590. The certain DCI may determine the “applied TCI state”. The certain DCI may indicate a TCI state for a PDSCH different from the PDSCH 1501. The certain DCI may be DCI indicating the TCI state 1580.

The operation hhh may mean that the uplink transmission spatial filter for the PUSCH 1601 is determined based on the SRS resource indicator field in the DCI 1690.

The terminal apparatus 1 may receive a first PDCCH to which the first DCI is mapped. The terminal apparatus 1 may receive a first PDSCH scheduled by the first DCI. The terminal apparatus 1 may receive a second PDCCH to which the second DCI is mapped. The terminal apparatus 1 may receive a second PDSCH scheduled by the second DCI The terminal apparatus 1 may transmit a PUCCH to which the uplink control information for the second PDSCH is mapped. The uplink control information may be a HARQ-ACK (HARQ-ACK information). The terminal apparatus 1 may perform transmission and/or reception in the order of reception of the first PDCCH, reception of the first PDSCH, reception of the second PDCCH, reception of the second PDSCH, and transmission of the PUCCH.

One or multiple pieces of first beam information may be indicated by the first DCI. For example, one or multiple pieces of first beam information may be indicated by the TCI field in the first DCI. One or two pieces of second beam information may be indicated by the first DCI. For example, one or two pieces of second beam information may be indicated by the TRP indicator field in the first DCI. For example, one or two pieces of second beam information may be selected from one or multiple pieces of first beam information by the first DCI. The first beam information may be “indicated TCI states”. The second beam information may be “applied TCI states”. For example, the beam information may be a TCI state. For example, one or two pieces of second beam information may be part or all of one or multiple pieces of first beam information.

One or multiple pieces of third beam information may be indicated by the second DCL For example, one or multiple pieces of third beam information may be indicated by the TCI field in the second DCI. One or two pieces of fourth beam information may be indicated by the second DCI. For example, one or two pieces of fourth beam information may be indicated by the TRP indicator field in the second DCI. For example, one or two pieces of fourth beam information may be selected from one or multiple pieces of third beam information by the second DCI. The third beam information may be “indicated TCI states”. The fourth beam information may be “applied TCI states”. For example, one or two pieces of fourth beam information may be part or all of one or multiple pieces of third beam information.

A first time (time offset) may be a time between reception of the first PDCCH or the first DCI and reception of the first PDSCH. For example, the first time may be a time from the last OFDM symbol of the first PDCCH to an initial OFDM symbol of the first PDSCH. A second time (threshold) may be a time to apply the first beam information. A third time (threshold) may be a time to apply the second beam information.

A fourth time (time offset) may be a time between reception of the second PDCCH or the second DCI and reception of the second PDSCH. For example, the fourth time may be a time from the last OFDM symbol of the second PDCCH to an initial OFDM symbol of the second PDSCH. A fifth time (threshold) may be a time to apply the third beam information. A sixth time (threshold) may be a time to apply the fourth beam information.

A time from the last OFDM symbol of the first PDCCH to the initial OFDM symbol of the second PDSCH may be equal to or longer than the second time. A time between the first PDCCH and the second PDSCH may be the same as or longer than the second time.

The first time may be equal to or longer than the second time. The first time may be equal to or longer than the third time. In other words, one or two pieces of second beam information may be applied to the first PDSCH.

In a case that the fourth time is the same as or longer than the fifth time, one or two pieces of fourth beam information may be applied to the second PDSCH. In a case that the fourth time is equal to or longer than the sixth time, one or two pieces of the fourth beam information may be applied to the second PDSCH.

In a case that the fourth time is shorter than the fifth time, part or all of one or multiple pieces of first beam information may be applied to the second PDSCH. For example, in a case that the fourth time is shorter than the fifth time and that the fourth time is equal to or longer than the sixth time, part or all of one or multiple pieces of first beam information may be applied to the second PDSCH based on the second DCI or the TRP indicator field in the second DCI. For example, in a case that the third beam information is the same as the first beam information, and that the fourth time is shorter than the fifth time, and that the fourth time is equal to or longer than the sixth time, part or all of one or multiple pieces of first beam information may be applied to the second PDSCH based on the second DCI. For example, in a case that the third beam information is the same as the first beam information, and that the fourth time is shorter than the fifth time, and that the fourth time is equal to or longer than the sixth time, part or all of one or multiple pieces of first beam information may be applied to the second PDSCH based on the TRP indicator field in the second DCI.

In a case that the fourth time is shorter than the sixth time, part or all of one or multiple pieces of first beam information may be applied to the second PDSCH. For example, in this case, one or two pieces of second beam information may be applied to the second PDSCH. For example, in this case, part or all of one or multiple pieces of first beam information may be applied to the second PDSCH based on the higher layer parameter. For example, in this case, part or all of one or multiple pieces of first beam information may be applied to the second PDSCH based on the second PDCCH or a CORESET for the second PDCCH. For example, in this case, part or all of one or multiple pieces of first beam information may be applied to the second PDSCH based on whether the PDSCH-MTRP scheme is applied. For example, in this case, the beam information applied to the second PDSCH may be determined based on the SS/PBCH block. The terminal apparatus 1 may receive the SS/PBCH block prior to the first PDCCH. For example, the terminal apparatus I need not expect this case. The higher layer parameter may be used to determine the “applied TCI state” for the PDSCH.

In the case that the fourth time is shorter than the sixth time, one or two pieces of beam information applied to the second PDCCH or the CORESET for the second PDCCH may be applied to the second PDSCH.

The number of pieces of beam information applied to the second PDSCH may be provided by any one of the first indication, the second indication, the third indication, and the fourth indication. For example, some or all of the first indication, the second indication, the third indication, and the fourth indication for the second PDSCH may be provided by the DCI. For example, some or all of the first indication, the second indication, the third indication, and the fourth indication for the second PDSCH may be provided by the higher layer parameter. For example, some or all of the first indication, the second indication, the third indication, and the fourth indication for the second PDSCH may be provided depending on whether the PDSCH-MTRP scheme is applied to the second PDSCH. For example, the fact that the PDSCH-MTRP scheme is applied for the second PDSCH may mean that one or both of the third indication and the fourth indication are provided for the second PDSCH. For example, the fact that the PDSCH-MTRP scheme is not applied for the second PDSCH may mean that one or both of the first indication and the second indication are provided for the second PDSCH. The fact that one of the first indication and the second indication is provided may mean that one piece of beam information is applied. The fact that one of the third indication and the fourth indication is provided may mean that two pieces of beam information are applied.

The terminal apparatus 1 may receive a third PDCCH to which third DCI is mapped. The terminal apparatus 1 may receive a first PUSCH scheduled by the third DCI. The terminal apparatus 1 may perform transmission and reception in the order of reception of the first PDCCH, reception of the first PDSCH, reception of the second PDCCH, reception of the second PDSCH, transmission of the PUCCH, reception of the third PDCCH, and transmission of the first PUSCH.

One or multiple pieces of fifth beam information may be indicated by the third DCI For example, one or multiple pieces of fifth beam information may be indicated by the TRP indicator field in the third DCI. For example, one or multiple pieces of fifth beam information may be indicated by an SRS resource indicator field in the third DCI. For example, one or multiple pieces of fifth beam information may be part or all of one or multiple pieces of third beam information. A TRP indicator field in the third DCI may be the SRS resource set indicator field. The fact that the beam information is applied to the PUSCH may mean that an uplink transmission spatial filter for the PUSCH is determined.

A seventh time (time offset) may be a time between reception of the third PDCCH or the third DCI and transmission of the first PUSCH. For example, the seventh time may be a time from the last OFDM symbol of the third PDCCH to an initial OFDM symbol of the first PUSCH An eighth time (threshold) may be a time to apply the fifth beam information.

A time from the last OFDM symbol of the second PDCCH to the initial OFDM symbol of the first PUSCH may be equal to or longer than the fifth time. A time between the second PDCCH and the first PUSCH may be the same as or longer than the fifth time.

In a case that the seventh time is equal to or longer than the eighth time, one or multiple pieces of fifth beam information may be applied to the first PUSCH.

In a case that the seventh time is shorter than the eighth time, one or multiple pieces of sixth beam information may be applied to the first PUSCH. Alternatively, the terminal apparatus 1 need not expect that the seventh time is shorter than the eighth time. One or multiple pieces of sixth beam information may be different from part or all of one or multiple pieces of fifth beam information. One or multiple pieces of sixth beam information may be part or all of one or multiple pieces of third beam information.

One or multiple pieces of sixth beam information may be beam information applied to the first PUCCH. One or multiple pieces of sixth beam information may be determined based on the higher layer parameter. The higher layer parameter may be used to determine the “applied TCI state” for the PUSCH. One or multiple pieces of sixth beam information may be beam information applied to the third PDCCH or a CORESET for the third PDCCH. One or multiple pieces of sixth beam information may be determined by the SRS resource indicator field in the third DCI. One or multiple pieces of sixth beam information may be determined based on whether the PUSCH-MTRP scheme is applied for the first PUSCH. One or multiple pieces of sixth beam information may be determined based at least on whether the third beam information is in the Joint TCI state. For example, in a case that the third beam information is in the Joint TCI state, one or multiple pieces of sixth beam information may be indicated by the second DCI or the TRP indicator field in the second DCI. The sixth beam information applied to the first PUSCH may be one of one or multiple pieces of third beam information. One or multiple pieces of sixth beam information may be determined based on the message 3 PUSCH. One or multiple pieces of sixth beam information may be applied to the second PUSCH. For example, the second PUSCH may be the latest PUSCH among one or multiple PUSCHs transmitted prior to the first PUSCH.

The number of pieces of beam information applied to the first PUSCH may be provided by any one of the first indication, the second indication, the third indication, and the fourth indication. For example, some or all of the first indication, the second indication, the third indication, and the fourth indication for the first PUSCH may be provided by the DCI. For example, some or all of the first indication, the second indication, the third indication, and the fourth indication for the first PUSCH may be provided by the higher layer parameter. For example, some or all of the first indication, the second indication, the third indication, and the fourth indication for the first PUSCH may be provided depending on whether the PUSCH-MTRP scheme is applied to the first PDSCH. For example, the fact that the PUSCH-MTRP scheme is applied for the first PUSCH may mean that one or both of the third indication and the fourth indication are provided for the first PUSCH. For example, the fact that the PUSCH-MTRP scheme is not applied for the first PUSCH may mean that one of the first indication and the second indication is provided for the first PUSCH. The fact that one of the first indication and the second indication is provided may mean that one piece of beam information is applied. The fact that one of the third indication and the fourth indication is provided may mean that two pieces of beam information are applied.

Various aspects of apparatuses according to an aspect of the present embodiment will be described below.

Each program running on the base station apparatus 3 and the terminal apparatus 1 according to an aspect of the present invention may be a program that controls a central processing unit (CPU) and the like (a program causing a computer to function) to realize the functions of the above-described embodiment according to an aspect of the present invention. The information handled in these apparatuses is temporarily loaded into a Random Access Memory (RAM) while being processed, is then stored in a Hard Disk Drive (HDD) and various types of Read Only Memory (ROM) such as a Flash ROM, and is read, modified, and written by the CPU, as necessary.

Note that the terminal apparatus 1 and the base station apparatus 3 according to the above-described embodiment may be partially implemented by a computer. In that case, this configuration may be implemented by recording a program for implementing such control functions on a computer-readable recording medium and causing a computer system to read the program recorded on the recording medium for execution.

Note that it is assumed that the “computer system” mentioned here refers to a computer system built into the terminal apparatus 1 or the base station apparatus 3, and the computer system includes an OS and hardware components such as peripheral devices. In addition, the “computer-readable recording medium” refers to a portable medium such as a flexible disk, a magneto-optical disk, a ROM, and a CD-ROM, and a storage apparatus such as a hard disk built into the computer system.

Moreover, the “computer-readable recording medium” may include a medium that dynamically stores a program for a short period of time, such as a communication line in a case that the program is transmitted over a network such as the Internet or over a communication line such as a telephone line, and may also include a medium that stores the program for a certain period of time, such as a volatile memory included in the computer system functioning as a server or a client in such a case. In addition, the above-described program may be one for implementing some of the above-described functions, and also may be one capable of implementing the above-described functions in combination with a program already recorded in a computer system.

Furthermore, the base station apparatus 3 according to the aforementioned embodiment may be implemented as an aggregation (apparatus group) including multiple apparatuses. Each of the apparatuses included in such an apparatus group may include a part or all of each function or each functional block of the base station apparatus 3 according to the aforementioned embodiment. As the apparatus group, it is only necessary to have all of functions or functional blocks of the base station apparatus 3. Moreover, the terminal apparatus 1 according to the aforementioned embodiment can also communicate with the base station apparatus as the aggregation.

Also, the base station apparatus 3 according to the aforementioned embodiment may be an Evolved Universal Terrestrial Radio Access Network (EUTRAN) and/or a NextGen RAN (NG-RAN or NR RAN). Moreover, the base station apparatus 3 according to the aforementioned embodiment may have a part or all of the functions of a higher node for an eNodeB and/or a gNB.

Also, a part or all portions of each of the terminal apparatus 1 and the base station apparatus 3 according to the aforementioned embodiment may be implemented as an LSI, which is typically an integrated circuit, or may be implemented as a chip set. The functional blocks of each of the terminal apparatus 1 and the base station apparatus 3 may be individually implemented as a chip, or a part or all of the functional blocks may be integrated into a chip. Furthermore, a circuit integration technique is not limited to the LSI and may be implemented with a dedicated circuit or a general-purpose processor. Moreover, in a case that a circuit integration technology that substitutes an LSI appears with the advance of the semiconductor technology, it is also possible to use an integrated circuit based on the technology.

In addition, although the aforementioned embodiments have described the terminal apparatus as an example of a communication apparatus, the present invention is not limited to such a terminal apparatus, and is also applicable to a terminal apparatus or a communication apparatus that is a stationary type or a non-movable type electronic apparatus installed indoors or outdoors, for example, such as an AV device, a kitchen device, a cleaning or washing machine, an air-conditioning device, office equipment, a vending machine, and other household appliances.

Although the embodiments of the present invention have been described in detail above referring to the drawings, the specific configuration is not limited to the embodiments and includes, for example, design changes within the scope that do not depart from the gist of the present invention. Furthermore, in the present invention, various modifications are possible within the scope of claims, and embodiments that are made by suitably combining technical means disclosed according to the different embodiments are also included in the technical scope of the present invention. In addition, a configuration in which elements described in the respective embodiments and having mutually similar effects are substituted for one another is also included.

### INDUSTRIAL APPLICABILITY

An aspect of the present invention can be utilized, for example, in a communication system, communication equipment (for example, a cellular phone apparatus, a base station apparatus, a wireless LAN apparatus, or a sensor device), an integrated circuit (for example, a communication chip), or a program.

### REFERENCE SIGNS LIST

1 (1A, 1B, 1C) Terminal apparatus
3 Base station apparatus
10, 30 Radio transmission and/or reception unit
10a, 30a Radio transmission unit
10b, 30b Radio reception unit
11, 31 Antenna unit
12, 32 RF unit
13, 33 Baseband unit
14, 34 Higher layer processing unit
15, 35 Medium access control layer processing unit
16, 36 Radio resource control layer processing unit
91, 92, 93, 94 Search space set
300 Component carrier
301 Primary cell
302, 303 Secondary cell
700 Set of resource elements for PSS
710, 711, 712, 713 Set of resource elements for PBCH and DMRS for PBCH
720 Set of resource elements for SSS
3000 Point
3001, 3002 Resource grid
3003, 3004 BWP
3011, 3012, 3013, 3014 Offset
3100, 3200 Common resource block set
1400 Configured TCI state
1401 Activated TCI state
1402 Indicated TCI state
1403, 1501 PDSCH
1404, 1500, 1600 PDCCH
1590, 1591, 1690 DCI
1450, 1451 TCI state
1460, 1461 Applied TCI state
1502 PUCCH
1510, 1511, 1512, 1513, 1610 Threshold (time)
1520, 1521, 1522, 1620, 1621 Time offset
1530 Time interval
1570, 1571, 1670 Applied TCI state
1580, 1581, 1582 Indicated TCI state
1601 PUSCH

1. A terminal apparatus comprising:
a receiver configured to receive a physical downlink control channel (PDCCH) to which downlink control information (DCI) is mapped and a physical downlink shared channel (PDSCH) scheduled by the DCI; and
a transmitter configured to transmit a physical uplink control channel (PUCCH) to which uplink control information for the PDSCH is mapped, wherein
one or multiple first transmission configuration indication (TCI) states are indicated by the DCI,
one or two second TCI states are selected by the DCI from the one or multiple first TCI states,
a time offset is a time interval between the PDCCH and the PDSCH,
a duration is determined based on a terminal capability,
in a case that the time offset is equal to or longer than the duration, the one or two second TCI states are applied to the PDSCH, and
in a case that the time offset is shorter than the duration, one of the one or multiple first TCI states is applied to the PDSCH.

2. A base station apparatus comprising:
a transmitter configured to transmit a physical downlink control channel (PDCCH) to which downlink control information (DCI) is mapped and a physical downlink shared channel (PDSCH) scheduled by the DCI; and
a receiver configured to receive a physical uplink control channel (PUCCH) to which uplink control information for the PDSCH is mapped, wherein
one or multiple first transmission configuration indication (TCI) states are indicated by the DCI,
one or two second TCI states are selected by the DCI from the one or multiple first TCI states,
a time offset is a time interval between the PDCCH and the PDSCH,
a duration is determined based on a terminal capability,
in a case that the time offset is equal to or longer than the duration, the one or two second TCI states are applied to the PDSCH, and
in a case that the time offset is shorter than the duration, the one piece of third beam information is applied to the first PDSCH.

3. A communication method for a terminal apparatus comprising:
receiving a physical downlink control channel (PDCCH) to which downlink control information (DCI) is mapped;
receiving a physical downlink shared channel (PDSCH) scheduled by the DCI; and
transmitting a physical uplink control channel (PUCCH) to which uplink control information for the PDSCH is mapped, wherein
one or multiple first transmission configuration indication (TCI) states are indicated by the DCI,
one or two second TCI states are selected by the DCI from the one or multiple first TCI states,
a time offset is a time interval between the PDCCH and the PDSCH,
a duration is determined based on a terminal capability,
in a case that the time offset is equal to or longer than the duration, the one or two second TCI states are applied to the PDSCH, and
in a case that the time offset is shorter than the duration, one of the one or multiple first TCI states is applied to the PDSCH.
